(19) United States
(12) Patent Application Publication
(10) Pub. No.: US 2019/0098725 A1
(43) Pub. Date: Mar. 28, 2019

(54) Universal Solid State Lighting System

(71) Applicants: Laurence P. Sadwick, Salt Lake City, UT (US); Ruey-Jen Hwu, Salt Lake City, UT (US)

(72) Inventors: Laurence P. Sadwick, Salt Lake City, UT (US); Ruey-Jen Hwu, Salt Lake City, UT (US)

(21) Appl. No.: 16/147,561

(22) Filed: Sep. 28, 2018

Related U.S. Application Data
(60) Provisional application No. 62/564,686, filed on Sep. 28, 2017.

(51) Int. Cl. H05B 33/08; F21K 9/27; F21V 23/04; H05B 37/02

(52) U.S. Cl. CPC H05B 33/0872; F21K 9/27; F21Y 2115/10; H05B 37/0245; F21V 23/0442

(57) ABSTRACT

A solid state lighting system includes a number of solid state lamps, each associated with a sensor module. The sensor modules are configured to communicate with each other and to coordinate location-based color settings in the solid state lamps.

### BACKGROUND

While developments in electronic systems have greatly increased the comfort, control over and safety of our environment, excessive use of electricity in consumer residential housing and commercial and industrial buildings, these developments have had negative effects such as those excessive and unnecessary energy usage can have on the economy. A major source of this excessive and wasted electrical energy is due to inefficient lighting and energy wasted when lighting is left turned on.

Electric lighting in the US domestic building inventory consumes almost 10% of the primary energy delivered annually in the US representing about 22% of the electricity produced. While efforts have been made to conserve energy and to shift to more efficient lighting, the adoption and migration of energy efficient technology into existing and new buildings will take a number of years to accomplish. Therefore there is a need for novel and relatively inexpensive solutions that will accelerate the adoption of efficient lighting building inventory as well as provide security and safety including in both providing energy efficient lighting and savings and also providing security and safety including but not limited to in man-made and natural emergencies and disasters including but not limited to active shooters, hurricanes, floods, earthquakes, tornadoes, monsoons, rainfall, blizzards, bad actors, fire, collapses, structural or unsafe situations, etc.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a solid state lamp (SSL) or fluorescent lamp replacement (FLR) with a sensor module in accordance with some embodiments of the invention.

FIG. 2 depicts a fluorescent lamp troffer with an associated sensor module in accordance with some embodiments of the invention.

FIG. 3 depicts a floor plan of a school building including a solid state lighting system with safety indications including directional and status indicators in accordance with some embodiments of the invention.

FIG. 4 depicts a floor plan of a building including a solid state lighting system communicating directions to occupants in accordance with some embodiments of the invention.

FIG. 5 depicts a floor plan of a building including a solid state lighting system communicating the location of a specific area of interest or need from one or more starting locations in accordance with some embodiments of the invention.

FIG. 6 depicts an example login screen of an App for interfacing with/configuring/controlling a solid state lighting system in accordance with some embodiments of the invention.

FIG. 7 depicts example screens of an App for interfacing with/configuring/controlling a solid state lighting system, illustrating an example grouping of or connection between classrooms using lamp linkages in accordance with some embodiments of the invention.

FIG. 8 depicts an example screen of an App for interfacing with/configuring/controlling a solid state lighting system, illustrating the assignment of SSL/FLR lamps to zones within a building in accordance with some embodiments of the invention.

FIG. 9 depicts example screens of an App for interfacing with/configuring/controlling a solid state lighting system, illustrating the use of a smart phone to set zones in a floor plan, to add performance rules, set permissions, etc. in accordance with some embodiments of the invention.

FIG. 10 depicts an example screen of an App for interfacing with/configuring/controlling a solid state lighting system, illustrating a drag and drop interface for adding new sensors, IOT components, reconfiguring existing components or system elements, etc. in accordance with some embodiments of the invention.

FIG. 11 depicts a heat map of a building such as school where one or more perpetrators have entered the building, displaying their movements in the building as tracked by sensors in the SSL/FLR lighting system in accordance with some embodiments of the invention.

FIG. 12 depicts a block diagram of a solid state lighting system including smart units for processing sensor inputs, communicating with controllers or between SSL/FLR devices, etc., in accordance with some embodiments of the invention.

FIG. 13 depicts a block diagram of a solid state lighting system including smart units for processing sensor inputs, communicating with controllers or between SSL/FLR devices, etc., including indicator lights for, for example but not limited to, providing indications of dangerous or safe regions in a building, directions to exits or areas of interest, etc., in accordance with some embodiments of the invention.

FIG. 14 depicts a block diagram of a solid state lighting system including DC to DC converter and control system(s) for processing sensor inputs, communicating with controllers or between SSL/FLR devices, etc., in accordance with some embodiments of the invention.

FIG. 15 depicts a block diagram of a solid state lighting system including multiple DC to DC converter modules and control systems for processing sensor inputs, communicating with controllers or between SSL/FLR devices, etc., in accordance with some embodiments of the invention.

FIG. 16 depicts a cubicle or work space with a solid state lighting system that can be programmed to automatically adjust color temperature based on time of day or other triggers or events or conditions in accordance with some embodiments of the invention.

FIG. 17 depicts a fluorescent lamp troffer with a solid state light source and sensors/indicator lights/danger lights/cameras/microphones/buzzers/speakers/sirens, etc. in accordance with some embodiments of the invention.

FIG. 18 depicts another fluorescent lamp troffer with a solid state light source and sensors/indicator lights/danger lights/cameras/microphones/buzzers/speakers/sirens, etc. in accordance with some embodiments of the invention.

FIG. 19 depicts another fluorescent lamp troffer with a solid state light source and sensors/indicator lights/danger lights/cameras/microphones/buzzers/speakers/sirens, etc. in accordance with some embodiments of the invention.

FIG. 20 depicts another fluorescent lamp troffer with a solid state light source and sensors/indicator lights/danger lights/cameras/microphones/buzzers/speakers/sirens, etc. and with indicator danger lights, etc., in accordance with some embodiments of the invention.

FIG. 21 depicts a non-limiting example touchscreen of an App for interfacing with/configuring/controlling a solid state lighting system, including but not limited to adjusting LED brightness in a group of LED lamps and for placing the system in a particular state such as an emergency or flashing state in accordance with some embodiments of the invention.

### DESCRIPTION

School safety is a matter of great concern to community members as well as education and public safety professionals across the nation as well as in other countries. There is a need for technology improvement in use in K-12 schools as well as colleges and universities and other types of buildings and campuses as well as other institutions, buildings, campuses, offices, etc. to, for example but not limited to, prevent, respond to, and mitigate bad actor, man-made or natural disasters, including but not limited to active shooter, fire, earthquake, smoke, toxic exposure, criminal acts of violence. The approaches and technologies including how they are being used; what is known about their efficiency and efficacy; and factors that may affect their deployment are important considerations. Specifically, while addressing the technology improvement needs; it is important to recognize factors that may affect the deployment of technologies which can make schools safer and other entities, organizations, buildings, structures, campuses, both inside and out (i.e., indoors and outdoors, etc.) and the consideration of cost is one of the highest concerns for adopting the necessary technologies. The present invention involves, among others, school safety systems and safety systems for others that can be embedded into the existing legacy lighting infrastructure of the school system by literally replacing the existing fluorescent light tubes with smart/intelligent two-way communication, internet of things (IoT) and sensor loaded LED tubes and other form factors that directly work with and are powered the existing fluorescent light ballasts without rewiring or new construction including not triggering any codes or requiring construction permits. The present invention also applies to new construction lighting as well as retrofit and replacement lighting, etc. Embodiments of the present invention can provide for retrofitting any existing installation, building, office, structure, campus, etc. to providing lighting solutions and related technologies and products for new construction of any type, level, complexity, size, square footage, installation, building, office, structure, campus, etc. to anything in between including involving both existing and new construction, etc. Embodiments and implementations of the present invention can use any types of technologies in combinations or alone to detect, respond, interfere with, attempt to stop, distract, disarm, etc. including but not limited to strobing to distract, disturb, disorient, etc. an active shooter for example after an active shooter has been detected including gunshot detection, measuring velocities at one or more locations at one or more angles, orientations, noise, decibel level, smoke, thermal response, thermal imaging, gunshot pattern detection, etc., panic buttons, alert buttons, detection of one or more intruders, unauthorized people/personnel, etc. cell phone communications and alerts, computer communications and alerts, tablet and other wired and wireless devices, etc., combinations of these, etc., including from various groups as appropriate for the setting, situation, school, type of business, type of location, type of residence, including but not limited to those discussed herein including but not limited to, as appropriate, students, staff, teachers, instructors, professors, employees, employers, administration, security personnel, police, soldiers, first responders, fire department, 911 personnel, peace officers, military police and others, etc., combinations of these, etc.

Although some safety features supported by technologies can be built into the design of new and remodeled schools, offices, hospitals, senior facilities, stores, malls, campuses, libraries, classrooms, public and private spaces of any type, etc. often in a cost effective manner, however, being able to also provide affordable and effective safety measures to all of the existing school and other types of places, buildings, campuses, etc. systems can be problematic and challenging—the present invention addresses this problem/challenge. For example the present invention can use both new lamp fixtures and lighting as well as a product family of linear and other form factor LED tube lamps and other LED/SSL lamps, lighting, fixtures, luminaires, etc. that provides easy plug-and-play installation (example but not limited to being compatible with most existing commercial ballasted fixtures including school system luminaire infrastructure), high quality uniform and adjustable brightness light, sensor integration, color temperature and color tunable and two-way communication (to, for example but not limited to, gather and provide data and intelligence, communicating and signaling situation, tracking perpetrator(s), and providing safe areas for lock down and paths for escape). Properly integrated, this lighting hardware with its embedded technologies could also be effectively used as emergency and situational management tools for increased school safety and other types of buildings, campuses, etc. safety. As a non-limiting example, these intelligent linear-Fluorescent-Replacement LED tube Lamps (FRLs) can be used as have been developed for and are being sold to the large retrofits market needs in the existing schools, other academic, commercial and industrial buildings as well as hospitals, schools, libraries, public and private buildings, dormitories, apartments, condos, houses, shared residences, shared commercial properties, leased and rented spaces including hourly or temporarily rented, warehouses, stores, malls, outlets, superstores, hotels, motels, and any other types of campuses, buildings, structures, etc. School and other types of building, office, campus, private and public locations, including those described herein, etc. safety-specific software for new construction and linear-fluorescent-replacement intelligent LED luminaire to perform emergency and situational management as an important part of school and other types of safety and also should be physically and rigorously effective including all of its associated protocol practices for this new and innovative school safety tool based on intelligent linear-fluorescent-replacement LED lamps.

The present invention includes but is not limited to solutions including among others and is not limited in any way or form to: (1) direct, layered, two-way communication between for example, for school, college, university and other academic and related situations, teachers and a central command and control system and providing school staff, faculty, administration and law enforcement with critically relevant information identifying the exact location of the threat, position tracking of the threat, signaling status of threat, safe areas and safe paths to retreat during violent and other safety-related events, all with affordable and economical cost and using and building upon existing infrastructure. (2) as the solution can be based on connectivity and IoT, the actions taken and data collected by the system can be integrated with or fed into on-line networks/systems providing school staff, faculty, administration and law enforcement with relevant information to enable the real-time “all-in-one” platform for overall school safety protection. (3) The solution reduces human error; and it can guide the responders in terms of where to make their entrance, signal the situation, for example but not limited to, inside the school so to receive proper responses and planning for maximum safety of the students, staff, faculty, administration and others. (4) The school safety system is future-proof updated including, for example, with communications protocols of newer technologies and can keep up with changes, for example, in state and federal laws. In other embodiments of the present invention, the system can be run in a more manual mode where, for example, but not limited to, modes where teachers, instructors, staff, students, principals, other administrators, a central office, a security officer, an embedded or otherwise police officer, etc. can activate the system, etc. Implementations of the present invention can, for example but not limited to, also use, work, interact with, support, be supported by, other programs, software, Apps, hardware, firmware, infrastructure, etc.

The present invention provides for example but not limited to the, among other types of functional and institutional uses, applications, purposes, etc. school safety specific software for the linear-fluorescent-replacement intelligent LED luminaire and complete the installation in a classroom for the users (teacher and students) including optimization with connectivity and two-way communications for school safety through the linear-fluorescent-replacement intelligent LED lamps with, as a non-limiting example, the desired/necessary/requested/etc. user/stakeholder network including school administrators and law enforcement in a school building setting as well as first responders. Integration with existing school safety measures such as but not limited to video cameras, biometrics, cell phones, tablets, other, for example but not limited to, wireless (non-limiting examples: WiFi, Bluetooth, Cellular, other communications including but not limited to those that have a unique identifier such as a WiFi address, a SIM card including eSiM cards, Bluetooth information, etc.) etc. at, for example, but not limited to entrances to a school building door and/or elsewhere and the school safety functionalities that are capable of handling a large number of safety issues and addressing various safety concerns coupled with software security of the intelligent LED replacement lamps in existing lamp luminaires in an entire school building setting with the system also connected to law enforcement and other first responders. In some embodiments of the present invention artificial intelligence can be used and incorporated as well as on site and remote monitoring and control, etc. Embodiments of the present invention can also interact with existing apps and websites that provide reporting, counseling, identification, warnings, building status and safety information, individual information, student, staff, faculty and/or administration status including safety, security, situational, etc. information, data, etc.

LEDs are and will continue, for the foreseeable future, to be the most efficient and flexible light sources. LEDs have the capabilities to provide significant energy reduction resulting in, among other things, less dependence on foreign sources of energy and less wasted energy including wasted heat energy. It has been established that by Department of Energy (DOE) that advancing energy efficient electric lighting in US buildings could conserve more than 50% of this energy.

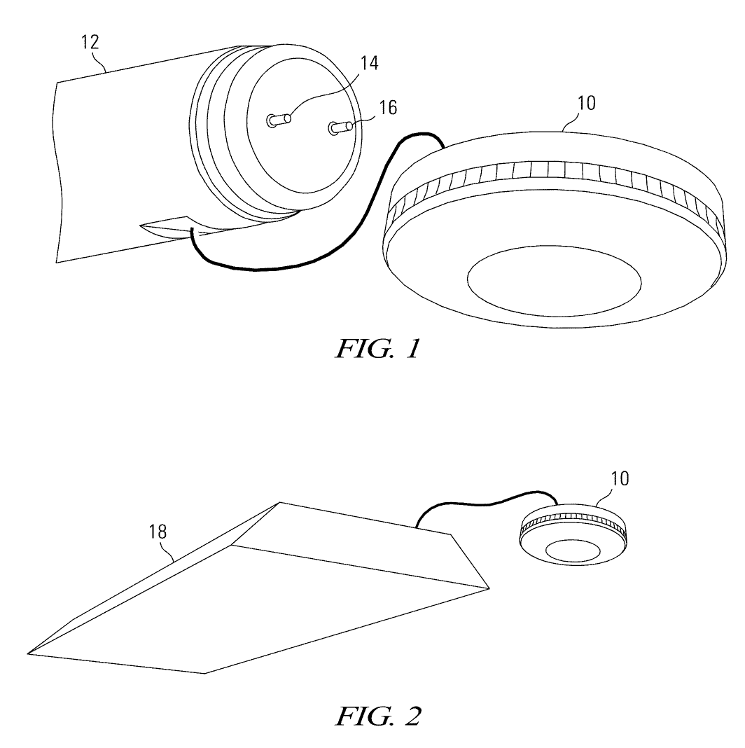

In addition, improved visual quality is a result of several intrinsic characteristics of LEDs and, as a result, LEDs provide quality benefits for general lighting that are not possible using fluorescent or most other types of lighting. Linear fluorescent lamps have the highest number-of-lamps penetration in the commercial and industrial sectors (>80%), and the commercial sector including schools has the highest installed linear-fluorescent base and usage. Part of the reason for resistance in linear LED adoption is the difficulty and expense of working with or around the ballast, which adds a significant layer of engineering complexity for achieving energy saving lighting. This difficulty has been successfully addressed: Linear-fluorescent-replacement intelligent LED lamps (See FIG. 1) into the market to allow additional 35% energy saving through intelligent lighting control including dimming and trimming. FIG. 1 depicts a SSL/FLR 12 with an associated sensor module 10. The SSL/FLR 12 can be installed in a fluorescent troffer by, for example but not limited to connecting bi-pins 14, 16 to a tombstone connector in the troffer. FIG. 2 shows how energy saving is possible through occupancy/vacancy sensing and daylight harvesting functions of the intelligent lighting solution. A sensor module 10 connected to a SSL/FLR in a fluorescent troffer 18 can be used for a number of sensing/indicating functions, as well as providing daylight harvesting, etc. The combined motion and daylight harvesting (DLH) sensor module 10 mounted in a ceiling tile that is wired to powered by and communicates with the intelligent FLR in the troffer 18 which, turn, is powered by the output of a standard non-dimmable ballast). Of course the present invention can also be powered by a dimmable ballast however this is not necessary nor in general preferred. The sensor module can automatically (and, if desired or needed, autonomously) continuously dim the intelligent LED FLR via the ambient light sensor in the DLH and turn on/off the intelligent LED FLR based on signals sent by the motion sensor in the sensor module prototype. Note light from the blue LED inside the sensor is intentionally visible and programmed to turn on when motion is detected.

This intelligent lighting uses built-in two-way communications coupled with control and monitoring technologies which can also form an IOT lighting platform that provide versatile and flexible functions towards different applications. Further configured with multi-channel (e.g., white tunable, color tunable and full spectrum) capabilities, the smart/intelligent/connected, feature-full LED fluorescent lamp replacement products can further perform signaling functions for, for example but not limited to, identifying the exact location and situation, escape routes and locations, compromised routes and locations, good locations, bad locations, unknowns, etc. for use in the school and other types of buildings, structures, etc. including but not limited to those discussed herein.

Since the product family of smart/intelligent fluorescent replacement lamps can support and are compatible with almost any existing linear fluorescent lamp ballast fixture in the school system, it allows economical, cost-effective safety-specific intelligent lighting for the education system and schools with intelligent lighting using the existing lighting infrastructure at far lower cost than full new LED-fixture solutions.

Taking advantage of the linear-fluorescent-replacement opportunity and the linear LED fluorescent lamp replacement that provides plug-and-play installation with wireless and/or wired connectivity, a highly scalable, extremely adoptable, low-cost solution for school safety and other safety discussed herein through the definition and development of application specific intelligent lighting software can be implemented as part of the present invention. The advantages of this solution include easy installation and configuration for school safety specific intelligent lighting application in the built environment. No removal of old fixtures and/or installation of new ones are in general required.

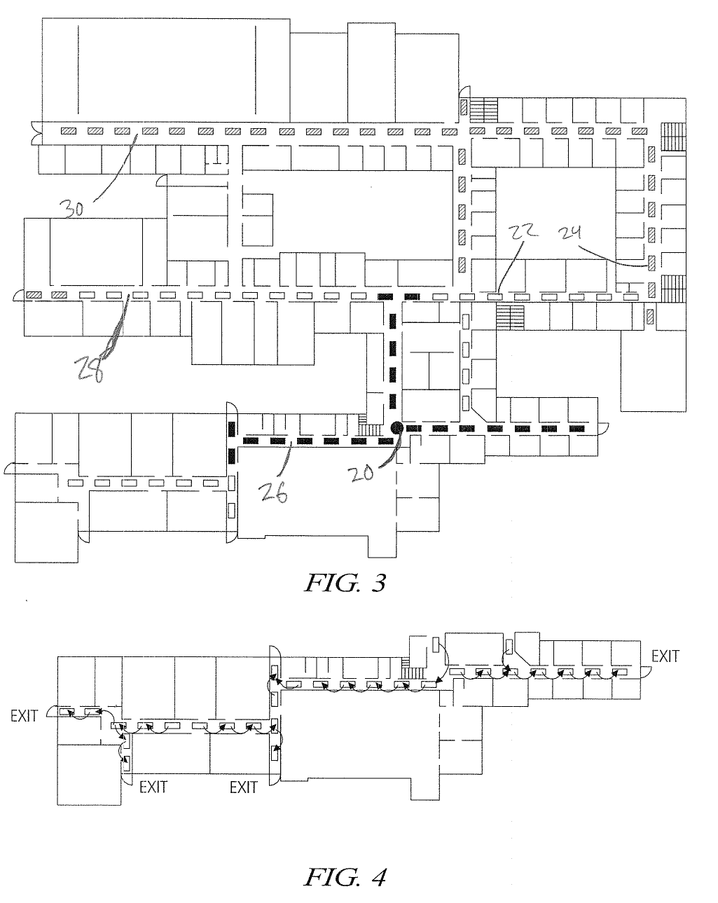

FIG. 3 depicts a floor plan of an example school with a solid state lighting system, which improves school safety through configuring the intelligent LED replacement lamps to identify and continuously track the location of the intruder(s) and to indicate and update the safety situations of different areas. If an intruder 20 is detected or identified either by sensors in the lighting system or by externally provided information, one or more lamps 22, 24 can change color, lights can be used to warn occupants and help law enforcement for example with red in line of sight hallways 26, yellow in adjacent hallways 28, green in hallways 30 leading to safe areas for lockdown or exits, etc. In one non-limiting example shown in FIG. 3, SSL/LEDs set to yellow are depicted as empty rectangles (e.g., 22, 24), SSL/LEDs set to green are shown with diagonal hatching, and SSL/LEDs set to red are depicted as solid black rectangles.

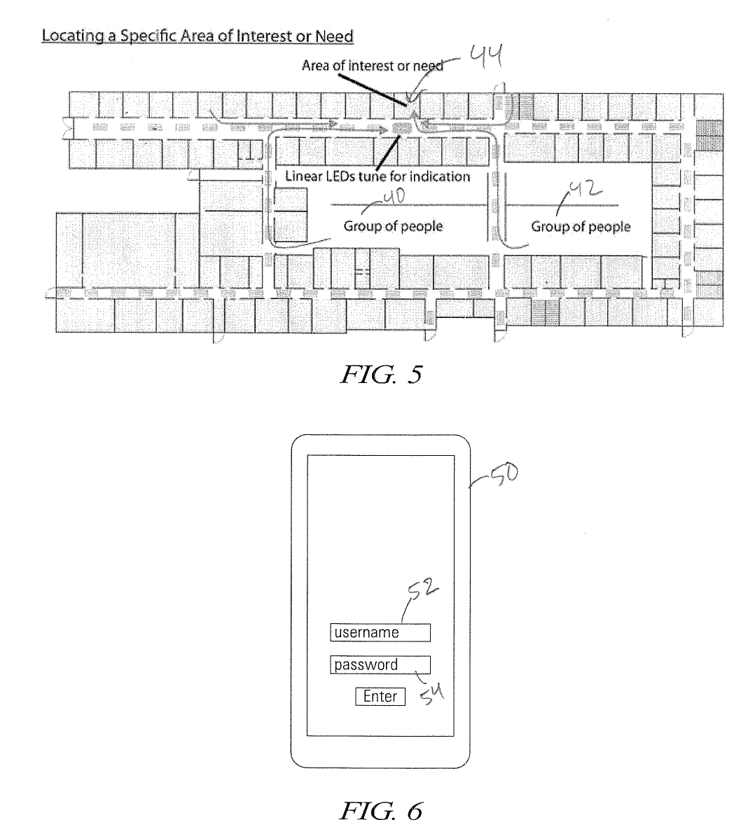

Configuration of the lighting system can be straightforward and accomplished through application-specific software. This approach eliminates extensive and expensive contracting and maintenance costs, and is upgradable and future-proof. The following are only merely a few non-limiting examples of the present invention software functionality in potential applications for the non-limiting example of a school safety system: FIG. 3 depicts an example scenario with identification of the affected or danger areas of a school when intruder(s) or perpetrator(s) show up, FIG. 4 illustrates a light signal which helps to guide the escape route of teachers and students, and FIG. 5 illustrates a light signal which helps to lead the school administrator or law enforcement effectively and quickly to the site requiring help, action, response, etc. In FIG. 4, fixture-to-fixture sequential flashing is pre-programmed to lead students or workers to a nearest exit in an emergency or to a place or destination in an event (i.e., concert, play, etc.) Notably, directions to the nearest exit from virtually any location in the illustrated building can be provided by the fixture-to-fixture sequential flashing represented by the curved arrows. In FIG. 5, linear LEDs are tuned or programmed to indicate the location of an area 44 of interest or need, and can indicate directions to such an area from multiple start points 40, 42. For example, in a hospital, such lighting can be used to rapidly guide doctors, nurses and others to the location of a room in which a code or other emergency requires immediate attention.

The software platform supports the various applications for school safety through programming the lighting and associated systems to perform different built in functions some non-limiting examples of which will be discussed below:

Application 1: Upon receiving an alert from, for example, a motion sensor or video camera or, as another example, a panic button indicating a suspicious entrance, the lights will start to perform through their respective motion and other sensors as well as other surveillance elements including optional cameras that are attached to and powered by the intelligent LED fluorescent replacement lamps and/or new construction lights and fixtures that, for example but not limited to, also have the ability to supply power to other devices, sensors, lights, cameras, IOT, other sensors, speakers, microphones, sirens, buzzers, etc. including but not limited other safety devices discussed herein, and provide continuous identification of the location of the intruder(s) and continue to track the movements of the intruder(s) and communicate the whereabouts of the bad actor(s) or other intruders that may pose potential danger. At this point, if the danger of the intruder(s) has already been confirmed then the lights will indicate the danger areas as distinct from safe areas through, for example but not limited to color or flashing or both changes in the lighting for situational indication as shown in FIG. 3 for teachers or others to take action to lock down the classrooms or to take the students out through safe paths also being signaled by the lights (Application 2 in FIG. 4), however, if the danger has not yet been verified, then school administrators and security staff could follow or remotely monitor the lights and associated sensors, IOT, etc. to reach, for example but not limited to, the intruders as shown in FIG. 5 (non-limiting example Application 3). It should be pointed out that one or more effective escape route(s) for the students and can also be supported by non-limiting example Application 2 so there will not be overcrowding of one particular exit which creates another type of danger to the students and teachers while exiting the danger area. The lighting system can be used to improve safety by identifying and guiding in dangerous situations, and/or for convenience of occupants during more normal activities, guiding occupants to their destinations, indicating status, etc. While non-limiting examples have been disclosed involving schools and hospitals, the lighting system is not limited to use in any particular type of facility or building. A few other non-limiting example uses include, but are not limited to, supermarkets, drug stores, media centers, newsrooms, newspaper facilities, newspaper headquarters, newsrooms, TV station, high tech facilities, office, corporate, R&D, any type of places where people congregate, work, socialize, operate, meet, function, etc.

In terms of the software/Apps for school safety itself, passwords can be required for access and verification of different levels of authority and privileges in terms of controlling the lights, the sensors and communications (etc.).

The SSL/FLR lighting systems disclosed herein can be implemented in any suitable manner, such as, but not limited to, those disclosed in PCT patent applications PCT/US16/45659 filed Aug. 4, 2016 for “Solid State Lighting Systems”, PCT/US16/52560 filed Sep. 19, 2016 for “Solid State Lighting Systems”, PCT Patent Application PCT/US15/32763 filed May 27, 2015 for “Lighting Systems”, in U.S. patent application Ser. No. 15/586,216 filed May 3, 2017 for “Safety Lighting and Monitoring”, and PCT Patent Application PCT/US16/69054 filed Dec. 28, 2016 for “Personalized Lighting Systems” which are incorporated herein by reference for all purposes. A tagalong inductor such as those disclosed in U.S. patent application Ser. No. 13/674,072, filed Nov. 11, 2012 by Sadwick et al. for a “Dimmable LED Driver with Multiple Power Sources” can be used with embodiments of the present invention.

Embodiments of the present invention can also use an infrared to RF wireless universal interpreter/converter as described in PCT Patent Application PCT/US15/12965 filed Jan. 26, 2015 for “Solid State Lighting Systems” which is incorporated herein by reference for all purposes.

FIG. 6 depicts an example login screen on a smartphone 50 or other device for an App to interface with/control a smart lighting system such as those disclosed herein. If a username 52 is not recognized then the App can prompt with a “new user” screen. If a password 54 is entered incorrectly, or is not recognized after one try the app can prompt with a “forgotten password” page. After a specified number of attempts, information regarding the source (i.e., phone number of the smart phone, IP address of the WiFi for phones or tablets, or laptop or desktop local area network (LAN) identifier, etc. can be sent to the appropriate person or persons in IT or administration and appropriate action based on specific protocols can be taken.

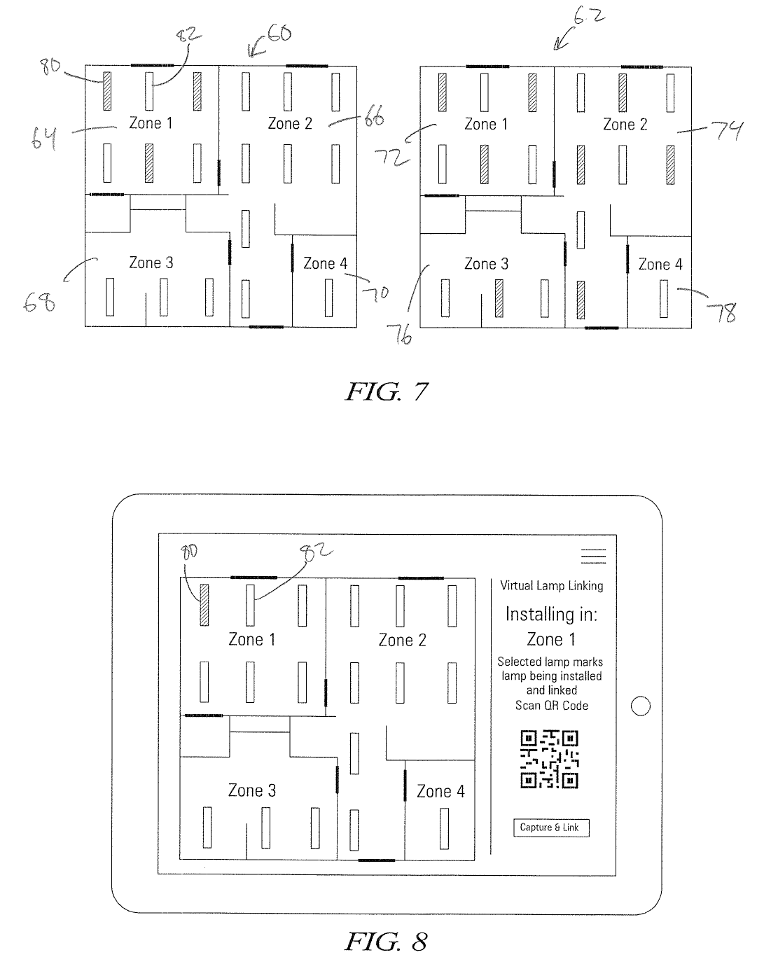

FIG. 7 depicts a non-limiting example of a setup and configuration of the lighting in two interior areas 60, 62 each of which consist of four zones 64, 66, 68, 70, 72, 74, 76, 78 in terms of the arrangement of the intelligent FLRs with sensors and two-way communications. For example, two different depicted classrooms are being connected through MetaZones which have been set up to show alternative lamp linkages as depicted by hatched (e.g., 80) and non-hatched (e.g., 82) indicator lamps.

Note that, with the non-limiting example of proper permission levels, the App in FIG. 8 allows for ‘MetaZones’ to be created. These MetaZones can be dynamically-defined between components in the lighting database to group components in the lighting database into, for example, but not limited to, MetaZones comprising a set of lamps (e.g., 80, 82) that can, as a group, be given a rule, linked to one or more sensor(s), linked to, for example, but not limited to a control, or controlled automatically or manually. These MetaZones are stored in the Smart Lighting software. MetaZones can be temporary (i.e., not permanent) or semi-permanent to permanent, configurable, and reconfigurable and can, for example, but not limited to be used to adapt to emergency situations, provide information to persons or first responders, etc. Subzones and MetaZones can be re-assigned as needed including treating the MetaZones as separate or a single space in response to, for example, functionality needs or in response to the identification of the perpetrator(s) and performing other functions including situation signaling. Note that the MetaZones can be used to either expand or reduce the number of temporary zones an area that has one or more zones. Such expansion or reduction can be used to help locate, pinpoint, respond to, etc., the one or more perpetrator(s), emergency, exit routes, etc. As an example of exit routes, the MetaZones can be dynamically used to set one or more exit routes.

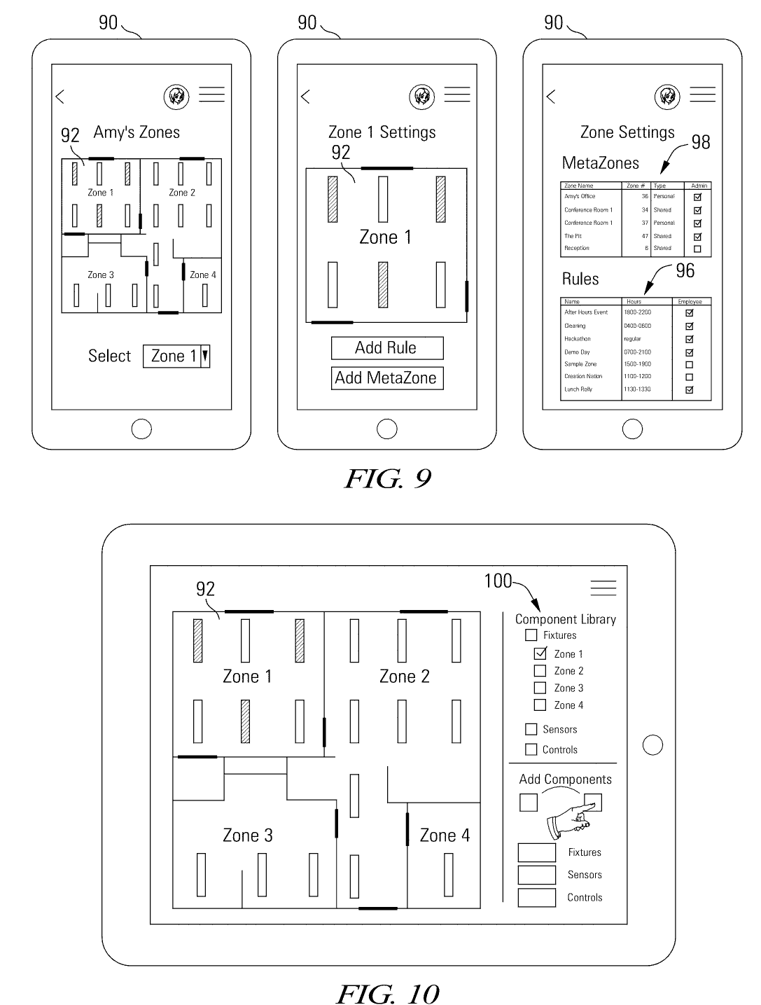

FIG. 9 shows a non-limiting example of a smart phone 90, with proper password entry and permission, being used, for example, to set the Zones and/or MetaZones for a certain area 92 such as one or more classrooms, cafeteria, gymnasium, administration offices, etc. The User can select specific zones (e.g., 92) to which to add performance rules as well as new MetaZone rules 96. The User can also see the total list 98 of MetaZones and Rules they have created and have the ability to modify, delete, or add to these at any given time. However in times of emergency or identification of intruder(s) or perpetrator(s), permission levels and authorizations can be restricted, denied, modified, etc. Compromised or at-risk/in harm's way users can have additional options including sending a personalized and uniquely activated SOS emergency or distress signal that can also be

coordinated with the intelligent lighting system in a number of ways. The distress/emergency signal can be sent in coded, secure way so that the intruder(s) or perpetrator(s) would be unaware that such a signal had been sent, or if appropriate, the signal could trigger certain modes including visible modes such as flashing, strobing, optional color changes, alarms, alerts, sirens, etc. as well as other methods/ways of coordination, synchronization and communications.

FIG. 10 shows a non-limiting example of system administrators and/or (if permission is granted) Users being able to use a virtual representation of the “floor plan” and relative lighting plan to add or remove components to a physical zone (e.g., 92) within a space. The user would be able to drag and drop these components into a zone, thus adding them to the component library 100. The user would be able to drag and drop these components into a zone, thus adding them to the component library 100.

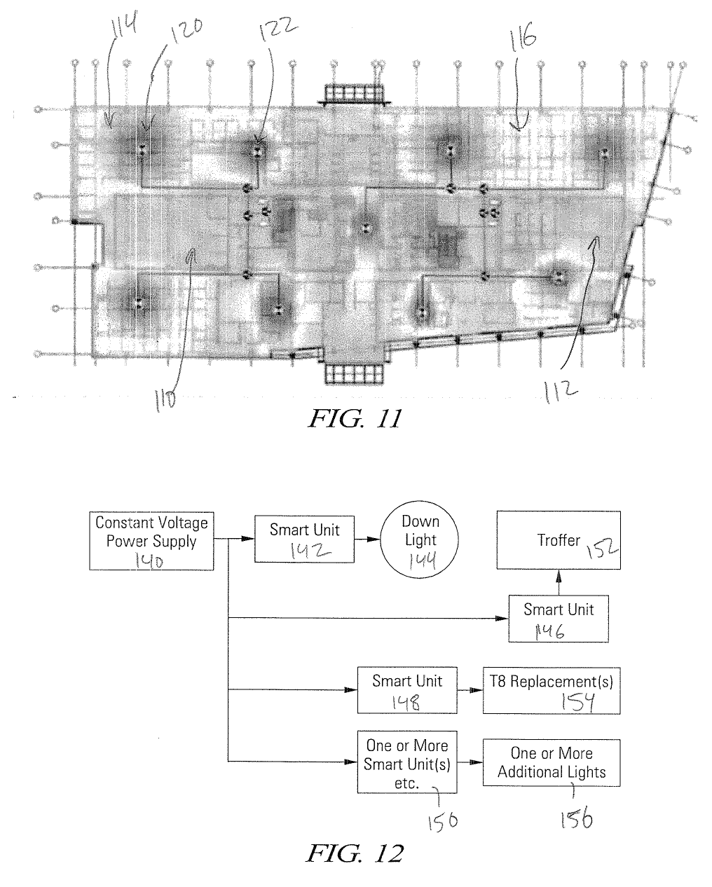

FIG. 11 shows a heat map of a building such as school where one or more perpetrators have entered the building and shows their movements in the building. The school safety system software will also provide timing information including but not limited to highlighting the last/current location of the one or more perpetrators. The school safety system can also interact with, control, be controlled by other programs, software(s), Apps, etc. Safe zones 110, 112 can be illuminated in a first color (e.g., green), potentially risky zones 114, 116 in one or more second colors (e.g., blue/purple), elevated danger zones in third colors (e.g., yellow) and highly/extremely dangerous zones 120, 122 in a fourth color (e.g., red). Such a heat map could be used, for example by students, staff, faculty, and administrators as well as first responders in terms of safe zones/areas, location(s) of perpetrator(s) or emergencies such as fire, gas leaks, etc.

Communicating, sending alerts and alarms about potential dangerous and other situations and events through and by utilizing the lighting system eliminates and mitigates the necessity of staff members or teachers or others being forced to put themselves into additional danger and harm's way to activate an alarm or investigate under dangerous or compromised situations. Lights indicating the exact location of the danger can provide a low cost alternative for geographic information system (GIS) mapping which is very costly to achieve or, in some embodiments and/or implementations could also incorporate GIS if desired. Furthermore the light signaling providing indication(s) of situation (through, for example, color or other coding) and effective safe and secure locations, passageways, and/or paths to take or retreat to, provides additional capability which is not currently available and highly desired. The lights could also be put into a strobe, stroboscopic, strobing, strobe-like, flashing, pulsing, pulsating, etc. mode or modes of any frequency, one or more frequencies, periods, time periods, duty cycles, etc. Such mode or modes could be done locally, globally, only in the proximity or proximities of the intruder(s), bad actors, active shooter, etc. In addition, sirens, speakers, sound generators, frequency generators, etc. of essentially any kind can also be used with and as part of the present invention. In some embodiments of the present invention a frequency of around or about the 15 to 20 kilohertz (kHz) such as in particular 17 kHz can be used. In some embodiments of the present invention empathetic sensors, sensory systems and controls and electronics as well as artificial intelligence or both of these or either can be employed.

Note that for each application involving software, the software can integrate sound cybersecurity protocols, including those outlined in the Department of Homeland Security's ICS-CERT tool, to ensure system security.

Building into the linear-(and/or other form factors) fluorescent-replacement (FL) intelligent LED lamps, school and other entity, environment, building, campus, office, warehouse, etc. safety specific functions allows for minimal investment, minimal infrastructural change, comprehensive tracking of the perpetrator(s) while monitoring, sharing, interacting with and communicating the threat to the appropriate personnel, providing indication of safety situation and guidance for the potential escape and response paths, etc. while at the same time, producing a much-improved lighting experience. In other situations, new construction fixtures, luminaires, lighting, lamps, etc. can be used that perform the same functions and features and have integral sensor(s), notification lighting, IOT, speakers, microphones, performance, capabilities, wayfinding capabilities, strobing, etc. as discussed herein for linear FL intelligent LEI) lamps and lighting. In some embodiments previously retrofitted lighting can be retrofitted with the present invention to retrofit the retrofits, including but not limited to, to implement embodiments of the present invention including replacing or augmenting the existing lighting including but not limited to replacing or augmenting existing LEDs with additional LEDs to perform the functions and features discussed herein including adding either or both additional color temperatures and/or colors.

It is worth noting that the linear-fluorescent-replacement intelligent LED lamps give users greater control of their lighting experience (dimming, trimming, color temperature tuning or optional color tuning, scheduling, sensor thresholds), which has thus far largely been limited to on/off switching in the commercial and industrial sectors, and affects the comfort level and productivity of users and can have additional positive effects on other issues, including health, weather-induced and season-related disorders and aid in regulating light exposure therapies including circadian rhythm alignment and other light therapies as well as providing better illumination, increased security and other features as well as higher productivity and attention in the classroom. In some embodiments of the present invention environmental sensors including but not limited to temperature, humidity, carbon monoxide, carbon dioxide, other airborne environmental gases, volatiles, toxins, pollution, etc. can be monitored including but not limited to an internal and/or a remote connection to embodiments of the present invention. For example, the temperature could be measured remotely from the lights including above a ceiling including but not limited to a false or gridded, etc. ceiling to check for temperatures outside the normal range that might be indicative of for example, but not limited to, a fire if too hot, a possible breakage of plumbing including fire suppression/sprinklers/etc. if too cold especially in climates where there can be sub-zero temperatures without heating provided, etc. The humidity sensor can be used alone or coupled with for example but not limited to water sensors, flood sensors, moisture sensors, water leakage sensors, spill sensors, water detectors, flow detectors, combinations of these, etc. to detect/sense the presence of water due to, for example but not limited to, a leak, a broken pipe, an overflowed water or other liquid container, a broken bathroom fixture such as a sink, toilet, urinal, shower, bathtub, etc., a leak from a dishwashing machine, a washer, other types of sinks, etc. rain due to a breach of a roof or from a floor above, etc. All of these are merely intended to be simple non-limiting examples and not limiting in any way or form. As another non-limiting example, one or more sensors including but not limited to one or more of a temperature sensor(s), humidity, moisture, water, air quality sensors can be powered by the present invention and inserted into the plenum of a room, ceiling, building, etc. and communicate by wired or wireless or both means.

In some embodiments, sensors are used to detect the intensity and/or color and/or color temperature of light reaching the sensors. Such data can be gathered and tracked over various time periods and used to customize and control the light produced by light sources in the system. For example, such data can be used to control light therapy treatments, to counteract the effect of undesirable light levels, light temperatures, etc. to which users are exposed. If, for example, a user is exposed to harsh and/or improper lighting conditions or to light colors or temperatures that tend to disrupt circadian rhythms, the lighting system tracks this exposure with one or more sensors, and could for example but not limited to, uses this data to customize the illumination levels, colors, and light temperatures output for the user at home to counteract the effects of the exposure to harsh or otherwise inappropriate and/or improper lighting. This can be used to improve circadian rhythms, season-related disorders, provide a more soothing lighting environment when needed in response to previously detected harsh or improper lighting conditions, aid in anti-aging, aid in lighting related health and lighting therapies, etc. This data can be used for other purposes as well, such as, but not limited to, correlation of lighting conditions with health care or health concerns, anti-aging, injuries, etc. for one person or many people. Big data mining techniques or artificial intelligence (AI) data processing techniques as well as virtual reality (VR) and augmented reality (AR), etc., combinations of these including but not limited to combinations of Big Data mining and AI, VR, AR, etc. can be applied to the data from such a system, and the results can be used to further customize lighting control or can be monetized in a variety of fashions.

Further note that all these functions are achieved at a reduced energy consumption level thus providing cost savings compared to traditional fluorescent lighting ceiling-based luminaires for schools. Specifically, it has been shown that linear-fluorescent-replacement intelligent LED lamps achieve energy savings of higher than 50%. The intelligence which could be part of the safety specific software for the linear-fluorescent-replacement intelligent LED luminaire will aid in performing additional aggressive energy savings through identifying areas which do not require a lot of artificial lighting or little traffic as determined by, for example, but not limited to, heat maps using, for example, but not limited to motion, gas, noise, radar, ultrasonics, carbon dioxide, etc., combinations of these, etc. sensors during certain times of the day or even night and as a result, provide additional energy savings of 35% maximum possible. As the energy saving is immediate and maintenance is reduced to changing ‘light bulbs’ (tubes) with many times longer lifetime than existing school or other, for example but not limited to, institutions, business, public, private, etc. organization lights, therefore, being able to achieve return on investment in relatively short period of time can be another saving in funding for, for example but not limited to, school infrastructure, resources and tax dollars.

The power of a robust intelligent lighting system that can affect the commercial and industrial build environment has another powerful benefit: the foundation for a smart building. Lighting fixtures in these environments are 1) ubiquitous and 2) powered, which provides the best first step for both energy savings and installing a sensor network that can be used for other benefits, such as greater HVAC and equipment efficiency and alarm-system security and numerous other IOT applications including motion, occupancy/vacancy, camera monitoring, voice and/or pattern communications and recognition, etc.

Additionally, the safety specific integrated lighting hardware & software is also applicable to other public and commercial buildings in a variety of settings including but not limited to those discussed herein. There are a large number of immediate beneficiaries of this technology within the commercial and industrial sectors. Furthermore, it is important to note that once replaced with intelligent LED lamps whether retrofit or new construction or both, immediate energy saving could be achieved and achieve return in investment in a few short years. In addition, the intelligent LED lamps are designed to be future-proof and the maintenance consists of simple unplugging an old and plugging a new lamp in the unlikely event that there should be a failure or other issue with one or more of these lamps Since there is also no mercury inside these LED lamps, schools also save environmental fees to dispose of the lamps at end of life; therefore, among other things, reducing significantly the maintenance requirements as well. The present invention presents an excellent, economic and efficient school safety measure with numerous additional value-added benefits including higher quality light, dimming, trimming, color tuning, color temperature tuning, substantial energy savings, increased productivity, increased learning, etc.

The present invention can also include geographic information system (GIS) mapping which can be combined with an alternative low cost solution of utilizing the distribution of the lamps in schools and buildings to provide such location information and position tracking which are critical to emergency and other first responders without the need to change or alter the existing school infrastructure thus resulting in substantial cost savings without function or performance loss and in general, in fact, greatly enhanced features and performance.

The school safety emergency alarming and management system built into, for example, but not limited to the linear-fluorescent-replacement intelligent LED lamps can employ technologies that have minimal concerns. Furthermore, this solution effectively addresses concerns about cost affordability and associated easy installation and implementation as the system can be installed literally by just changing the light bulbs (i.e., replacing the fluorescent tube lights). This solution can be designed to anticipate potential adherence to protocols failures by school administrators, faculty, staff and/or students as a way to reduce the negative effects and impact of human errors and these intelligent LED lamps will navigate past potential human errors in intruder/perpetrator/bad actor/active shooter situations and other potential safety threats to adhere to and follow protocols during emergencies as well as routine operation. Embodiments of the present invention can use artificial intelligence, empathetic hardware, firmware and software, augmented reality, virtual reality, other types or modes of reality modifications, apps, web and internet interactions and support, communications, data mining, social media, etc., combinations of these, etc.

The power supply or supplies for the present invention can include, for example, but not limited to one or more linear circuits, zero linear circuits, one or more switching circuits of virtually any topology including but not limited to non-isolated or isolated, combinations of these, etc. For example, but not limited to a non-isolated switching/storage circuit/power supply would be a buck (or boost, or boost-buck or buck-boost or others discussed herein) switching circuit that can be used with both a ballast or AC line which can also be optionally remote controlled and have features including OTP, OVP, SCP, dither, etc. and can be used with all types of ballasts including electronic rapid start, instant start, programmed start, preheat, magnetic, etc. that can be remote controlled and monitored and also has remote control/dimming. Examples of isolated circuits include but are not limited to one or more of galvanic isolated circuits, flyback isolated circuits, forward converter isolated circuits, push-pull circuits, etc., combinations of these, etc.

Any appropriate topology can be used to draw power either from the ballast (if installed) or AC line to power internal circuits, sensors, etc. In some embodiments, the internal power supply can be used to generate power for internal circuits, sensors, etc. as well as external circuits, sensors, IOT, controls, communications, detectors, sirens, cameras, arrays, pattern, voice, sound, facial, etc. sensors, detectors, etc., combinations of these including but not limited to those discussed herein without impacting the constant current to the lighting output. In other embodiments of the present invention the current/power to the lamp may not be controlled and will depend on the ballast and the applications and uses of the present invention. In some embodiments of the present invention, the light output may not be directly controlled or regulated however the one or power supplies with one or more isolated or non-isolated outputs may be used to provide internal and/or external power to sensors, IOT, controls, communications, etc., combinations of these, etc. including but not limited to those discussed herein using/with one or more of a fluorescent lamp ballast, a HID ballast of any type or lamp type, etc. including but not limited to electronic and magnetic ballasts for use with any type of gas discharge device including but not limited to any type of fluorescent, HID, Neon, etc. lamp ballast.

In some embodiments of the present invention, one or more time constants may be used to provide feedback and control. In some implementations of the present invention it may be useful to turnoff or turn on one or more time constants or other feedback or control circuits when in the ballast powered mode of operation compared to the AC mode of operation. For such cases, a circuit may be used. The circuit should not be taken to be limiting in any way or form.

Some embodiments of the invention include Identification Switches with, for example but not limited to, RFID and/or NFC. Other embodiments could have mechanical to electrical switch and/or gesturing, etc. that could, for example, but not limited to ZigBee to RFID, BTLE to RFID, etc. Control circuits interface with the FLRs, powered by any source, including but not limited to, power from the AC line or ballast output, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet, DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc. WiFi to RFID, vice-versa, etc., two-way communications, etc. are just a mere few of the non-limiting examples. Embodiments of the present invention can also be powered by low voltage output power sources) including with power over Ethernet (POE). Power switching and/or dimming can be of any known type including but not limited to electro-mechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

The SSL systems can be powered by any suitable source(s), such as, but not limited to, a ballast output via heater emulation and rectification circuits(s) and/or AC inputs via EMI filter and rectification circuits(s). In addition to AC power from the grid or off-grid sources, DC power, solar power, Power over Ethernet, etc. can be used to power implementations of the present invention.

Power supply can pass power through to solid state lights and can provide one or more of the functions disclosed herein, such as, but not limited to, current control, undervoltage protection (UVP), overvoltage protection (OVP), short circuit protection (SCP), over-temperature protection (OTP), variable impedance control, etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

A lighting control system with wired and/or wireless communications in accordance with some embodiments of the invention. A controller communicates with a remote device such as, but not limited to, a cell phone, tablet, laptop, computer, etc. through a wireless interface. The controller can also communicate with a tablet, laptop, computer, server, dimmer, remote, wall, controller, energy management, other, etc. through a wired and/or wireless interface. The controller can generate one or more control signals to control one or more channels, colors, etc. in a lighting system, for example but not limited to using a DC signal (e.g., 0 to 10V DC, 0 to 3V DC), PWM out, or any other signal type including but not limited to DMX. The controller can receive one or more inputs used to generate the control signals, such as, but not limited to, one or more daylight harvesters, one or more motion sensors, one or more sensors including IOT sensors, one or more temperature, environment sensors, one or more other IOT devices, etc. In some embodiments of the present invention, the motion detectors including of any type including but not limited to occupancy sensors in general, vacancy sensors in general, movement and/or volume sensors and detectors, IR sensors, reflectance sensors, time of flight sensors, microwave, RF, millimeter, terahertz, video, heat, thermal sensors and detectors, combinations of these, etc. can for example, provide information that can be analyzed, studied, mined, synchronized, etc. including either or both real time and off line, etc. such that, among other things, the motions can be to detect intruders, bad actors, active shooters, fires, spread of fires or other damage, etc. The motion detectors, other sensors, etc. can also be used in combination with, for example, either individually or with for example one or more of biometrics, cell phone data and information, facial recognition, lack of facial recognition, human response, panic or emergency situations, etc.

the lighting fixture allows a flexible number of lamps from 1 to N. Such a complete system could include typically a controller and monitor and one or more (i.e., multiple) solid state lighting drivers and sensors including Internet of Things (IOT) sensors and other devices in accordance with some embodiments of the invention.

An in-socket solid state lighting-compatible flexible fixture allows for analog and/or digital control/interface pins/connections that allows for safe electrical, mechanical and other connections and installation in accordance with some embodiments of the invention.

A solid state light mounted in an in-socket solid state lighting-compatible controller/dimmer can include a holding bar in an open position, enabling tombstones to be attached and moved in accordance with some embodiments of the invention.

A solid state light mounted in an in-socket solid state lighting-compatible controller/dimmer can include a holding bar in a closed position, holding tombstones in place in accordance with some embodiments of the invention.

Aspects of the present invention can be made to be transparent or nearly transparent and mounted on, embedded in, attached to, etc. windows to control, monitor and permit appropriate wavelength light transmission.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a fluorescent light replacement (FLR) where one side contains a solid state light (SSL) that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital, senior care facility, clinic, retirement home, assisted living, assisted care, other facilities, building, conference rooms, schools, colleges, universities, dormitories, apartments, condos, houses, libraries, public and private building, locations, structures, etc. (i.e., for example but not limited to code red, code blue, code yellow, other codes, other signals, etc. to indicate situations, emergencies, types of emergencies, status, statuses, conditions, responses, occupancy/vacancy, intruders, danger, dangerous situations, etc.), accent lighting, mood lighting, location indication, emergency information and direction, full spectrum lighting, etc. Some embodiments of the present invention can use multi-SSL packages, for example, multi-LED packages that have more than one LED on a package; as an example, a multi-LED package that contains one or more white color temperatures having different kelvin ratings, an amber LED and a blue LED. Such a package can provide different white combinations along with enhanced blue wavelength content to support wake up for circadian rhythm support as well as amber color to support falling asleep and sleep and also for short wake-up periods to get up to, for example, go to the bathroom and then go back to sleep. In addition to the multi-white color with blue and amber, other colors can be included or substituted including, but not limited to yellow, green, red, orange, other whites, additional whites, purple, yellow-orange, white, violet, mint, yellow, orange, etc., combinations of these, more than one of these, etc.

The present invention can work with all types of communications devices including portable communications devices worn by individuals, walkie-talkie, handie-talkie types of devices, etc.

The present device can use combinations of wireless and wired interfaces to control and monitor; for example for a linear or other fluorescent replacement for, for example, but not limited to, T4, T5, T6, T8, T9, T10, T12, PL 4 pin and 2 pin etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters may transfer, transmit, or receive, etc. information, data, commands from other wireless equipped fluorescent lamp replacements, etc. of combinations of these. Wireless options include but are not limited to RF, microwave, optical including infrared transmission and receiving using modulated/demodulated signals including but not limited to approximately 30 to 42 kHz signals, etc. for the master/slaves.

The present invention can also have one or more thermometers, thermostats, temperature controllers, temperature monitors, thermal imagers, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc. as well as web-based, WiFi-based, Bluetooth, ZigBee, ZWave, etc. of any type, form, implementation, protocol, etc.

In some embodiments of the present invention, the thermometer(s) and/or thermostats may be remotely located. In other embodiments of the present invention, such a temperature sensor or sensors or thermostat or thermostats, thermal imagers, pyrometers, etc. can use wireless or wired units, interfaces, protocols, devices, circuits, systems, etc.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, gyrometers, goniometers, etc., including by reflecting an optical signal from a surface for example, but not limited to, using a mirror to reflect an optical signal when the door is vertical and such that the optical signal does not reflect back from the door in a vertical state/position, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included or used in the present invention to track the location and, for example, to also make decisions as to where and when the present invention should do certain things including but not limited to turning on or off, dimming, etc. Such GPS systems can also make use of cellular phone capabilities as well as other wireless devices using for example signal strength and/or triangulation, etc.

Some embodiments of the system can include thermal imagers including but not limited to IR imagers, IR imaging arrays, non-contact temperature measurements including point temperature and array temperature measurements. These and other sensors are powered in some embodiments by power supplies/drivers/controllers in the lighting system. For example, these and other sensors can be powered and controlled by circuits in a fluorescent replacement lighting system, deriving power through the ballast in a fluorescent fixture or directly from an AC line through the fluorescent fixture if the ballast has been removed. Such sensors can be used to identify normal ambient conditions as well as emergency conditions, and can be used to control lighting and other systems as well as to initiate reports via web, internet, email, text, telephone, etc., or to trigger alarms such as sirens, flashing lights of one or more colors, etc. For example, an IR imaging array in a lighting system can detect cold spots in a room such as an open window or door that should be closed to save energy when outside temperature falls, or to detect hot spots such as a fire or overheating or faulty electrical outlet.

Embodiments of the present invention allow for dimming with both ballasts and AC line voltage, as will be discussed in more detail below. Embodiments of the present invention can use parameters such as current or light intensity to set level of the present invention. Embodiments of the present invention can use one or more variable capacitors or variable impedance to set the output level.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. All types of ballasts may be used with various embodiments of the present invention including but not limited to instant start, rapid start, program start, programmed start, preheat, and other types and forms of both electronic and magnetic as well as hybrid ballasts. In various embodiments of the present invention, different wavelengths, combinations of colors and phosphors, etc. can be used to obtain desired performance. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T6, T8, T9, T10, T12, PL 4 pin and 2 pin, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, purple, etc. color detectors could be included as part of the spectral/spectrum sensor or sensors. In some embodiments of the present invention, quantum dots can be used as part of and to implement the spectral/spectrum sensors.

The present invention can used as a switch to open or close, for example, garage doors and other types of residential, commercial or industrial doors by, for example, sending a signal such as a contact closure to open/raise or close/lower the door or doors or, for example, gates at a parking garage or other types of facilities. Such a signal can be activated using wired, wireless, or powerline approaches including serial, parallel, analog, digital, combinations of these including but not limited to those discussed herein including but not limited to Bluetooth of any type or flavor including Bluetooth, Bluetooth low energy, WiFi, IEEE 801, IEEE 802, ZigBee, ZWave, other 2.4 GHz and related/associated standards, protocols, interfaces, RFID, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc. In addition, voice commands, voice recognition, voice detection, fingerprint, retinal, face, speed, velocity, proximity, direction, time of day, location, whether conditions, weight, height, other features, motion, other characteristics, other forms of detection, etc., other combinations can be used in combination to command the door to open or shut. Optionally, horizontal and vertical detection can be used for example on garage doors, residential, commercial, industrial, etc. doors of any type and form including recreational vehicle (RV) and boat doors, storage facilities, etc. to command, detect, report, alert, alarm, monitor, control, etc. An example embodiment could use for example a Bluetooth controlled switch that can be activated from a cellular phone or tablet which could take in gesture commands, typed commands, voice commands, and other forms of commands to open or close the respective door by activated the switch. This example could also be coupled with detecting the distance of approach or a vehicle, bicycle, car, automobile, person, animal, other types of moving inanimate or animate (or both) objects, etc. combinations of these, etc. For example, as a car approaches a driveway or gate (including but not limited to home gates, parking lot gates, etc.) or both the signal strength of the Bluetooth device (i.e., cell phone, smart phone, tablet, custom remote, generic remote with Bluetooth) can be detected to achieve an appropriate signal strength level to open the gate or garage door or both. As another example, GPS can be used to detect the car or other inanimate or animate moving toward or away from the garage and the present invention can take appropriate action, for example, opening the garage or closing the garage as the car or other inanimate or animate moves toward or away from the garage. In still other example embodiments, voice commands can be used as part of the present invention with either dedicated to this purpose or general usage as part of the overall present invention with specific or distributed microphones, etc. to open or close the door or gate either with or without devices using, depending on the desired level of, for example, security, specific commands or secure commands or voice identification commands.

Such implementations of the present invention can be battery powered, solar powered including with both sunlight and ‘artificial’ light from light sources, battery powered with solar charging including with both sunlight and ‘artificial’ light from light sources, vibration and/or mechanically powered, battery powered with vibration or mechanical charging of the batteries, etc., being powered by the garage door opener, the gate opener, lighting for opener, AC wall power, other sources of power, etc., combinations of these including with both sunlight and ‘artificial’ light from light sources, etc. The switch or switches can take a diverse variety of forms including, but not limited to, electrical, mechanical, electromechanical, semiconductor, transistors of any type, vacuum tubes of any type, relays of any type including coil, reed, solenoid, static, latching, etc. Implementations of the present invention can be put at virtually any location and consist of a black box with no auxiliary user inputs, an on/off switch that is in parallel with the remotely controlled switch or switches, a toggle switch that is in parallel with the remotely controlled switch or switches, a momentary switch that is in parallel with the remotely controlled switch or switches, a keypad switch that is in parallel with the remotely controlled switch or switches, a touch pad switch that is in parallel with the remotely controlled switch or switches, a screen including but not limited to a touchscreen with a switch that is in parallel with the remotely controlled switch or switches, a slider switch(es) that is in parallel with the remotely controlled switch or switches, a capacitive coupled switch or switches switch that is in parallel with the remotely controlled switch or switches, etc., combinations of these, etc. Implementations of the present invention can also include sliding doors, patio doors, French doors, etc., for example controlling lighting based on door usage, door position, light through the door, and for example controlling doors, locking/unlocking doors, reporting position and locked state of doors, etc. Temporary permission for access may also be granted both locally and globally. In addition to opening the door and turning on any lights directly associated with opening the door, implementations of the present invention can also turn on other lights including to a prescribed, sequenced, scheduled, etc. or other level, etc., as well as turn on or off other devices including but not limited to air conditioners, heaters, furnaces, appliances, fans, etc.

Embodiments of the present invention can be used as a smart and secure pet door with the Bluetooth, RFID, WiFi, ISM, and/or other wireless only allowing the pet door to open when the animal wearing such a device is near.

The present invention can also form a Community where such a community can consist of neighbors, friends, family, others, located nearby or in other parts of a state, country, continent, world, etc. who remain in relative contact and collectively remain in contact in general such that using telephone lines, cellular/mobile communications, internet, radio communication, fiber communications, etc., the various embodiments of the present invention can be linked to others in terms of the control, monitoring, sensing, logging, etc. As an example, the SSL or other lighting can be set to flash in a single white color, multiple white colors, multiple colors, red color, or other colors when some potentially dangerous or life-threatening situation happens such as a fire, smoke, an unauthorized entry, intruder, motion detection, movement detection, etc. including both random and systematic, water leakage, natural gas leakage, electricity usage both in general and at specific locations, circuit breakers, junction boxes, outlets, etc., water flow, water usage, the lack of water usage, power outage, excessive power usage, too little power usage, lack of telephone, internet, etc., lack of response from inhabitants of house, a fall or injury, failure to contact one or more individuals or entities, screams, key words, certain words, code words, excessive vibrations, voice commands, over-heated areas, under-heated areas, too low of a temperature, too high of a temperature, thermal detection, thermal scans, abnormalities in the thermal scans or detections, video capture, detection, imaging, or recognition, etc., an appliance or appliances left on too long, an appliance or appliances left on too short of a time or not turned on, combinations of these, etc.—these events may also trigger optional alerts including speaker, siren, voice generation, etc. to be sent out locally as well as via cellular phone networks, internet, web, e-mail, texts, pictures, video, etc., combinations of these, etc. to all or a subset of the Community.

Some embodiments of the present invention include various means to detect sleep, heart rate, pulse rate, blood pressure, sleep state, sleep tracker, activity tracker, oximeter, etc. to control the SSL and other lighting. For example, many of the wearable technologies for sleep tracking, monitoring, adjustment, feedback, etc. as well as heart rate, pulse rate, blood pressure, oximetry, activity, wake or sleep state, general or specific health state, etc., combinations of these, use Bluetooth to communicate and interface to smart phones and tablets, etc. This also applies to many of the non-contact and/or proximity systems. As an example, the present invention can interface, connect, intercept, obtain, etc. the information being transmitted directly or indirectly for example but not limited to using the wearable device, using a phone or tablet app, using a laptop or desktop computer, using a server, using a dedicated interface, etc.

The present invention can also have interfaces which are either built-in or standalone/separate that accept and translate various control signals, information, etc. that are either one way (i.e., control) or two-way (control and monitor) to various standards and protocol including BACNET, LONNET, and similar HVAC/lighting standards and protocols, etc. In addition, other interfaces such as WiFi to Bluetooth or Bluetooth to WiFi, Wink, WeMo, etc. may also be used in certain embodiments of the present invention.

Embodiments of the present invention can also have isolated outputs that can supply power for other uses including USB uses (i.e., 5 volt), other voltage and current values, switches, relays, etc. to power, drive, signal, etc. Embodiments of the present invention can include batteries as part of the implementation or be powered by back-up batteries, emergency batteries, solar power directly or indirectly (using batteries, fuel cells, etc.), vibration or mechanical energy sources, uninterruptible power supplies (UPSs), emergency power sources, emergency ballasts, etc., combinations of these, etc. and can provide emergency (or other power) to charge or power cell phone(s), tablet(s), radio(s), laptops, computers, other personal device assistants, etc. during an emergency or at other times.

The present invention can be used to aid in circadian rhythm regulation and cycle synchronization as well as Seasonal Affective Disorder (SAD). The present invention can aid in correcting sleep disorders and provide light therapy including for SAD. The present invention can use input, feedback, etc. including human physiological and biological input and feedback and environmental (including, but not limited to, temperature, time of day or night, ambient light, light spectrum, etc.) to control and monitor the light including the colors/wavelengths and/or the intensity of the light, etc.

The present invention can be used for personal or professional use and applications. The present invention can be used, for example, in hospitals, rest homes, senior care homes, rehabilitation facilities, short term and long term care facilities, homes, residences, commercial and industrial buildings and locations, schools including K12, universities, colleges, etc., in cleanrooms, in confined spaces, in spaces devoid of natural light, on ships, buses, boats, planes, aircraft, submarines, vessels, all times of marine, ground, air and space vehicles including transport and working environments, spaces, vehicles, etc.

The present invention can use actimetry, sleep actigraphs which can be of any form including watch-shaped and worn on the wrist of the non-dominant arm, temperature, EEG, wrist, body movements, polysomnography (PSG) and other such techniques, etc.

The present invention can also be used to provide relatively dim illumination at night of appropriate wavelengths and can be integrated into a single light source and sensor unit to provide lighting sufficient for sleeptime/nighttime use and egress for, for example, children and adults including more aged and senior adults and parental or other (including, but not limited to nursing, nurse assistant, care giver, hospital, rest home, hospice, trauma, emergency room and similar environments, recovery, rehabilitation, assisted living, elderly living, senior care, etc. centers/facilities, etc.), dementia of all types and forms, etc., and to provide various types of light therapy including but not limited to individual, customized, programmable, adjustable, adaptable, etc. The present invention lighting can be used for, for example but not limited to, seniors, families, businesses, residences, homes, houses, elderly, physically impaired people and persons, etc. to signal, alarm and/or alert others of an emergency, an intrusion, a fire, a fall, an injury, toxic or explosive gases, loss of heating, water leakage, etc., by for example flashing lights, on-off lights at certain periods of repetition, different colors flashing, different patterns of colors, different intensities and dimming, etc., combinations of these, etc. In some cases, the interior/indoor lights can be set to full on/full brightness while the exterior/outdoor lights can be set to flashing or other modes including but not limited to those discussed herein. In some embodiments audio alarms including but not limited to sirens, recorded or synthesized voice messages, actual sounds from microphones within the house, synthesized ring tones, alarms, alerts, etc., other types of patterns of sound, music, etc., combinations of these, etc. can be used.

The present device can be made into light sources, including but not limited to sheet light sources, which can incorporate solar cells either on the front or the back, and optional energy storage such as batteries to create a light source that can be powered when there is no sunlight or can also act as a privacy screen and/or temperature reducer over windows by absorbing and blocking the sunlight (and potentially associated heat and UV rays) from entering the space on the interior side of the window while still powering and providing energy to the light sources to illuminate the interior space(s).

The present invention can use projectors, television sets, computer monitors and other displays, etc. including as light sources and to provide light of various and different colors including different white light colors including for use in light therapy including but not limited to circadian rhythm, SAD, dementia, other maladies, illnesses, diseases, etc., combinations of these, etc. Implementations of the present invention can include using televisions including older televisions that can be switched on and set to appropriate wavelengths for waking up and appropriate wavelengths for resting/going to sleep, etc. Embodiments of the present invention can use an interface/conversion/communication device/box/unit/etc. that can, for example, use the duplication of the remote control signals to turn on the television and set the channel such that the signals applied to the specifically set channel produce the desired wavelength spectrum. Embodiments of the present invention can also use a remotely controlled switch to turn on the television, projector, etc. Audio signals may also be used and applied to assist in waking or sleeping, such as, but not limited to, synthesized, simulated, emulated, and/or recorded voices, sounds, environments, tones, natural or man-made sounds, live streaming, personal communications, television, radio, other broadcasting whether wireless, web-based, cable, wired, etc., combinations of these, alarm clocks, either alone or in combination with changing light levels and/or wavelengths, in order to provide predetermined, or programmable, randomized, live, etc., audible and/or light-based alarms, whether gradual, gentle, insistent, etc. Such alarms can be adapted for slow or fast waking of individuals with a range of light sleeper to deep sleeper characteristics. Changing light patterns in alarms can simulate sunrise or other conditions, etc. or in certain cases, sunset or other times of the day or night, etc. which can be customized and personalized for a person, persons, groups of people, etc.

The present invention can be used to gently or urgently or anything in between wake a person or people by providing light with high/significant or total blue wavelength content. Such implementations of the present invention can be used in one or more locations that are collocated/local or located miles or continents apart. The present invention can control and monitor one or multiple light sources in one or more locations. For example parents can set one or more wake up sequences where the light can, for example, but not limited to, dim up slowly or go to full brightness instantly, provide vocals including, but not limited to, music, horns, buzzer, alarm, synthesized sounds, noise, nature, ocean and other sounds, combinations of sounds, voices, familiar voices, voice generated or previous voice recorded, etc. In a similar fashion, the present invention can include night-time or sleep time to control and monitor one or more light sources and optionally electrical outlets such as, for example, but not limited to, to control the turn off, dimming including gradual or abrupt or anything in between the light sources in one or more locations including the same or different rooms which could be set to simultaneously, separately, staggered, or other scheduling or sequencing of the light and related control. In some embodiments of the present invention, the amplitude of a sound, noise, acoustic, thud, vibration, mechanical, sounds associated with movement can be detected and optionally amplified including remotely amplified using commands, automatic signals, remote control and signals, etc.

Embodiments of the present invention can also use an infrared to RF wireless universal interpreter/converter as described in PCT Patent Application PCT/US15/12965 filed Jan. 26, 2015 for “Solid State Lighting Systems” which is incorporated herein by reference for all purposes. Such a universal interpreter/converter allows control of portable devices such as portable air conditioners, window air conditioners, portable heaters and furnaces, portable space heaters, portable space coolers, etc., entertainment devices, units, systems, etc., humidifiers, etc. In some embodiments of the present invention the infrared to RF wireless universal interpreter/universal converter/adapter may be installed in and included as part of a lamp, bulb, light fixture, etc., may be battery operated with a solar charger, a mechanical energy charger, other types of energy harvesting, etc. Such implementations of the present invention can use one or more mobile, portable wireless devices including, but not limited to, remote temperature sensors, smart phone temperature sensors and measurement devices, integrated circuits, etc., Bluetooth temperature sensors and measurement devices, tablet temperature sensors, etc., humidity sensors and measurement devices, etc. One or more of these sensors in one or more nearby locations may be used, for example, as temperature control points/locations for which certain embodiments of the present invention can be commanded to modify the temperature until one or more of the temperature setpoints are reached and maintained. Some embodiments of the present invention can also monitor the power (i.e., voltage, current, apparent power, real power, power factor, etc.) to monitor, store, calculate, make decisions, provide analytics, etc. of the heating and cooling energy use, etc.

In example embodiments of the present invention a power supply can be included in which the frequency can be detected using a microprocessor, microcontroller, FPGA, DSP, analog circuit, other digital circuits, combinations of these, etc. A switch including, for example, a transistor such as a field effect transistor (FET) such as a MOSFET or JFET can be used in the power supply to, for example, either turn on or turn off a circuit that operates in either ballast mode or AC line mode depending on the amplitude of the signal or with the inclusion of a time constant, the average, RMS, etc. voltage level. The present invention removes the requirement that a reference level and a comparison to the reference level being required to detect the amplitude of the waveform.

Some embodiments of the present invention include a solid state lighting (SSL) replacement which could include but is not limited to one or more light emitting diode (LED), one or more organic light emitting diode (OLED), one or more quantum dot (QD), etc. combinations of these, etc., replacement lamp that can be directly put into, for example, but not limited to, 2 ft and 4 ft linear fluorescent tube sockets, tombstones, or other fixtures, other types of fluorescent fixtures and sockets, including but not limited to, PL 2 and 4 pin sockets, fixtures, etc. and receive power directly from electronic ballasts (i.e., instant start, rapid start, programmed start) and also magnetic ballasts or in lieu of the ballast, AC line voltage including being able to accept universal AC line voltage as well as new construction lighting and lighting fixtures of any and all types including but not limited to troffers, flat panels, edge lit, sconces, etc. The LED fluorescent tube replacements (FLRs) have a unique and innovative aspect in that the LED FLRs can be wirelessly dimmed and support both manual and daylight harvesting controls including standard 0 to 10 V, DALI, DMX, and other interoperable protocols and interfaces including, but not limited to, interfaces that support standards including Building Automation Control Network (BACnet) which is an open, standard communication protocol by the American Society of Heating, Refrigerating, and Air-Conditioning Engineers (ASHRAE) and LON (LonTalk), a protocol developed by the Echelon Corporation later named as a standard—by the Electronics Industries Alliance (EIA) that have been established for building automation system (BAS) vendors, manufacturers, suppliers, etc. to enhance and further enable the adoption of LED luminaires and FLRs in building automation. Implementations of the present inventions can interface with BACNET systems to support normal and emergency operations and situations, etc.

The present invention uses wireless signals to both control (i.e., dim) the LED FLR and monitor the LED current, voltage and power and can provide analytics, fault reporting, power usage, activation alerts, monitor traffic including the motion and sound and also video from for example a camera powered through the present invention including receiving power from a ballast. Power from a ballast/AC line can be used to power any devices in the lighting system, such as, but not limited to, security cameras, web cameras, remote monitoring, cameras, surveillance cameras, etc., combinations of these, etc. used to trigger actions rather than just generating images (which can also be performed), Bluetooth traffic monitors, motion sensing or sound sensors that are ballast powered, light sensors, etc. For example but not limited to, Optional the sensors can allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for in general lower cost, longer range and simplicity or Bluetooth including all variants such as, but not limited to, Bluetooth low energy, Bluetooth Mesh, ZigBee, ZWave, IEEE 802, or WiFi. In addition to these types of occupancy/motion sensors, photo sensors and daylight harvesting controls, simple and low cost interfaces that allow existing or other brands, makes, and models of daylight harvesting controls, photo sensors, occupancy/motion/proximity sensors, voice recognition, voice commands, gesturing, face recognition, magnetic sensors, infrared sensors, magnetic key cards, other types of sensors, RFID, cellular phones, smart phones, tablets, laptops, desktops, servers, etc., combinations of these, subsets of these, etc. to be connected to and control/dim and/or change color(s)/wavelength(s), etc. the wireless SSL including but not limited to LED, OLED, and/or QD FLRs in various embodiments of the present invention can be used. In addition, wired and powerline (PLC) interfaces may be used with the present inventions as well as multiple types and forms of local and remote sensors, detectors, transmitters, receivers, responders, etc.

These SSL FLRs are highly efficient especially with energy harvesting. The present invention is applicable to office, retail, food service, hospitality, healthcare, school, military, government buildings, etc. and can include cybersecure communications.

The present invention provides modular solutions and kits some of which can be selected at time of manufacturing, some of which can be added and are field-installable without the need for experience of knowledge of advanced electronics or the details of SSL systems—and all of which are low-cost and can provide additional energy savings. An optional but not necessary component of the control firmware, hardware and software is additional processor capability that can also be easily integrated into SSL systems.

The present invention employs low-cost, adaptive sensors and controls that can often communicate at low data rates with low data content to achieve energy usage reduction for a wide range of lighting products including both SSL and non-SSL products (that can later be replaced with SSL products); in addition this allows for existing dimmable and non-dimmable SSL products to be made more energy efficient. The merits include reduced energy consumption and cost as well as providing enhanced performance and functionality. Enhanced high speed, high data content (including video, video streaming, data mining, data gathering, etc.) versions of the present invention can also be implemented.

The present invention can be highly energy efficient, low-cost to manufacture and price enabling as well as designed to work with numerous platforms, including smart phones (i.e., iPhones, Androids), tablets (i.e., iPods, Androids), computers, Arduinos, Raspberry Pi(s), do-it-yourself (DIY) and novices, both smart and dumb (with a wireless interface) TVs including HDTVs, 4D TVs, TVs that are only NTSC-compatible (and not HDTV-compatible). Implementations of the present invention can be, for example, in both kit forms and fully assembled, tested and ready-to-plug-and-play modules and units. The system, once setup, can be self-maintained or controlled, monitored and data logged (including analytics) using, for example, the industrial, scientific and medical (ISM) radio frequency (RF) bands and/or powerline control (PLC) and/or wired interfaces and connections using low-cost components and electronics or virtually any other method including optional (and not required) interfaces ranging from low-tech to very high-tech. Some embodiments and implementations of the present invention does not require the internet or internet protocol (IP) addresses to operate; however optional choices and accessories allow internet-connectivity if so desired. The present invention, in some embodiments, can also respond to voice commands and gesturing. Smart phones and tablets can be connected in a number of ways to the present invention innovative SSL energy savings sensor system including, but not limited to, Bluetooth (including Bluetooth Low Energy) and other ways without or with the internet or IPs.

The present invention includes a family of SSL lighting products including innovative, ultra-efficient, highly flexible power supplies and drivers for LEDs, QDs and OLEDs.

The present invention provides power supplies and associated control and monitoring electronics that enable and support rapid introduction of both SSL replacement and innovative general lighting and luminaires for residential, commercial, educational and industrial applications and markets as well as supporting and enhancing other types of new construction lighting and fixtures.

In particular these power supplies and drivers for SSL can convert AC input to DC output power, have a high power factor (PF) and low total harmonic distortion (THD), support various types of dimming, meet FCC EMI limits, provide over-current (OCP), over-voltage (OVP), over-temperature (OTP) and short circuit protection (SCP). Of great importance, these power supplies are high to ultrahigh efficient and in some embodiments are amenable to form fit applications for LEDs and OLEDs including edge-emitting LEDs and edge lit LED lighting. Implementations of the present invention include ultra-efficient, highly flexible family of isolated and non-isolated power supplies for SSLs that support both white light and color tunable red/green/blue (RGB) as well as other color combinations including red/green/blue/amber (RGBA) and red/green/blue/amber (RGBA) coupled with one or more white colors (i.e., one or more white color temperatures) modes of SSL operation.

The present invention includes smart, feature-full SSL drivers and photo/light, noise, and/or motion sensors that are very low power and capable of sending information wirelessly (or wired) to one or more controller/monitor units or directly to the SSL power supplies and drivers or combinations of these. The smart drivers, in addition to the performance specified for the simple drivers support, among others, optional wall (Triac), 0 to 10 V, powerline (PLC), wired and wireless dimming. In addition to versions that support white light dimming via ISM RF signals and, optionally (via, for example Bluetooth, Bluetooth Low Energy, ZWave, ZigBee or WiFi), smart phones, tablets, iPods, iPads, iPhones, Android devices, Kindles, computers, etc., RGB or RGBA or other combinations of more or less color/mood changing SSL panels can also be supported via the same interfaces and mobile/computer devices. Unlike simple infrared controlled RGB light strips, ropes and the likes with limited color choices and dimming levels, the present invention RGB lighting allows for high resolution 8-bit to 12-bit (256 to 1024) or higher resolution color levels per RGB channel and with innovative ways to interactively and dynamically user-select the resolution and dimming level. The present invention can be self-learning and can support artificial intelligence including but not limited to in terms of lighting, light therapy, light growth, light interactions, intruder detection and response, bad actor, fire, smoke, active shooter, man-made, natural disasters, others discussed herein, etc., combinations of these, for, but not limited to, humans, animals, plants, insects, etc.

Solid state lighting, including but not limited to light emitting diodes (LEDs) and organic light emitting diodes (OLEDs) and quantum dots QDs, has the capabilities to provide significant energy reduction resulting in, among other things, less dependence on foreign sources of energy and less wasted energy including wasted heat energy. SSL provides quality benefits for general lighting in both residential and commercial applications that are not possible using fluorescent lighting or most other types of lighting. Improved visual quality is a result of several intrinsic characteristics of SSL systems. For example, newer types of SSLs have brightness levels that are actually visually pleasing to view directly. Given their unique form coupled with power supplies and drivers specifically optimized to enable and exploit the unique form factors and inherent flexibility and digital nature of SSLs, tremendous design flexibility is an inevitable result, thereby creating the possibility of new and innovative luminaires, lighting design approaches, and architectural integration. SSLs also enable luminaires with superior color attributes. The SSLs can offer superior color attributes include user-adjustable and selectable RGB and, for example, but not limited to RGBA color and high ‘white light’ CRI, and even color temperature tunability. SSL luminaires not only eliminate hazardous material but also embed less energy in the manufacturing and transportation processes. The thinness and minimal weight of the SSLs facilitate the use of lighter and innovative materials in the luminaire construction. Integrating energy efficient solid-state lighting with advanced sensors, controls and connectivity provides for a family of comprehensive lighting products including control and monitoring products that further reduce energy usage while enhancing the user-experience.

The present invention includes implementations that are compact, low-cost multipoint addressable RF control and monitoring system that includes SSLs, photo/light sensors, motion sensors, control, dimmers (which can also function and be set to on/off mode) that SSL and other light source types can be plugged or screwed into. The light and motion sensors can, for example, be battery and/or solar powered and only send/transmit information/signals when there is change (i.e., the ambient light changes appreciably compared to a reference set-point, motion is detected or not detected, etc.). Implementations of the present invention can include integrated circuits (ICs) to be used in, for example, but not limited to, SSL drivers, dimmers, and sensors. Such sensors and other circuits in a lighting system can be powered by a ballast in a lighting fixture, or, if the ballast has been removed or otherwise bypassed, directly from the AC line through the lighting fixture. In some embodiments, sensors in the system can recognize occupants based on, for example, but not limited to the Bluetooth fingerprint of their electronic devices as they enter a room, and configure lighting levels, colors wavelengths etc. based on their stored preferences automatically, or based on time of day or week, holidays, financial reports, cost of energy at a given time or day, weather reports, temperature indoors or outdoors, emergency conditions, smoke detectors, etc. The ballast or AC line in the lighting system can be used as a power source for any connected device, such as, but not limited to, including a thermostat in the light fixture, with Bluetooth control, WiFi, or any other interface. The system can include IR temperature sensor or thermal imaging camera(s) to measure ambient temperature or point temperatures in the room or other environment around the light fixture. Such sensors or thermal imaging cameras could measure temperature differentials throughout the room to trigger an alarm if temperature differentials are detected that are greater than a threshold. Such sensors can be moved in some embodiments, for example by mounting on a motorized gimbal. In some embodiments lenses or filters, such as a fisheye lens, can be used in connection with sensors to increase the monitored area. Such sensors can be used to monitor for abnormal temperature differentials, identifying fires, faulty and overheating electrical outlets or wiring, windows or doors needing to be closed, motion or movement, forced entry, etc. The system can include adaptive control such as, but not limited to, artificial intelligence (AI) systems to determine normal operating conditions and to identify and signal abnormal conditions. In some embodiments, the AI systems or other systems and approaches will act on the abnormal conditions, situation(s), and address and resolve, mitigate, eliminate the abnormal conditions, including but not limited to the abnormal conditions be the system, threats to the system, personnel, natural disasters, active shooter(s), fire, etc. In some embodiments the ballast is bypassed and the present invention is powered by AC line, grid, DC, off-grid, alternative energy sources, hybrid energy sources, energy harvesting, stored energy such as chemical or battery/batteries which in some cases can be restored/restocked/replenished, etc.

The lighting system can be used with and also replace for example but not limited to fluorescent lights and lamps and all types of high intensity discharge (HID) lights in schools, gyms, hospitals, nursing homes, theaters, cafeterias, restaurants, malls, government buildings, military facilities, factories, warehouses, libraries, churches, airports, train stations, bus terminals, subway systems, shopping centers, others discussed herein, as well as others not specifically discussed herein etc., to provide tunable light colors/wavelengths and illumination levels, both for normal operating conditions and emergency conditions of any types. For example, lighting in a school gym can be controlled during a dance to vary the color and intensity to enhance the atmosphere of the dance, in some cases based on the music. In the event of a fire or other emergency, the light can, for example but not limited to, be switched to flashing red light or a combination of solid white and flashing red light to facilitate exit from the building. For example but not limited to, safe areas could flash green or other color(s) or be solid green or other color or colors light; non-safe areas could flash red or other color(s) or be solid red or other color or colors light, etc.

Some embodiments of the present invention include relatively low-cost ISM and/or Bluetooth transceivers and further reduce cost and power consumption so as to make long-term and longlife operation possible using, for example, small batteries or solar power/charging or both. In some embodiments of the present invention solar or other types of charging including those discussed herein can be used to recharge the battery or batteries using for example but not limited to buck boost, buck, boost, boost buck, flyback, forward converters, half bridges, full bridge, push-pull, Cuk, SEPIC, etc. topologies.

Some embodiments of the present invention support low power operation including deep-sleep ultra-low power mode such that the power consumption is extremely low when not transmitting or receiving, and also optimizing transmit and receive power. In some embodiments, the intent is to send only as much data as needed and not to go ‘overboard’ in terms of information sent and received.

Addressing protocol and firmware/hardware setting and programming can be used to control and monitor the present invention including individually addressing the drivers, dimmers and sensors. One simple approach would be to use physical DIP switches to set the address of each unit. Another approach is to have a low-cost programming station that the user purchases as a one-time-only expense that allows easy user programming of the drivers, dimmers and sensors, (and other modular components to be added/included) etc. as well as having other wired or wireless programming or joining/connecting/connection/advertising protocols, approaches, methods, techniques, technology, etc. that include cyber secure methods, approaches, techniques, etc. that could optionally permit programming changes or reprogramming, uploads of updates to the firmware and software, etc.

Embodiments of the present invention can incorporate the low-cost wireless control and monitoring into the drivers and sensors. This provides a wide-open way to interface with the energy efficient SSL with advanced sensors, controls and connectivity systems including without the need for internet protocol (IP) addresses (and typically, if so desired, using at most only one IP address) using most any type of entertainment device including old NTSC TVs, monitors and more modern do-it-yourself (DIY) gadgets including Arduino, Raspberry Pi, etc.

The present invention allows the ability to switch from remote (control) mode to manual mode simply by touching, in the case of a dimmer, a knob. Embodiments of the present invention can detect/sense motion and light and make informed, automatic decisions based on algorithms; however such algorithmic auto-tuning, automatic decisions can be easily overridden by the user. Additional developers can create additional hardware and software for these systems and expand the functionality and user-interface/experience/abilities/etc.

A graphical user interface is provided in some embodiments of the present invention, for example accessible as a web page or set of web pages that can be accessed using any web browser on any device. Such a graphical user interface can display all of the data sources, all of the controllable devices, and can provide remote control of any of the controllable devices in the system. Some embodiments provide for power monitoring and logging, for example measuring/monitoring input voltage and current, power consumption including both real and apparent power consumption and power factor of a single light source in the system or other device in the system, or for groups of devices in the system. These and other such GUIs can be imported to other formats such as, but not limited to, a converter box designed to work with NTSC TVs, HDTVs including smart HDTVs, computers, dedicated control/monitor blocks that can either have a built-in display or use a TV or monitor display, Arduinos, Raspberry Pis, smart phones, tablets (in Bluetooth or WiFi mode as well as wireless internet mode), and a vast host of other interfaces.

Some embodiments of the present invention can use low-cost smart/intelligent SSL drivers based on existing powerline, wired and wireless interfaces including for example but not limited to AC powerline, 433 MHz, 868 MHz and 2.4 GHz wireless remote monitoring and control systems in addition to wireless solutions/options that use more expensive Bluetooth, ZigBee, IEEE 802-based, WiFi, etc. as well as complete 0 to 10 V dimming control for LED dimmable drivers and CCFL and FL dimmable ballasts and other dimmers. The wireless systems can be easily modified to other frequencies if needed including, for example, in the International Science and Medical (ISM) mid to high MHz frequency range as permitted by the FCC. The monitoring and control systems can monitor all key parameters including, but not limited to, input current, input voltage, inrush current, voltage spikes, power factor, true input power, Volt-Amp (VA) input power, output current, output voltage, output power, output voltage, etc. The powerline communications can support, for example, X-10, Insteon, and HomePlug protocols, etc. In addition, open source protocols can be implemented.

Manual/Remote Mode feature with status indicators can also be provided in some of the embodiments with flexible manual override capabilities and user selectable setup features. Voice recognition and gesturing can also be implemented into versions of the present invention along with the wireless, wired and powerline choices.

Interfaces that support standards including Building Automation Control Network (BACnet) developed as an open, standard communication protocol by the American Society of Heating, Refrigerating, and Air-Conditioning Engineers (ASHRAE) and LON (LonTalk), a protocol developed by the Echelon Corporation later named as standard EIA-709.1 by the Electronics Industries Alliance (EIA) that have been established for building automation system (BAS) vendors, manufacturers, suppliers, etc. can also be implemented in the interfaces to the SSL drivers and power supplies to enhance and further enable the adoption of SSL luminaires in residential and commercial building automation. A purported primary feature of BACnet and LON is interoperability enabling multiple control systems and lighting systems manufactured by different vendors to work together, sharing information via a common interface. Some embodiments of the present invention allow for higher output powers than would normally be allowed by, for example, taking advantage of the additional power supplying capabilities of the ballast to supply full wattage as opposed to a reduced wattage that are typically needed for SSL to have the same output lumens. For example, during an emergency including, but not limited to a smoky environment or a need for more intense light, embodiments of the present invention could switch to a high energy/high power mode where more power/current was being used by the SSL and thus, in general, increasing the output lumens even if doing so may, depending on the situation, degrade (or not degrade) the ultimate lifetime of the SSL including but not limited to LEDs and/or OLEDs.

Some embodiments of the present invention include an in-socket solid state lighting-compatible controller/dimmer. Although any socket and any light source mounting technology can be used, one example embodiment may include a male and female Edison E26 or medium screw base. The socket includes a male Edison screw base to connect to a light fixture, and a female Edison screw socket to receive a solid state light. The socket includes power supply/driver circuits, wireless control circuits, on/off/dimming circuits, monitoring/control circuits, etc. as desired. In some cases, power supply/driver circuits, wireless control circuits, on/off/dimming circuits, monitoring/control circuits are also or alternatively located in the solid state light. The solid state light includes a male Edison screw base, a housing that can emulate the familiar shape of an incandescent bulb if desired that can house circuits, heat sinks, sensors, etc. The solid state light includes a circuit board housing in which one or more circuit boards can be mounted supporting one or more solid state lights of one or more colors, covered by a lens that can include diffusers, filters, lenses, phosphor coatings, etc. as desired.

The present invention can use wireless signals to both control (i.e., dim) SSL (e.g., LED, OLED, QD) fluorescent lamp replacements (FLRs) as well as new construction lighting/lamps/fixtures/etc. and monitor the LED current, voltage and power. The LED fluorescent lamp replacement is designed to work directly with existing electronic ballasts and requires no re-wiring and can be installed in the same amount of time as or less than=changing a regular fluorescent lamp tube. This smart/intelligent LED FLR is also designed to be compatible with most daylight harvesting controls and protocols. Included, incorporated or optional sensors allow for relative light output to be measured and wirelessly reported, monitored, and logged permitting analytics to be performed. The FLRs can be of any size and length including both two foot and four foot T4, T5, T6, T8, T9, T10 standard/nominal linear lengths as well as any other lengths (T12 sizes can also be used if deemed useful for FLR usage) as well as other form factors including but not limited to PL 2 pin and 4 pin, U shaped, U-bend/bent tubes, etc. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth or any type and flavor, ZigBee, ZWave, IEEE 802, WiFi, WeMo, Bluetooth Low Energy, LoRa, Thread, 6LoWPan, WiFi, gateways, hubs, bridges, etc., more than one of these, combinations of these, etc. In addition to occupancy/motion sensors, photo sensors and daylight harvesting controls, various embodiments support simple and low cost interfaces that allow existing other brands, makes, and models of daylight harvesting controls, photo sensors, occupancy/motion sensors to be connected to and control/dim the wireless SSL (e,g, LED) FLRs. The LED FLRs can be switched on and off millions of times without damage as well as be dimmed up and down without damage. The wireless communications can be encrypted and secure. This LED FLR technology does not require or need a dimmable ballast (although the present invention will also work with dimmable ballasts, dimming ballasts, etc.) and works with virtually any electronic ballast including instant start, rapid start, programmed start, programmable start, preheat, dimmable, dimming, non-dimmable, 1, 2, 3, 4, 5, 6 and higher count lamp ballasts, etc. and can also work with magnetic ballasts.

The control code interoperability allows multiple control systems manufactured by different vendors to work together, sharing information via, for example but not limited to a common Web-based interface. The Web/Internet/Cloud can for example but not limited to be used to gather information, make decisions, change settings, change, color temperatures, change color, set schedules, scenes, themes, sequences, send alerts, check time of day, weather conditions, and change the lighting, HVAC, obtain information and data about demand usage(s), etc. Such information and data can be used to avoid having too high of instantaneous power or peak power usage by for example but not limited to having some or all of the lighting dim, trim, turn off, send information, signals, etc. to other systems, for example but not limited to, HVAC, etc. to also turn off, reduce power consumption, etc. Implementations of the present invention can use, can be used by, etc. smart meters, including but not limited to smart power meters, etc. Implementations can send out status, error, warning, alerts, updates, etc. via SMS, the Web, the Internet, the Cloud, etc.

The present invention can use wireless signals to both control (i.e., dim) the SSL FLR and monitor the SSL current, voltage and power. Optional sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth, ZigBee, ZWave, IEEE 802, WiFi, WeMo, Wink, cell phone signals, WiMax, 6LoWPAN, THREAD, LoRa, IrAD, other infrared, optical, light, electromagnetic, electromagnetic waves, radio frequency (RF), Thread, 6LowPan, modem including 1G, 2G, 3G, 4G, 5G, GSM, etc. based mobile communications, powerline, wired, etc. with either secure/encrypted or unsecure communications. In addition to occupancy/motion sensors, photo sensors and daylight harvesting controls, simple (or more complex, sophisticated, etc.,) and low cost interfaces allow existing or other brands, makes, and models of daylight harvesting controls, photo sensors, occupancy/vacancy motion sensors to be connected to and control/dim the wireless SSL FLRs. These SSL FLRs are highly efficient. In some embodiments, the system includes demand response capability, including enabling and disabling lighting and other devices based on demand, reducing output current/power usage when demand is low, etc.

Any and all types of buildings and residences, small or large, that have/use electronic ballasts or magnetic with linear fluorescent tubes or compact fluorescent tube types (e.g., PL2 and/or 4 pin) can use and directly benefit from the present invention. The present invention is extremely well suited to work with demand response (DR) systems including automatic demand response (ADR) systems as well as all similar and variants of DR and ADR including but not limited to peak response, critical peak pricing, voluntary reduce use (TOU), call ahead, call day of, etc. In addition to receiving automatic response, automated response, etc. commands and information to reduce energy usage from a utility or other source, entity, etc., the present invention can be scheduled, told, commanded, etc. to reduce energy usage including by dimming, signaling other systems, etc., monitoring average, total, peak, etc. power usage, etc.

Some embodiments of a lighting system include a wireless controller and monitor and sensors in accordance with some embodiments of the invention. Sensors can include, but are not limited to, occupancy/motion detectors/sensors and daylight harvesting sensors. The wireless controller and monitor of a lighting system can feed control signals to one or more SSL FLR's, any number of which can be addressed and controlled, and can have the same or different or multiple colors or light wavelengths. The wireless controller/monitor can be interfaced to, for example, an intranet, the Internet, custom remote controls, autonomous controls, Bluetooth, etc. and can be securely encrypted or unsecure. In some embodiments, the SSL FLR's are direct fluorescent lamp replacements that can be snapped in or connected to any existing fluorescent light fixture and turned on without requiring electrical re-wiring to install. This makes switching to SSLs/LEDs as simple as changing a light bulb/tube: no rewiring or special handling required. The SSL FLR's can be powered by ballasts in, for example, but not limited to T8 (or T4, T5, T6, T9, T10, T10, PL, etc.) lighting fixtures and used in rewired fixtures where AC power is supplied directly to the lamps.

Some embodiments of the present invention include one or more multiple light emitting panels with fixed or movable mounts, such as, but not limited to, those disclosed in PCT Patent Application PCT/US15/32763 filed May 27, 2015 for “Lighting Systems” which is incorporated herein by reference for all purposes. For example, multiple panels can be mounted on moveable or articulating arms. Like a blooming flower the SSL system can be ‘folded’ to close and then opened to bloom. The light emitting panels can use monochrome, white, multi-color, color-changing, color-tuning, color adjusting, etc. using for example but not limited to LEDs, QDs and/or OLEDs or combinations of these, etc. Motors, gears, pulleys, chains, etc. may be used with the SSL system to unfold, fold, rotate, move, translate, etc. the light emitting panels. The light emitting panels (or petals of the blooming flower) may have any size or shape, may be symmetrical, asymmetrical, etc.

Any number of light emitting panels of any color or combination of colors can be included, and can also include point light sources if desired, as well as sensors, detectors, cameras, fans, reflectors, diffusers, etc. as desired.

An example SSL system can include multiple light emitting panels mounted on movable arms which can be adjusted to tilt the light emitting panels. The mounting system can be adapted as desired to allow any range of motion, rotation, etc. In some embodiments, multiple attachment points can be used on each light emitting panel to control position, tilt, etc. In some other embodiments, a single attachment point is used with a controllable mount, such as a motorized gimbal, on each light emitting panel, enabling each light emitting panel to be independently positioned, tilted, rotated etc.

The present invention may be used as a light source for multiple purposes including as a reading lamp, as a task lamp, as an ambient lamp, as a circadian rhythm regulator and adjuster, etc., an entertainment and mood lamp, emergency indicator or other indicator, guide light by shining or flashing different colors to indicate one or more paths simultaneously, sequencing including temporally sequencing the lighting to indicate directions to follow/take/etc., turning different parts including light source parts to indicate a direction or path, etc. to follow, a status indicator by shining various colors in various locations according to conditions to be identified, etc. Such emergency or identification or guide or other functions can be performed in combination or conjunction with other functions, including simultaneous lighting such as combining white illumination with colored indicators.

An example of the present invention includes, but is not limited to, a light source for train, bus, airplane, ship, boat, yacht, recreational vehicle (RV), SUV, limousine, van, submersible vehicles including, but not limited to, submarines, Navy boats, commercial jets, plant growth, etc.

The present invention can be used to produce various effects in, for example, a long distance travel by train, boat or plane in which the users can choose from soothing or exciting colors, certain wavelengths of light to help induce, reset, etc. circadian rhythms and melatonin production or suppression, etc., to address SAD conditions, to provide one or more types of light therapy, to provide a calming or exciting ambiance, to affect mood, emotions, sleep, rest, enjoyment, ambiance, environment, relaxation, alertness, focus, attention span, etc.

The present invention can be used, for example, on a commercial airplane to allow the passenger to adjust the local lighting by using, for example, Bluetooth, WiFi, or any other wireless method, way, protocol, etc. to, for example, communicate with the light/lamp to dim, change color temperature, change color or combinations of colors to change white color temperatures, to provide alerts, alarms, mood setting, light therapy, turn off, turn on, tilt, and/or combinations of these, etc.

The present invention can be attached/embedded/incorporated/integrated/etc. into a fan, including, but not limited to, a ceiling fan that in some embodiments can change speed and light intensity and/or colors as it rotates. The LED and/or OLED and/or QD lighting can be incorporated/attached/embedded/etc. on one or both sides of the fan blades as well as other parts of the fan.

As an example of the present invention, a 12 channel driver can separately and independently supply and wirelessly control (i.e., dim) each color of four RGB or three RGBA or RGBW SSL panels as well as 12 individual monochrome (e.g., white or other color) SSL panels, and/or a mix and match combination of both color, color-changing and/or white SSL panels. Of course more or less channels can be implemented.

The present invention can implement building block power supply approaches that can be mated with and sold with SSL panels, lightbars, lamps, strings, etc. as SSL lighting kits.

The driver electronics for the color changing/tunable SSL lighting allow, among other things, flexible, selectable lighting including warm, cool, daylight, etc., white light choices for residential consumers and business customers. These drivers also permit and support remote dimming, control, monitoring, data logging as well as analytics.

All of the above can be wirelessly interfaced, controlled and monitored using, for example, smart phones (i.e., iPhones, Androids), tablets (i.e., iPad, iPod touch, Droid, Kindle, Samsung, Dell, Acer, Asus, etc. tablets), laptops, desktops and other such digital assistants.

Universal drivers can also be used to support Triac and 0 to 10 Volt dimming as well as optional powerline (PLC) and wired and/or wireless remote control. As another example, the DC input power supply can support 0 to 10 volt dimming and can have optional wired and/or wireless control and monitoring.

Some embodiments of the present invention include power supplies and drivers specifically focused on OLEDs that address both the rather unique properties of OLEDs compared to, for example, even LEDs. In general, both OLEDs and LEDs should be current control driven—that is to safely operate both LEDs and OLEDs the power source should be current controlled and regulated as opposed to, for example, applying a constant, regulated voltage to the OLEDs or LEDs.

In general LEDs are point sources made up of certain mixtures/alloys of III-V semiconductors based, for example, binary gallium arsenide (GaAs) and gallium nitride (GaN) forming ternary alloys such as, but not limited to, aluminum gallium arsenide (AlGaAs) and aluminum gallium nitride (AlGaN). These and other such alloys allow a vast number of nearly single wavelength with a relatively small full width at half maximum (FWHM) optical emission which can include optical emission wavelengths that are visible to the human eye and are perceived as colors. White light LEDs can be achieved in a number of ways including color combining single color LEDs such as red, green and blue LEDs or using phosphors or QDs to perform wavelength conversion(s). LEDs are two terminal point source emitter devices which emit light when an electrical stimulus is applied. LEDs can be easily formed into parallel and/or series configurations occupying relatively small areas. OLEDs, on the other hand, are made of molecules that also emit light when electrical stimulus is applied. However, unlike LEDs, OLEDs are designed and configured as area sources and not point sources. There are a number of ways to also obtain white light OLEDs including homogenously mixing at, for example, the nanometer level red, green, blue or red, yellow, blue or other combinations of OLEDs, stacking layers of various colors of OLEDs vertically on top of each other, having stripes of various colors placed laterally close to each other, etc.

With LEDs, typically both the cathode and anode are available for, for example, each individual LED color to be connected in parallel and/or in series either individually or in groups/arrays/etc. such that often there are only two electrical power connections from the power to the LEDs and therefore the power supply/driver output and output connection configurations are often much simpler and more universal for LEDs than OLEDs. Of course, with the continued widespread growth and use of LEDs, there are and will be numerous exceptions to just the two connections per LED fixture or luminaire although such a generalization usually applies to LED lights and lamps such as, but not limited to, GU10, MR16, A Lamps, PAR 30, PAR 38, R30, T4, T5, T6, T8, T9, T10, T12, PL 2 and 4 pin, and other SSL/LED/OLED/QD/etc. lamp replacements. Unless there is only one OLED panel that has only two electrode connections for a given lighting application, an optimized power supply design for multi-electrode (i.e., more than two electrodes) OLED panel(s) can involve consideration of a number of factors including, among others, ensured proper current sharing, size/gauge of wires used, over-current protection, over-voltage protection, individual OLED panel fault detection/correction, OLED lifetime aging, OLED differential color aging (e.g., blue color lifetime being lower than typically other OLED colors), whether to put multiple OLED panels in parallel or series or combinations of both, voltage drops in the interconnect wiring between the power supply and the OLED panels for OLED fixtures and luminaires.

The present invention provides solutions that include OLED lighting kits that would include power supplies/drivers, connectors/interconnects and OLED panels that are all designed to be mated to each other. In addition interfaces can provide significant assistance and aid in connecting multiple OLED panels to power supplies and drivers safely and correctly. This simple interface will use an OLED identification system that allows the power supply/driver and each of the individual OLED panels to communicate with each other in a similar but much simpler (and slower) fashion as, for example, the Telecommunications Industry Association/Electronic Industries Alliance (TIA/EIA) 485 also known as RS485 interface (which is also the basis of, for example, Modbus, Profibus, DMX512, etc.) 2 wire systems.

In addition, articulating desk lamps with one or more rotatable solid state lighting panels can be provided in some embodiments of the invention. As a non-limiting example, a desk lamp can include one or more support members connected by hinges and mounted by a rotating sleeve to a base, allowing the lighting panel to be pointed in any desired direction. The support structure is not limited to any particular articulating arm assembly, but can include any device or assembly suitable for positioning and orienting the lighting panel, such as, but not limited to, a ball and socket chain, gimbaled arm, etc. A power supply/dimming control circuit can be provided to power and control the lighting panel and can be positioned in any suitable location, such as in the base. An IR receiver and/or other wired or wireless connection can be provided to link the desk lamp to other parts of an automation system, enabling the illumination level, color, on/off state to be controlled, scheduled, sequenced, etc.

In some embodiments of an articulating desk lamp the position and/or orientation of the lighting panel can be automatically controlled. The desk lamp includes one or more support members connected by hinges and mounted by a rotating sleeve to a base, allowing the lighting panel to be pointed in any desired direction. In some embodiments the position can be controlled by motors such as stepper motors, DC motors or other actuators. For example, IR receivers are provided on the motors and/or motor controllers in some embodiments to remotely control/schedule motor movements. Encoders, decoders, etc. can be used to monitor, track, store, record, remember, replay, spin around, spin in circles, control speed, angular speed, velocity, angular velocity, movement, angular position, angular position, acceleration, angular acceleration, spinning at various speeds including relatively very slow to relatively fast speeds, move to, etc. existing and previous positions, locations, etc. and can also be used to respond to, interact with, track, move, position, speed, velocity, acceleration, pitch, etc. the present invention based on, for example, but not limited to one or more inputs, information, sensing, detection, time of day, date, ambient temperature, light intensity, movement, proximity, location, GPS information, atomic clock information, people animals, plants, insects, heat, cold, temperature, thermal gradients, thermal leakage, fire, smoke, gases, etc.

Lamps used with the present invention can have any shape, configuration, size, materials, etc. For example, a light emitting panel can be mounted in a support frame or mounted more directly in a sleek form factor. A desk lamp can include one or more support members connected by hinges and mounted by a rotating sleeve to a base, allowing the lighting panel to be pointed in any desired direction. The support structure is not limited to any particular articulating arm assembly, but can include any device or assembly suitable for positioning and orienting the lighting panel, such as, but not limited to, a ball and socket chain, gimbaled arm, etc. A power supply/dimming control circuit can be provided to power and control the lighting panel and can be positioned in any suitable location, such as in the base. An IR receiver and/or other wired or wireless connection can be provided to link the desk lamp to other parts of an automation system, enabling the illumination level, color, on/off state to be controlled, scheduled, sequenced, etc. In some embodiments the position can be controlled by motors such as stepper motors, DC motors or other actuators. For example, IR receivers are provided on the motors and/or motor controllers in some embodiments to remotely control/schedule motor movements. Encoders, decoders, etc. can be used to monitor, track, store, record, remember, replay, move to, etc. existing and previous positions, locations, etc. and can also be used to respond to, interact with, track, move, position, etc. the present invention based on, for example, but not limited to one or more inputs, information, sensing, detection, time of day, date, ambient temperature, light intensity, movement, proximity, location, GPS information, atomic clock information, etc.

It should be noted that the basics and essentials of the LED or OLED or LED/OLED or LED/Quantum Dot desk lamp including color, multicolor, color plus white, multicolor plus white, various colors and ‘shades’ of white, amber and/or blue OLEDs and/or LEDs or QDs, etc., combinations of these, etc. can be modified to produce and be used in, for example, under-cabinet lighting for kitchens, bathrooms, vanities, etc. as well as accent and sconce lighting.

Additional features and functionalities can be added to the OLED desk, task and table, sconce, under-counter and over/above-counter lighting including but not limited to proximity detection, daylight harvesting, voice recognition, voice detection, proximity, heat, thermal, other ways, methods, techniques, approaches, etc. discussed herein, combinations of these, etc.

The OLED power supplies and example associated innovative lighting and luminaire applications including the circadian rhythm cycle regulation lighting system can also be portable OLED or LED lighting that can be charged by AC, direct current (DC) or solar power/energy sources. Such innovative OLED and LED lighting can be used for camping, emergency, outdoors, indoors, and general portable, etc. compact and rechargeable illumination applications including circadian rhythm regulation, SAD and other types of light therapy applications in these varied environments, etc. With properly designed high efficiency power supplies/drivers, portable OLED and LED lighting sources provide highly innovative, attractive, flexible and even colorful and also entertaining lighting as well as being lightweight and able to support novel shapes and form-factors while still providing circadian rhythm cycle regulation that can be individually modified and adjusted for these and other (e.g., work time, work space, shift time, etc.), environments.

The present invention includes OLED power supplies and associated innovative OLED lighting for desk, and task applications and innovative color changeable OLED RGB (or RYB, RGBA, RTBA, RGBAW, RGBYW, etc. and/or additional colors, etc.) power supplies and drivers. The embodiments of the present invention are very flexible in design and application space.

The present invention includes power supplies for OLEDs, LEDs, QDs, etc. including ones designed for universal AC or DC input voltages and Triac and other dimming formats including 0 to 10 V, powerline, wireless, etc. Such power supplies can be adapted to be highly efficient. Embodiments of the present invention include a number of high performance power supplies and drivers for both monochromatic and multiple color/color changing/color tunable OLED lighting panels, including for example 12 channel common anode and/or common cathode OLED drivers that can be individually addressed and controlled/dimmed by wired and wireless interfaces and smart dimmable OLED desk/task lamps. Matched and mated power supplies/drivers for OLED and OLED panel kits can also be used for:
Highly efficient OLED lighting.
Flexible OLED lighting.
Do-It-Yourself (DIY) building block kit products to significantly expand the usage of OLED lighting applications and markets.
Smart/Intelligent OLED products
Wide range of AC and DC power supply/driver for OLEDs products
Color changing OLED products
Low, medium and high power OLED products
Low cost OLED power supplies and drivers
OLED products aimed at specialized and specific applications, products and markets
High performance OLED products
Task/table/kitchen/closet/compartment, sconce, accent lighting OLED products
Individually personalized OLED products
Energy saving LED light
Color changing
Color tuning
Voice command
Gesturing and proximity detection
Health and Happiness and Entertainment
Retrofit or new construction

A circadian rhythm management lighting system with a wearable monitor can be provided in accordance with some embodiments of the invention. In some embodiments, the wearable monitor is a circadian rhythm detector or detectors. A master coordinator and control unit receives data from the wearable monitor and controls LED and OLED lighting, in some embodiments comprising portable lighting, based at least in part on the data sensed by the wearable monitor including FitBit, Apple, Nike, or any health or fitness monitors, etc., or by data from other mobile sources such as wearable circuits, fabric circuits, communications devices, location trackers, combinations of these, etc.

In an example embodiment of the present invention, portable wireless controlled lighting for the circadian rhythm regulation system can be set to white, blue (for wake-up), green, red, yellow (for blue-free light to promote sleep) and amber-orange (also for blue-free light to promote sleep).

To appropriately synchronize daily rhythms in behavior, physiology and brain functioning with environmental time, terrestrial species have evolved an endogenous, circadian timekeeping system. Circadian rhythms are generated by a hierarchy of central and peripheral oscillators with the suprachiasmatic nucleus (SCN) of the anterior hypothalamus acting as the master circadian pacemaker. The circadian system evolved such that environmental light input from the retina synchronizes internal timing, with the daily environmental cycle of sunlight and darkness as the primary time setter and keeper.

The use of artificial lighting has led to unnatural light exposure, and persistent pattern changes have impacted circadian rhythms and sleep physiology. The use of artificial lighting can lead to some degradation of mental and physical health among human populations. For example, flight attendants frequently traveling across time zones exhibit gross cognitive deficits associated with reductions in temporal lobe structures. Likewise, numerous studies indicate that circadian disruption leads to an increased incidence of cancer, diabetes, ulcers, hypertension and cardiovascular disease, and a degradation of mental health. Exposure to certain types of artificial light at night can result in circadian rhythm misalignments leading to cognitive decline, increased incidence of depression and anxiety disorders, and a host of metabolic disorders. There are concerns regarding circadian rhythm misalignments as they are known to affect response time, judgment and planning, as well as psychomotor skills, and can increase the prevalence of certain illnesses and chronic issues.

By developing strategies to correct/mitigate disruptions to circadian function and misalignment between endogenous cycles in circadian and sleep physiology with the external environment (e.g., following jet lag, shift work, night work, etc.), one can recover diminished human performance as well as improve human health, reduce risk of disease, and enhance cognitive functioning and performance. Strategies that use pharmacological approaches or bright light presentation are often largely ineffective, as chronotype (e.g., ‘lark’ or ‘owl’), circadian phase and amplitude, and other variables that vary largely across individuals are not considered in the treatment regimen. For example, a wearable device can be used with a wireless system that can be utilized as a personal circadian rhythm monitor and regulation device capable of rapidly realigning the circadian rhythm of users to the local environment. In other situations the system adjusts the user to the work, mission or sleep cycle requirements, leading to improved sleep and performance. The lighting system 2900 continuously measures and collects data indicative of circadian phase and uses these data to drive the presentation of light of appropriate wavelengths during optimal times in the circadian cycle known to maximize circadian adjustment and sleep quality. Additionally, the data the device collects is self-reported with data from other wireless monitors of sleep quality for periodic examination of cognitive function and decision making to further enhance light presentation.

An integrated solution of circadian rhythm estimation and light-based circadian rhythm adjustment allows effective regulation of circadian rhythms and avoidance of circadian misalignment, leading to improved health, sleep and performance. The present invention includes an optional integrated wearable device coupled with a wireless system that can be utilized as a personal circadian rhythm monitor and regulation device/system capable of rapidly realigning the circadian rhythm of service members to the local environment or, depending on the situation, aligned to provide an artificial environment to ensure both the rhythm of light and user are in sync with the rhythm of activity and sleep, leading to improved sleep and performance. This device and system continuously measures and collects physiological signals, synthesizes them into continuous circadian rhythm estimation, monitors the ambient light to detect circadian misalignments, and controls artificial light presentation. Secure storage of the data set is on the device/system to allow the user and, with proper approval(s), health professionals to perform further evaluation. The data set includes collected physiological signals, estimated circadian rhythm data, and circadian light monitor control information, as well as user input on self-assessed sleep quality and alertness. The host system can include mobile devices including but not limited to Smart phones, user/operator control stations or integrations into platform avionics suites and work environments. Integration, portability and interoperability across these platforms and their advanced performance management/training environments are important considerations. The present invention can also be used for SAD and other light therapy applications.

The present invention is on lighting systems that can interface with technologies to regulate circadian rhythm for health and performance that can, for example, include a low cost, human wearable system that includes at least two and typically/optionally more than two connected components: the first accurately monitors the user's circadian rhythms to produce reliable circadian phase and amplitude markers and the second is an integrated light presentation unit whereby the timing, wavelength, and intensity of light is driven by the data collected from the first component. The present invention can also be used for SAD and other light therapy applications.

The present invention can be used to increase the effectiveness of utilizing an integrated system and its impact on real-world outcomes of circadian rhythm regulation, sleep, and alertness including accuracy, reliability, and usability of the devices in the system as well as those suffering from SAD and other maladies, diseases, disorders, illnesses, dementia, muscle, physiological or brain disorders, etc.

The present invention can be also be utilized for personal circadian rhythm regulation by synthesizing physiological signals into a circadian rhythm estimate and adjusting the circadian rhythm control light input based on the estimate. The lighting system seamlessly integrates with other peripheral device(s), web-based and Smartphone applications, and provides additional feedback and monitoring tools for long-term health assessment. In addition, the lighting system has numerous uses for various commercial consumers for improving general health of shift workers, students in classrooms, hospital patients, and workers in controlled lighting areas, sleep deprived individuals and aviation operators, including both aircrew and passengers.

Implementations of the present invention include a master coordinator/controller (MCC) that wirelessly receives information as input from the circadian rhythm detector device(s).

The present invention can include wireless commands to control the lighting sources to be able to regulate and entrain the circadian rhythm cycle. Wireless control signals can be transmitted from the MCC to the lighting sources to include light emitting diodes (LEDs) and organic light emitting diodes (OLEDs) and quantum dots (QDs) using appropriate libraries, class(es), frameworks, object oriented languages, etc.

The present invention includes cost-effective, portable, accurate, and transparent methods to monitor, assess, maintain, regulate, realign, and if necessary, reset the circadian rhythm of a person to help ensure optimum health and performance.

The Master Coordinator Control (MCC) unit can be adapted to store, interpret, analyze, and transmit control signals to the lighting modules to apply the range of wavelengths necessary to modify (e.g., for maintaining, resetting and entraining) circadian rhythms.

In some embodiments the circadian rhythm management lighting system with a wearable monitor is adapted to communicate wirelessly with controllers such as a smart phone, tablet, etc. A master coordinator and control unit (MCC) communicates with the wearable circadian rhythm detector(s) via the smart phone/tablet, with either one-way or two-way communications with the smart phone/tablet also acting as an optional method and way to display circadian rhythm and the circadian rhythm regulation system information and data, including those for the control and monitoring of the lighting and other environmental information. Other embodiments of the present invention can also be used for SAD and other light therapy applications.

The light sources can include light emitting diodes (LEDs) and organic light emitting diodes (OLEDs) and quantum dots (QDs) including ones that are designed to install in conventional legacy light sockets and fixtures and/or portable light sources. Embodiments of the present invention can be implemented whereby the MCC communicates with wirelessly-controlled lighting that fits directly into conventional legacy light fixtures (without any changes in the electrical wiring or overhead lighting or lamp design). These LED and OLED lighting sources can change from (non-color) ‘white’ light illumination to any color combination of white light plus primary colors such as, but not limited to, red, green, blue (RGB) or red, green, blue, amber (RGBA) or other color temperatures of white depending on the needs indicated by the MCC unit. The MCC or other controllers control features and functions including alarm clock mode, scheduling, synchronization with local time, daylight harvesting and occupancy sensing, etc. These LED and OLED and/or QD light sources are inherently portable, can be fully deployed typically in a time frame of minutes and is easily system integrated to work locations in conjunction with wearable circadian rhythm (CR) devices to provide light feedback for the circadian rhythm regulation and performance systems. In addition they are rugged, highly reliable, provide controlled dimming and can withstand repeated on/off cycles with no impact on life expectancy. In example embodiments with three color red, green, blue (RGB) or RGB plus amber (RGBA) OLED panels, each individual color can be obtained by turning off the other two colors. To facilitate wake onset and morning circadian phase resetting, a lighting choice with a significant blue color component is selected. To promote sleep onset and permit the nightly evening rise in melatonin a color choice essentially devoid of blue color is selected.

Firmware and software frameworks for bioinformatics, signal processing and interpretive feedback control can be used with the present invention. The software framework can be designed to be interoperable and multiplatform compatible, and incorporate protections for personally identifiable information and health care privacy regulations and to run on a number of platforms including smartphones and tablets running iOS, Android, and Windows Phone operating systems, computers and laptops running Windows, Linux and Apple operating systems as well as having web interfaces. All data regarding individual users can treated and designed to be kept private with encryption and tamper-resistant access permission.

Alternatives and complimentary control effectors such as acoustic spectra, magnetic fields, acupressure, electrical signals, or aromatics can also be included. The wearable circadian rhythm detector can include any suitable sensors, such as, but not limited to, motion sensors or biosensors to track sleep patterns, heart rate sensors, muscle movement sensors, brain activity sensors, blood pressure sensors, oximeters, etc. The present invention can be used in environment(s) that can be highly variable (e.g., while sleeping, traveling, portable locations, etc.) as well as fixed environments (home, barracks, longer-term temporary quarters and housing, etc.).

The functions of the system can be implemented and distributed among system elements in any suitable manner. For example, some embodiments of a circadian rhythm management lighting system include a wearable monitor, LED and/or OLED portable lighting modules or other light sources, and a master coordinator and control unit in direct communication with smart phones, tablets, laptop computers, other computers, etc. Notably, in some embodiments the user can also self-report information using the smart phone/tablet which can also act as an optional way to display circadian rhythm and the circadian rhythm regulation system information and data including for the control and monitoring of the lighting and other environmental information.

The present invention lighting allows virtually any level and ‘size’ of lighting from highly compact lighting that is only a few inches square weighing much less than one pound that can be powered by, for example, batteries to SSL/LED lighting that can be quickly and easily installed in bedrooms, entire houses and apartment buildings to office buildings of practically any size.

Implementations of the present invention allow comparison of circadian rhythm or phase information from commercial off the shelf (COTS) systems whether currently known or developed in the future, as well as devices with well-established markers of circadian phase, including dim light melatonin onset (DLMO) through salivary measures and sleep midpoint analysis.

Implementations of the master coordinator/controller (MCC) wirelessly receive information as input from the circadian rhythm device using any means, including but not limited to WiFi, Bluetooth of all types and flavors, ISM, WeMo, hubs, gateways, bridges, Wink, and Near Field Communications with added channels and/or drivers as desired. The MCC receives signals from smart phones, tablets, laptops, desktops, etc., and the wearable circadian rhythm detection device(s) are in some embodiments able to communicate with, for example, a smart phone, tablet, etc. Sensors, such as cameras and motion detection, can also be used in embodiments of the present invention. Industrial, scientific and medical frequency (ISM) bands and additional sensors as desired can be included in the MCC module. Smart Phone+MCC modules that are portable inexpensive, high powered, optimized can also be used. Software apps can be used to gather, transfer and transmit the pertinent information from the wearable circadian rhythm sensor(s) that is periodically or continuously transmitted to the mobile device and MCC module.

The present invention allows for the ability to integrate, log, archive and catalog data. Data management for collected physiological signals, estimated circadian rhythm, user performance metrics and circadian light modifier control signal information can be used to determine the storage details of how and where the collected physiological signals, estimated circadian rhythm, circadian light control information, the sensor(s) information, the information gathered from the circadian rhythm detector(s), and the control status information along with date, time and location stamps is stored (e.g., in Flash memory, solid-state drives, USB ‘thumb’ drives, SD cards, hard drives, etc.), hard drives, and other types of storage devices. This information can also be synced up to store on additional mobile devices, PDAs, computers, laptops, etc. to, among other purposes, allow health professionals (with privacy protection) further evaluation.

Example features and functions including, as an example, an alarm clock mode with blue wavelength light content to facilitate waking and to and maximize circadian rhythm phase alignment which could also contain amber wavelength or other wavelengths suitable for use near or at or even during sleep time including in hospital, other care-giving facilities, dormitories, schools, overnight camps, military installations, retirement homes and facilities, convalescent facilities, urgent care facilities, recuperation locations and facilities including temporary, mobile, and permanent ones, etc., combinations of these and other discussed herein, etc.

In some embodiments, timing of light presentation and wavelength can be run through a simulation to determine the anticipated impact on circadian phase based on existing models of human circadian functioning. The MCC can be modified or adjusted accordingly if there is incongruence between the timing of light presentation and the required adjustments in circadian phase.

The white plus color changing lighting or white changing plus color changing light can be controlled such that, for example, the white and blue LEDs can be selected (enabled) or deselected (disabled) depending on the phase of the circadian rhythm and other measured and available signals and information or to support SAD or other light therapies.

Wireless commands are used to control the lighting sources to regulate and entrain the circadian rhythm cycle. For example some embodiments can use wireless-controlled white plus color-changing or white color changing plus color-changing LED and/or OLED lighting (including, but not limited to, A-lamp, PAR 30, PAR 38 R30, R40, MR16, GU10, both high and low voltage track lighting, magnetic lighting, 1 ft., 2 ft. 3 ft., 4 ft., 5 ft., 6 ft., and longer linear fluorescent lamp replacement LED tube lamps, PL 2 and 4 pin, U shaped fluorescent lamps, etc., combinations of these, sconces, under-cabinet, over cabinet, wall lights, ceiling lights, night lights, marker lights, HID lamp replacements of all types and forms, etc., combinations of these, etc.) to work with the MCC prototype unit.

Existing sensors including daylight harvesting sensors, other photo/light sensors, motion/occupancy sensors, other environment/ambient sensors, etc. can be used with the present invention. The circadian rhythm regulation system can prompt, notify, alert the user if an inappropriate light source such as, for example, a smart phone/tablet or television set is detected that is emitting inappropriate wavelengths for that part/phase of the circadian rhythm cycle. If the user does not respond to the prompts, notifications and/or alerts, the circadian rhythm regulation system will attempt to modify the offending light source to be circadian rhythm cycle phase-compliant. Such prompts can be sent to, among others and not limited to, family, friends, medical staff, hospital staff, doctors, care givers, emergency responders, etc. by any means including but not limited to cell phones, land line phones, smart phones, mobile phones, tablets, computers, answering machines, text messages, e-mails, pictures, etc., more than one of these, combinations of these, other methods, ways, etc. discussed herein, etc.

Software apps can be used to gather information including geographical location, time zone, ambient light, settings of in-use digital devices including cell/smart phones, tablets, laptop computers, desktop computer displays and monitors, (if possible) televisions, MP3 players, etc. The system uses this information to adjust the display settings to support circadian rhythm cycle alignment and circadian rhythmicity and to avoid or mitigate circadian desynchrony and circadian disruption as well as treat SAD and provide other types of light therapy.

Embodiments of the present invention can include low-cost portable battery-powered/solar powered optical color ‘notch’ filters so as to be able employ these color filters as and where needed to provide additional optical sensory information and feedback to the MCC unit to aid in circadian rhythm regulation.

Some embodiments of the present invention thus provide a means to improve circadian rhythm, SAD, and other illnesses, diseases, disorders, etc. discussed herein by, for example, but not limited to, providing the appropriate wavelengths of light at appropriate times, based on data from sensors and/or information gathered from various sources and control interfaces, including but not limited to:
Internal and external photosensors including wavelength specific or the ability to gather entire or partial spectrums
Atomic clock(s) signals
Other broadcast time signals
Cellular phone times
Smart phone, tablet, computers, personal digital assistants, etc.
Remote control via dedicated units, smart phones, computers, laptops, tablets, etc.
The Web, the Internet, the Cloud, including aggregating information, information and/or data mining, analysis, etc., using existing programs, information, APIs, Apps, etc.

The present invention can be used in general for all types of light therapy including but not limited to circadian rhythm light therapy, SAD light therapy, and other types of light therapy to assist with, treat, improve, etc., illnesses, diseases, cancers, disorders and general well-being.

Particular embodiments depicted and disclosed herein are merely examples and are not intended to be limiting, but can use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. The circuits remove the requirement that a reference level and a comparison to the reference level are required to detect the amplitude of the waveform.

An AC input can be connected, for example, to the pins in a fluorescent light fixture, either with a ballast in place or removed/bypassed. Fuses provide protection, and AC coupling capacitors are provided in some embodiments at the input. A diode bridge rectifier rectifies the AC input, yielding a Pre_LEDP voltage. A series diode is provided in some embodiments, yielding output voltage LEDP to output. A filter capacitor can be provided across the output between output nodes LEDP and LEDN. In some embodiments, a current sense resistor is provided in series with the output.

In some embodiments, a startup sequence circuit for a solid state fluorescent replacement can be included. The startup sequence circuit generates a pulse sufficient to allow ballasts of certain types including certain rapid start ballasts to operate correctly.

In some embodiments, a startup power detection circuit can be included, such as, but not limited to, that disclosed in PCT Patent Application PCT/US15/32763 filed May 27, 2015 for “Lighting Systems” which is incorporated herein by reference for all purposes.

The present invention can be used to provide the electronics for a direct fluorescent lamp replacement that uses for example LEDs or OLEDs or both or QDs or combinations of these, etc. The AC (low 50 or 60 Hz) frequency or electronic ballast (high typically ˜30 to 100 kHz) frequency can be detected using for example but not limited to a microprocessor, microcontroller, FPGA, DSP, ASIC, IC, etc. or combinations of these, etc.—such a detector (using for example a microcontroller or microprocessor, etc.) can also be used to provide the functions disclosed herein.

As some ballasts perform various status, fault, failure, protection detection, sensing, and correction, embodiments of the present invention provide the necessary electronics, circuits including either in analog and digital (or both) implementations and associated firmware/software if needed to provide the proper sequence so that the ballast performs properly with the present direct replacement LED FLRs including rapid start ballasts. For example, circuits in the startup sequence circuit generate a pulse sufficient to ballasts of certain types including certain rapid start ballasts to operate and provide power to the present invention. In addition remote operation including dimming or intensity level changes can be performed, as well as remote monitoring. Remote dimming/level changes can be accomplished for example by, for example but not limited to, inserting the output of a wireless receiver either with a built-in or separate digital to analog converter (DAC) such that the DAC is controlled by the received information from the receiver such that the output of the DAC which is connected to the input of resistor provides the programmable/controllable reference signal/voltage used to set the output current to the LEDs or OLEDs for these embodiments of the direct replacement FLR present invention. An RC circuit can be used to provide a temporary recharging voltage should the DAC (and therefore the output current) be commanded to zero. Notably, more than one DAC can be included for, for example, multi-channel uses in/with the present invention as well as analog to digital converter(s) (ADC(s)) to read various settings and operational info and report this back for example using a transceiver or transmitter, etc.

Low voltage (12 V) AC and DC lighting systems and components including MR16 can also be used for the present invention including RGBW and the use of RGBAW (i.e., R and/or A (amber) and in some cases G to produce yellow for night time, sleep time, sleep, etc. mode and BW to produce light suitable for wake up mode) as well as RGBW and the use of RGBAW with more than one white color temperature which can be in any form and could include but is not limited to a wireless or wired or powerline control (PLC) receiver, transceiver, transmitter, etc. Although a low voltage MR16 was discussed, the present invention also equally applies to all types and forms of general lighting including, but not limited to, GU10, A-lamps, E26 socket lighting, E27 socket lighting, PAR30, PAR38, R30, T12, T10, T9, T8, T5, T4, PL 2 and 4 pin, etc. and other types and forms of SSL/LED/OLED/QD lighting.

The RGBW can consist of discrete LEDs or packaged LEDs of any size and form and also could consist of additional colors and quantities such as RGBWA, RGBWB, multiple white (W) color temperatures, etc.

The present invention also includes dies of any type and form and arrangement that consist of four or more LEDs in which one of the LEDs is white—again, for example, RGBW, RGBWA (or RGBAW, etc.). The package, substrate, die, etc. that the four or more LEDs with one LED being white (e.g., RGBW) include plastic, ceramic, composite, polymers, metal, etc., combinations of these, etc. The ceramic(s) can be of any type including but not limited to oxides, nitrides, etc. such as aluminum oxide, sapphire, quartz, aluminum nitride, beryllium oxide, boron nitride, etc. Any shape can be used including essentially round, square, rectangular, elliptical, parabolic, semi-circle, semi-sphere, sphere and other standard and non-standard essentially 2 and 3 dimensional shapes and forms, etc. Two wires/pads/pins/etc. may be used per LED color or some wires/pads/pins/etc. may be reduced to reduce count, etc. for example, but not limited to, common anode or common cathode arrangements, etc.

If heat sinking is insufficient to support high power RGBW then the present invention can automatically insure that the power is either scaled back for all channels or automatically turn off, for example, the white channel or other color channels and keep the white channel on or dim one or more channels including color and/or white channel(s). In emergency or other types of situations, such heat management control may be overridden to produce additional light (i.e., higher lumens), etc.

For any of the present inventions discussed herein, power supplies of any type, form, topology, architecture, etc. including but not limited to non-isolated and/or isolated power supplies and drivers such as buck, buck-boost, boost-buck, boost, Cuk, SEPIC, forward converters, push-pull, current mode, voltage mode, current fed, voltage fed, one-stage, two-stage, multi-stage, high power factor, linear, switching, resonant converters, half bridge, full bridge, combinations of these, etc.

Embodiments of the present invention include multi-panel configurations including parallel (i.e., same voltage, shared total current through each panel) and series (i.e., same current, stacked voltage). Currently most OLED panels, whether single or multi-color, operate at a total voltage of less than 10 VDC and are typically connected in parallel. White-changing OLED panels also provide a certain subset of color changing/tunability. The circadian rhythm lighting and/or SAD and/or light therapy products can use the white-changing/tunable OLED panels to provide blue wavelength enhanced lighting for the ‘wakeup’ and blue wavelength depressed lighting for the ‘sleep-time’ for example, by using layered blue OLEDs and yellow (or amber or orange or similar wavelength color) OLEDs, respectively in any method including layered on top of each other or side-by-side stripes/strips, etc. These respective OLEDs can be color-tuned/turned on, for example, by providing an appropriate current (or in some cases, voltage) to certain electrodes turn on and excite the proper and desired color or colors depending on the particular point and phase in the circadian rhythm cycle. Implementations of the present invention for both fixed and portable circadian rhythm applications include, but are not limited to, main lighting, under-cabinet and over cabinet lighting for bedrooms, reading rooms, living rooms, dens, family rooms, offices, barracks, hotels, hotel rooms, motel rooms, bed and breakfasts, office buildings, kitchens, bathrooms, etc., desk, table, task, reading, and portable lamps/lights, accent lamp/lights and special environment lighting and other discussed herein, etc. Some embodiments of the present invention apply multiple floating output current control to driving the respective OLEDs/LEDs/QDs/other forms of SSL, etc., combinations of these, etc.

LEDs, OLEDs, QDs, light sources and panels that are color changing, blue enhanced and blue depressed (for example, but not limited to, orange, amber, yellow, reddish, red, etc.), white changing and special purpose OLEDs can be used for circadian rhythm cycle regulation and assistance and/or SAD and/or other lighting described herein as well as for medical, cleanroom, warehouse, office space, museums, event-spaces, multi-use, multipurpose, gyms, classroom, nursery, prenatal care, urgent care, long term care, critical care, intensive care, architecture design, etc. and, general lighting, etc.

The present invention applies to OLEDs, LEDs, QDs, other types of SSLs, combinations of these, etc. in general including white and other fixed color, white-changing, color-changing and multi-color, multi-panel applications including OLEDs of any type including but not limited to stacked, layered, multi-electrode, striped, patterned, etc., OLEDs and edge emitter, edge lit, and waveguided LEDs, QDs, etc.

All of the above can be wirelessly interfaced, controlled and monitored using, for example, smart phones (i.e., iPhones, Androids), tablets (i.e., iPad, iPod touch, droid, etc.), laptops, desktops and other such digital assistants and also other dimming including 0-10 Volt dimming and powerline (PLC) dimming/control. The universal drivers can also support Triac and other forward/reverse phase cut dimming.

In some embodiments a quasi-uniform lighting panel is provided using an array of solid state point light sources such as LED's, QD's, etc., thereby simulating a lighting panel such as an OLED. Electrical connections can be provided around edges of the panel or in any other suitable manner, providing power and control/addressing of individual point light sources or groups of point light sources. For example, LEDs of different color groups can be controlled as groups in some embodiments. The light sources can be positioned in a rectilinear array or in any suitable pattern, and can have any number of colors, RGBW, RGBWA (or RGBAW), with one or more white (W) color temperatures, etc.

An array of LEDs in an OLED equivalent array lighting panel can be included in accordance with some embodiments of the invention. LEDs can be mounted so that they are facing down onto a reflective surface, thereby producing a no-glare OLED equivalent. One or more LEDs may be positioned in each location. In some embodiments of the present invention, more than one color LED may be used. Embodiments of the present invention can provide one or more colors including, but not limited to, two colors such as blue and amber/yellow, multi-colors, RGB, 3 colors, more than 3 colors, monochrome, white, RGBA (where A is amber), RGBW (where W is white), RGBWA, RGBWA plus additional colors, etc. The LEDs can be wired in series and/or parallel and/or combinations of these. The LEDs can be at the corners, along the sides, through inserts into the reflective surface, etc.

In some embodiments the solid state lighting is embodied in fluorescent tube replacements, such as, but not limited to, T4, T5, T6, T8, T9, T10, T12, PL 4 pin and 2 pin etc. An example embodiment of a FLR includes a single strip of LEDs mounted on a printed circuit board between end caps. One or more mounting/connection pins are provided at each end. A lens/cover/reflector etc. can be provided over one or both sides of the FLR.

Circuits can be provided on the printed circuit board, such as, but not limited to, power supply circuits, driver circuits, control circuits, monitoring circuits, reporting circuits, interface circuits, etc. In some embodiments, circuits can include sensors such as, but not limited to, temperature sensors/thermostats, cameras, thermal imaging arrays, etc. Such circuits can be located inline with LEDs, or alongside the LEDs to avoid interrupting the array of LEDs, in end caps or at any other location.

In some other embodiments, a SSL FLR includes a double strip of LEDs mounted on a printed circuit board between end caps. One or more mounting/connection pins are provided at each end. A lens/cover/reflector etc. can be provided over one or both sides of the FLR. The printed circuit board can be mounted across the widest section of the cylindrical housing, with top and/or bottom covers/lenses/diffusers/reflectors as desired. In other embodiments, the printed circuit board can be mounted nearer the top or bottom of the cylinder, as desired. More than two (double) arrays of LEDs can be used for implementations of the present invention.

In some other embodiments, a SSL FLR includes a triple strip of LEDs mounted on a printed circuit board between end caps. One or more mounting/connection pins are provided at each end. A lens/cover/reflector etc. can be provided over one or both sides of the FLR. Again, the SSL FLR can include LEDs of one or more colors including, but not limited to, two colors such as blue and amber/yellow, multi-colors, RGB, 3 colors, more than 3 colors, monochrome, white, RGBA (where A is amber), RGBW (where W is white), RGBWA, RGBWA plus additional colors, etc. Differently colored LEDs can be arranged in any desired layout/arrangement/pattern.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power

Including, but not limited to, AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described primarily for motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components. For example, op amp and comparator in most cases may be used in place of one another in this document.

In some embodiments of the present invention, one or more time constants may be used in feedback and/or control circuits or other devices that provide feedback and control. In some implementations of the present invention it may be useful to turnoff or turn on one or more time constants or other feedback or control circuits when in the ballast powered mode of operation compared to the AC mode of operation.

Implementations of the present invention can be used to identify solid state fluorescent lamp replacements in a solid state lighting system, powered by one or more of multiple sources in accordance with some embodiments of the invention. Some embodiments of the invention include Identification Switches with, for example but not limited to, RFID and/or NFC. In addition implementations of the present invention could have mechanical to electrical switch and/or gesturing, etc. that could, for example, but not limited to ZigBee to RFID, BTLE to RFID, etc. Control circuits interface with the FLRs, powered by any source, including but not limited to, power from the AC line, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet, DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc., WiFi to RFID, vice-versa, etc., two-way communications, etc. Embodiments of the present invention can also be powered by low voltage output power sources including with power over Ethernet (POE). Power switching and/or dimming can be of any known type including but not limited to electro-mechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

Some embodiments of the invention include circuits to link to watches and in particular smart watches, wearable watches, health monitoring watches, FitBit, Apple. Nike, Android based smart watches and wearables, etc.

Some embodiments of the invention include circuits to link to watches and/or other types of wearables to interact with, control, dim, monitor, light and other systems.

Some embodiments of the invention include motion detectors for outdoor outside that can have motion sensor, ultrasonics, noise, etc. separate from the light source and connected via Bluetooth Smart, BLE, USB, use WEB and other info including but not limited to weather, wind, wind speed, could coordinate with other sensors, lights, etc. feedback information, etc.

Some embodiments of the invention includes lamps that can be all or partially screen printed, 3D printed, etc. including custom designs, customized designs, etc. using, for example, UL or CE approved, recognized, listed, etc. materials.

Some embodiments of the invention use proximity sensors and/or beacons, identifiers, etc. to identify who is near including by cellular/smart phone, smart watch, other Bluetooth devices, RFID, others, etc. and take appropriate actions including settings selection based on profile information stored, learned, taught, trained, memorized, etc., combinations of these, etc.

Some embodiments of the invention advertise and obtain Bluetooth and other ID, etc.

Some embodiments of the invention use display panels including but not limited to OLED panels, tablets, etc. as lighting panels.

Some embodiments of the invention use a synchronous bridge for the dimmer. Some embodiments of the invention can also have a TRIAC that is, for example, but not limited to being in parallel with the diodes and transistors of embodiments of the present invention.

Some embodiments of the invention include motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors,

Some embodiments of the invention include sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging.

Some embodiments of the invention are adapted for use in stairwells, etc. especially ones that have doors to entry, use a device that makes a sound when the door is opened so that the light source ‘hears’ the sound and turns on. Can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments of the invention can use active or passive or both high pass, low pass, bandpass, notch, other filters, combinations, etc. including with the voice, sound, noise detection.

Some embodiments of the invention can use isolated digital PWM that can be converted to analog near the control reference point.

Some embodiments of the invention can use proximity and/or signal strength to decide, for example, but not limited to turn on or off lights, etc.

Some embodiments of the invention can flash at the end of an allotted time to indicate that the next group is ready to use, for example, a conference room.

Some embodiments of the invention can listen for and respond to emergency sounds such as smoke, fire, carbon monoxide (CO), carbon dioxide (for, for example but not limited to, both health and occupancy information), etc. detectors, sensors, etc. by flashing, turning on, forwarding the information, alert, alarm, etc.

Some embodiments of the invention can be powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, ZWave, Bluetooth, BTLE, WiFi, cellular, mobile, ISM, Wink, powerline, etc., combinations of these, etc.

A solid state lighting system is depicted with color controllable multiple light sources in accordance with some embodiments of the invention. For example, a solid state lighting system may include a solid state light fixture with multiple flat lighting panels (e.g., OLED panels) and multiple solid state point light sources, such as a LED. The shape, layout, form factor, and types and numbers of light sources are merely examples and should not be viewed as limiting in any manner. Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc. In some embodiments, the SSL can provide evening/night light using for example amber-orange-yellow SSLs including but not limited to LEDs and/or OLEDs that can be dimmed, flashed, color-changing, sound alarms, sequence, provide time of day and circadian rhythm and/or other health therapy or ailment alignment, information, etc. Some embodiments of the present invention can have light, motion, proximity, noise, sound RFID, NFC, etc. sensors that are either internal or external and connected by one or more of wired, wireless, powerline communications (PLC), etc.

Some embodiments of the present invention can include LEDs. OLEDs, QDs, other SSLs, other types of lights, etc. combinations of these, etc. and can include combinations of flashing, sequencing, dimming, changing colors, individually and/or collectively, etc., sirens, alarms, alerts, web connectivity, wired, wireless and/or PLC, etc.

Power supply circuits can pass power through to solid state lights and can provide one or more of the functions disclosed herein, such as, but not limited to, current control, undervoltage protection (UVP), overvoltage protection (OVP), short circuit protection (SCP), over-temperature protection (OTP), etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

Some embodiments of the invention can include indoor and/or outdoor motion sensors. The lights and, for example, sensors can have auxiliary ports that allow both control signals and other types of sensors, detectors, features, functions, etc. including, for example, but not limited to, motion, sound, video, vision recognition, pattern recognition, etc., combinations of these, etc. The indoor and outdoor embodiments can be very similar except for weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well-being watches, other wearables, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc. Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as a intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc.

Some embodiments of the invention can be configured, controlled, monitored, etc., from/to smart devices using for example, but not limited to, Apps, laptops, desktops, servers, mobile and/or PDA devices of any type or form, combinations of these, etc.

Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments of the invention can include outdoor motion sensing with smart additional components, accessories, etc. Sense includes weather, including from any source such as a local weather station, personal weather station, web-based weather report, etc. Smart Motion sense can also dim, flash, change intensities, white colors, be color-changing, etc., communicate two or more way, etc., monitor weather locally, regionally, wind factor, have a wind indicator, etc., wind vane, wind generator, etc.

Implementations of the present invention are designed to be a cost-effective and complete solution that provides both forward and backward compatibility which is also ideal for retrofits and can use either wireless or wire (or both) communications.

Implementations of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, etc.

Implementations of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Embodiments of the present invention support and can include color changing, color tuning, etc. lights with numerous ways to interact with the lights.

Embodiments of the present invention can be integrated with video, burglar, fire alarm, etc. components, systems.

Other features and functions include but are not limited to detecting the frequency using a microprocessor, microcontroller, FPGA, DSP, etc. Use of a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. Embodiments of the present invention removes the requirement that a reference level and a comparison to the reference level is required to detect the amplitude of the waveform

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.) or any other type of location, functionality, airport, train station, bus station, light rail, subway, other places including but not limited to those discussed, listed, presented herein, etc., accent lighting, mood lighting, location indication, emergency information and direction, full spectrum lighting, wayfinding, etc.

The present invention can work with all types of communications devices including portable communications devices worn by individuals, walkie-talkie types of devices, etc.

The present device can use combinations of wireless and wired interfaces to control and monitor; for example for a linear or other fluorescent replacement for, for example, but not limited to, T4, T5, T8, T9, T10, T12, etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

The present invention can also have one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these, etc. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces, protocols, device, circuits, systems, etc. In some embodiments the thermometer(s) and/or thermostat(s) can communicate with each other and relay, share, and pass commands as well as provide information and data to one another.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc., horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included in the present invention to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Embodiments of the present invention can use/incorporate/include/etc. thermal imagers including but not limited to IR imagers, IR imaging arrays, non-contact temperature measurements including point temperature and array temperature measurements including in lighting such as T8 and other linear and non-linear and non tubular replacements where the imagers are powered, for example, but not limited to the ballast either directly or indirectly.

Embodiments of the present invention allow for dimming with both ballasts without the need for dimming ballasts and AC line voltage.

Implementations of the present invention can use, but are not limited to, Bluetooth, Bluetooth low energy, WiFi, IEEE 801, IEEE 802, ZigBee, ZWave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

Embodiments of the present invention include SSL/LED Direct Fluorescent Tube Lamp Replacements that can be used, for example, but not limited to, for daylight harvesting/occupancy uses and applications.

Embodiments of the present invention uses wireless signals to both control (i.e., dim) the LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent LED FLRs are compatible with most daylight harvesting controls and protocols. Optional sensors allow for relative light output to be measured and wirelessly reported, monitored, and logged permitting analytics to be performed. Embodiments of the present invention come in a diversity of lengths including but are not limited to two foot, three foot, and four foot, five foot, six foot, eight foot T8 and other standard/nominal linear lengths as well as T12, T4, T5, T9, T10, etc. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or ZigBee, ZWave, IEEE 802, or WiFi or Bluetooth or any type of form. In addition to occupancy/motion sensors, photo sensors and daylight harvesting controls, simple and low cost interfaces that allow existing other brands, makes, and models of daylight harvesting controls, photo sensors, occupancy/vacancy/etc. motion sensors to be connected to and control/dim embodiments of the wireless SSL/LED FLRs. The SSL FLR can be switched on and off millions of times without damage as well as be dimmed up and down without damage. The wireless communications can be encrypted and secure. Such embodiments of the present invention FLRs do not require or need a dimmable ballast and work with virtually any T8 electronic ballast from all major ballast manufacturers (optionally with most T12 electronic ballasts).

The present invention can have integrated motion sensor as part of the housing and can also use auxiliary motion sensors and can also have integrated light/photocell sensor as well as auxiliary.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

Embodiments of the present invention permits enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form, DVD and other entertainment lighting and displays containing LEDs, OLEDs, CCFLs, FLs, CRTs, etc., displays, monitors, TVs, OLED, LED, CCFL, FL, incandescent lighting, etc.

The present invention can use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters.

The present invention can use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

The present invention can use TVs essentially of any type or form, including, but not limited to smart TVs, and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

The present invention can have integrated motion sensor as part of the housing and can also use auxiliary motion sensors and can also have integrated light/photocell sensor as well as auxiliary. In some embodiments of the present invention, these can be stand-alone units that replace conventional fluorescent lamps including, but not limited to, T8, T12, T5, T10, T9, U-shaped, CFLs, etc. of any length, size and power as well as high intensity discharge lamps of any size, type, power, etc.

The present invention can also respond to proximity sensors including passive or active or both, as well as voice commands and can be used to turn on, turn off, dim, flash, strobe and/or change colors, etc. including but not limited to including doing so in response to an emergency or dangerous situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

The present invention can use a BACNET to wireless converter box or BACNET to Bluetooth including Bluetooth low energy (BLE) converter. The present invention can also use infrared signals to control and dim the lighting and other systems as well as other types of devices including but not limited to heating and cooling, thermostats, on/off switches, other types of switches, etc.

The present invention can have the motion proximity sensor send signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to wired, wireless or powerline control which, for example, could be installed or added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelengths of light at appropriate times.

Internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

The present invention can also have sirens, microphones, speakers, earphones, headphones, emergency lights, flashing lights, strobing, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T8, T9, T10, T12, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors.

Implementations of the present invention can include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, dimmable compact florescent lamps, incandescent bulbs, halogen bulbs, etc. as well as smart dimmable (i.e., by wired, wireless, powerline communications, etc., combinations of these, etc.), infrared controlled devices including heaters of any type or form, air conditioners of any type or form, projectors, TVs, monitors, etc., color-changing, color-tunable, white color-changing, lighting of any type including but not limited to those discussed herein. Non-dimmable lamps and appliances and entertainment devices including but not limited to TVs, DVD players, CD players, satellite receivers, cable TV receivers and boxes, Blu-ray players, radios, projectors, other media, communications/media/content/entertainment/display, etc., devices, equipment, instrumentation, etc. can also be included in such implementations of the present invention and may be turned on and off by one or more of the smart on/off switches or a dimmer that is, for example, but not limited to, programmed to full on and full off only, etc. Projectors in including but not limited to classrooms, conference rooms, meeting rooms, lecture halls, etc. can be controlled, sequenced, included as part of a scene, separately activated, turned on, turned off, lights dimmed or turned off including but not limited to individually, in groups, in certain arrangements, patterns, etc., combinations of these, etc. The present invention can also provide signaling and indicating for room occupancy or vacancy for scheduling, etc.

Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can you any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), etc.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention can accept the output of a fluorescent ballast replacement that is designed and intended for a LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc. In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, facial expression(s), facial recognition, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics. Some embodiments of the present invention may be multiple dimming, color tuning, color temperature tuning and/or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both. Such a Remote Controlled Florescent Ballast Replacement can also support color LED Fluorescent Lamp Replacements including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc. Color-changing/tuning can include, but is not limited to, white color-tuning including the color temperature tuning/adjustments/settings/etc., color correction temperature (CCT), color rendering index (CRI), etc. Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. The ability to change to different colors when using light sources capable of supporting such (i.e., LEDs, OLEDs and/or QDs including but not limited to red, green, blue, amber, white LEDs and/or any other possible combination of LEDs and colors). Embodiments of the present invention has the ability to store color choices, selections, etc. and retrieve, restore, display, update, etc. these color choices and selections when using non-fluorescent light sources that can support color changing. Embodiments of the present invention also have the ability to change between various color choices, selections, and associated inputs to do as well as the ability to modulate the color choices and selections.

A further feature and capability of embodiments of present invention is use of passive or active color filters and diffusers as well as beam steering, optical steering, etc., combinations of these, etc. to produce enhanced lighting effects.

In addition, protection can be enabled (or disabled) by microcontroller(s), microprocessor(s), FPGAs, CLDs, PLDs, digital logic, etc. including remotely via wireless or wired connections, based on but not limited to, for example, a sequence of events and/or fault or no-fault conditions, sensor, monitoring, detection, safe operation, etc. An example of protection detection/sensing can include measuring/detecting/sensing lower current than expected due to, for example, a human person being in series with (e.g., in between) one leg of the LED, OLED and/or QD replacement fluorescent lamp and one side of the power being provided by the energized ballast. The present invention can use microcontroller(s), microprocessor(s), FPGA(s), other firmware and/or software means, digital state functions, etc. to accomplish protection, control, monitoring, operation, etc.

In addition to using a switching element, a linear regulation/regulator instead of switching regulation/regulator can be used or both linear and switching regulation or combinations of both can be used in embodiments of the present invention.

Rapid start ballasts with heater connections may be made operable using resistors and/or capacitors. Certain implementations require less power and also evenly divide and resistance or reactive (e.g., capacitive and/or inductive) impedances so as to reduce or minimize power losses for the current supplied to the fluorescent lamp replacement(s). An example when having power supplied from an instant start or other ballast without heater(s) with only one electrical connection per ‘side’ of the fluorescent tube/lamp or fluorescent tube replacement (for a total of two connections) the resistors are effectively put into parallel thus reducing the resistance by a factor of four compared to being in serial for, for example, a heater emulation circuit or as part of a heater emulation circuit. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

In some embodiments of the present invention, a switch may be put (at an appropriate location) in between the ballast output and the fluorescent lamp/fluorescent lamp replacement such that there is no completion of current flow in the fluorescent lamp replacement to act as a protection including shock hazard protection for humans and other living creatures in the event of an improper installation or attempt at or during installation. The detection of a such a fault or improper installation can be done by any method including analog and/or digital circuits including, but not limited to, op amps, comparators, voltage reference, current references, current sensing, voltage sensing, mechanical sensing, etc., microcontrollers, microprocessors, FPGAs, CLDs, wireless transmission, wireless sensing, optical sensing, motion sensing, light/daylight/etc. sensing, gesturing, sonar, infrared, visible light sensing, etc. A microprocessor or other alternative including, but not limited to, those discussed herein may be used to enable or disable protection and may be combined with other functions, features, controls, monitoring, etc. to improve the safety and performance of the present invention including before, during, after dimming, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

Some embodiments of the present invention utilize high frequency diodes including high frequency diode bridges and current to voltage conversion to transform the ballast output into a suitable form so as to be able to work with existing AC line input PFC-LED circuits and drivers. Some other embodiments of the present invention utilize high-frequency diodes to transform the AC output of the electronic ballast (or the low frequency AC output of a magnetic ballast into a direct current (DC) format that can be used directly or with further current or voltage regulation to power and driver LEDs for a fluorescent lamp replacement. Embodiments of the present invention can be used to convert the low frequency (i.e., typically 50 or 60 Hz) magnetic ballast AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown in herein are merely intended to provide some illustrations of the present inventions and not limiting in any way or form for the present inventions.

Using digital and/or analog designs and/or microcontrollers and/or microprocessors any and all practical combinations of control, protection, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of, for example, a comparator.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or kilowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), provide data monitoring, data logging, analytics, analysis, etc. including, but not limited to, input and output current, voltage, power, phase angle, real power, light output (lumens, lux), dimming level if appropriate, kilowatt hours (kWH), efficiency, temperature including temperatures of components, driver, LED or OLED array or array or strings or other types of configurations and groupings, etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, DALI, other serial interfaces, etc.), a combination of analog and digital, analog-to-digital converters and interfaces, digital-to-analog converters and interfaces, wired, wireless (i.e., RF, WiFi, ZigBee, ZWave, ISM bands, 2.4 GHz, Bluetooth, etc.), powerline (PLC) including X-10, Insteon, HomePlug, Smart Home, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including but not limited to digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described primarily for motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components. For example, op amp and comparator in most cases may be used in place of one another in this document.

Embodiments of the present invention can use external sensors including color temperature, color, wavelength, spectral sensors, etc. to set the properties including but not limited to color, color temperature, CRI, etc. of the light source and associated optics including sleeping light sources, beam steering/steered light sources, filters, liquid crystals, shutters, types of light sources, chromatic windows, electrostatic windows, electrically controlled window materials, etc. Such sensors can be internal or external or both, embedded, separated, grouped, individual, combinations of these, etc.

A major problem with SSL including LED lighting products is the inability to change or upgrade the LEDs as the LEDs are often an integral part of the lighting product, fixture, etc. The present invention addresses this by making the LED light sources, whether, for example, but not limited to, light bars, light strips, light tubes, arrays of LEDs arranged in circle, corn, cylindrical, square, rectangular, triangular, etc., combinations of these, etc.—essentially any shape—modular and easily replaceable so that the system can be upgraded from mono-white color to dual-white color (i.e., warm and cool white, low and high color temperatures, etc.), color temperature tunable with 2 or more while color temperatures, color tunable with 2 or more colors including but not limited to white, etc. The electronics and firmware can also be upgraded or in some embodiments may already allow and accept the modular SSL/LED upgrades and well as also in some embodiments the electronics can also be modular. The upgrades whether, for example but not limited to, already built-in or added/upgraded include but are not limited to dimming, trimming, tunability, communications, etc. so as to, among other things, provide future-proof capabilities.

In such a modular system, various elements of the system can be modular and individually replaced and/or upgraded, such as, but not limited to, the light sources (e.g., LEDs), power supply, dimming circuits, sensors of various types, etc.

Cameras and other sensors, detectors, IOT, can be embedded, incorporated, connected, separated, wired, wireless, power line communications, etc. for implementations of the present invention.

These lighting units and tiles can be integrated with sensors, Internet of Things (IOT) sensors and other devices, controls, firmware including embedded firmware and software for responses, programming, and interactions. For example, the colors of the tiles could be changed with music. In the case of the Rubik cube, the Rubik cube could be played by touching and moving the colors through, for example, but not limited to touch screen function. In addition to wireless control, wired control including analog, digital or both can be used to set the color(s) intensities, dimming, levels, etc. As a non-limiting example, AC to DC powerline and DC to DC powerline control (PLC) can also be used with the present invention. The LEDs may be in any configuration including but not limited to back lit, edge lit, side lit, combinations of these, etc.

The LED lighting can be adjusted to support circadian rhythm, light therapy, health benefits, high color temperature (CCT) at, for example, breakfast time and low (warm) CCT at dinner time, night time and sleep time. Embodiments of the present invention can be used as night light or motion controlled night light(s), can use photo/optical sensors to perform daylight harvesting, can use one or more of energy harvesting of any type and form including but not limited to solar, optical, RF, mechanical, vibrational, thermal, thermoelectric, thermomechanical, noise, acoustic, etc., combinations of these, etc., as well as batteries, battery charging, AC power, DC power, wireless power, etc., combinations of these, etc.

In some embodiments of the present invention, the LEDs that comprise the implementation of the present invention may be turned on/set/activated/operated/etc. as an entire group or individually addressed including forming images. In some embodiments of the present invention, the lighting elements may consist of other types of lighting including but not limited to other types of solid state lighting (SSL) such as but not limited to organic light emitting devices (OLEDs) and quantum dot (QD) based lighting and/or combinations of these, etc. In some embodiments of the present invention, implementations can also perform display of information including but not limited to text, images, movies, streaming videos, movies, sending SMS messages, other types of alerts, messages, e-mails, Cloud mail, combinations of these, etc.

The present invention can also be used to alert, warn, etc. In the event of a fire, break in, home invasion, carbon monoxide situation, intruder detected, compromise of breach of home, house, residence, building, office, showroom, store, etc.

The present invention can use sensors including IOT sensors, cameras including cameras of any type, form, etc. which can be incorporated, embedded, inserted, etc. into implementations of the present invention. Embodiments of the present invention can display patterns, images including but not limited to moving images, rainfalls, waterfalls, oceans, rivers, any type of scenes, visualizations, etc. Embodiments of the present invention can incorporate water including but not limited to waterfalls, pumped water, other water effects, cascading water, etc.

Embodiments of the present invention can include speakers including but not limited to Bluetooth speakers, wireless speakers, wired speakers, internal speakers, etc., combinations of these, etc.

Embodiments of the present invention can include microphones including but not limited to Bluetooth microphones, wireless microphones, wired speakers, internal speakers, etc., combinations of these, etc.

The present invention can be connected to, for example, but not limited to weather services or other web based services to indicate, for example but not limited to, the weather, the time, the spectrum of the Sun, the moon, light therapy, health related lighting, etc.

Embodiments of the present invention can also be used as a neighbor warning system and change colors, flash, incorporate sirens, speakers, microphones, etc. when an suspicious event or events such as but not limited to a break in, intrusion, fire, carbon monoxide detected, gas detected, etc. takes place.

Embodiments of the present invention can include but are not limited to using, for example, but not limited to a regular on/off light switch and incorporate 0 to 10V dimmer in cover plate as well as LED motion light and/or light sensor. Embodiments of the present invention including but not limited to the ones discussed above and herein can use for example but not limited to ZigBee, ZWave, BLE, WiFi, etc.

Embodiments of the present invention can include artificial intelligence (AI), virtual reality (VR) and augmented reality (AR).

The present invention relates to lighting and in particular to solid state lighting (SSL) including but not limited to LEDs, OLEDs, QDs, etc.

The present invention can be used with lighting of all types including, but not limited to, with ceiling, wall, recessed, direct, embedded, installed, troffer, pendant, replacement, etc.

Embodiments of the present invention can be used to replace, upgrade, and retrofit existing and new lighting fixtures. The present invention can utilize safe DC voltages (typically below 60 VDC) which can be discrete, bundled, periodically placed, low wattage, high wattage, individual, grouped, zoned, one or more outputs, groups of outputs, etc. that can be connected wired, wirelessly, powerline, etc., combinations of these, etc. such that the electrical power can be from, but not limited to, AC to DC power supplies, solar to DC converters, wind generated, alternative energy, heat to electrical, thermal to electrical, vibration, mechanical, geothermal, hydroelectric, etc. such that the low voltage DC (or in some implementations) AC can be fed to SSLs including one or more LEDs, one or more arrays of LEDs, one or more strings of LEDs, etc., combinations of these, etc. and controlled with embodiments of the present invention inserted in between the low voltage DC and the current controlled SSLs.

Embodiments of the present invention can be used to make non-dimmable and non-tunable SSL including LEDs, OLEDs, etc. dimmable and, in some embodiments, tunable including but not limited to color temperature tunable and color tunable. For example, but not limited to, making voltage controlled power supplies series dimmable either by one or more of analog or digital or PWM, PFM, PPM, etc. and current controlled power supplies shunt dimmable either by one or more of analog or digital or PWM, PFM, PPM, etc.

Embodiments of the present invention can use a dumb power supply that for example but not limited to takes an AC input including a universal AC input (80 VAC to 277 VAC+/−10% or higher or lower e.g., 480 VAC, 50/60 Hz, 400 Hz, etc.), a DC voltage from, for example, but not limited to, an AC to DC power supply, a solar panel, an array of solar panels of any type or form, etc. and use the DC output to power one or more lamps as well as provide power for controls, sensors, IOT, etc. In some cases, for example, but not limited to step up or step down converters, inverters, etc. including but not limited to buck, buck-boost, boost-buck, boost, Cuk, SEPIC, flyback, forward converters, etc. can be used. In some embodiments of the present invention, the lighting source may be TLEDs that are powered by the AC to DC or one or more other power source(s), SSL/LED strips, conversion kits, etc.

Embodiments of the present invention can also include additional elements with functions and features such as additional indicating lights including orbs, pucks, diamond, etc. shaped lights that can be triggered turned on to indicate fire, earthquakes, intruders, bad actors, other natural or manmade events, disasters, situations, threats, etc. The indicator light can consist of one or more indicator lights including one or more colors that can be individually and/or group controlled including simple on/off, blinking, PWM, etc.

FIG. 12 depicts a block diagram of a solid state lighting system including smart units for processing sensor inputs, communicating with controllers or between SSL/FLR devices, etc., in accordance with some embodiments of the invention. A constant voltage supply 140 powers a smart unit 142, which controls a down light 144. The down light 144 can be used to provide area illumination and/or to provide status or instructions or directions, such as, for example but not limited to, using color, flashing, intensity, etc., displayed graphics, shaped illumination such as arrows etc. The constant voltage supply 140 can also power other elements of a lighting system, such as, but not limited to, other smart units 146, 148, 150 controlling SSL/FLR devices in fluorescent troffers 152, T8 replacements 154, other lights 156, or any other non-limiting solid state lighting or other devices as disclosed herein or otherwise.

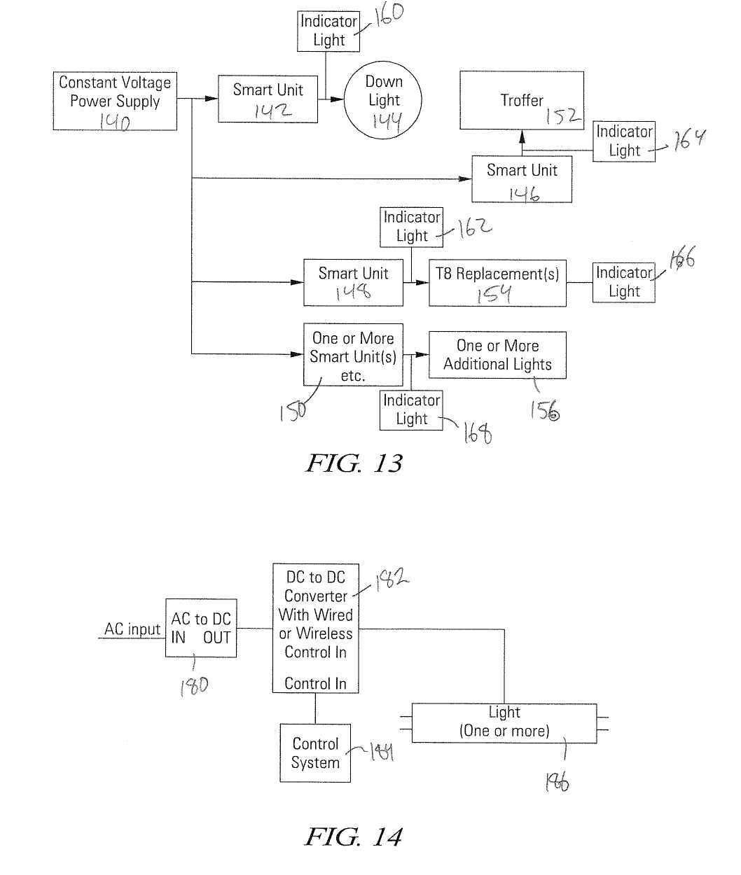

FIG. 13 depicts a block diagram of a solid state lighting system including smart units for processing sensor inputs, communicating with controllers or between SSL/FLR devices, etc., including indicator lights for, for example but not limited to, providing indications of dangerous or safe regions in a building, directions to exits or areas of interest, etc., in accordance with some embodiments of the invention. In this example embodiment, indicator lights 160, 162, 164, 166, 168 are added to the system of FIG. 12, which can be used, for example but not limited to, providing directions, instructions, status etc. as disclosed above with respect to FIGS. 3, 4 and 5.

FIG. 14 depicts a block diagram of a solid state lighting system including an AC to DC converter 180, DC to DC converter 182 and control system(s) 184 for processing sensor inputs, communicating with controllers or between SSL/FLR devices 186, etc., in accordance with some embodiments of the invention.

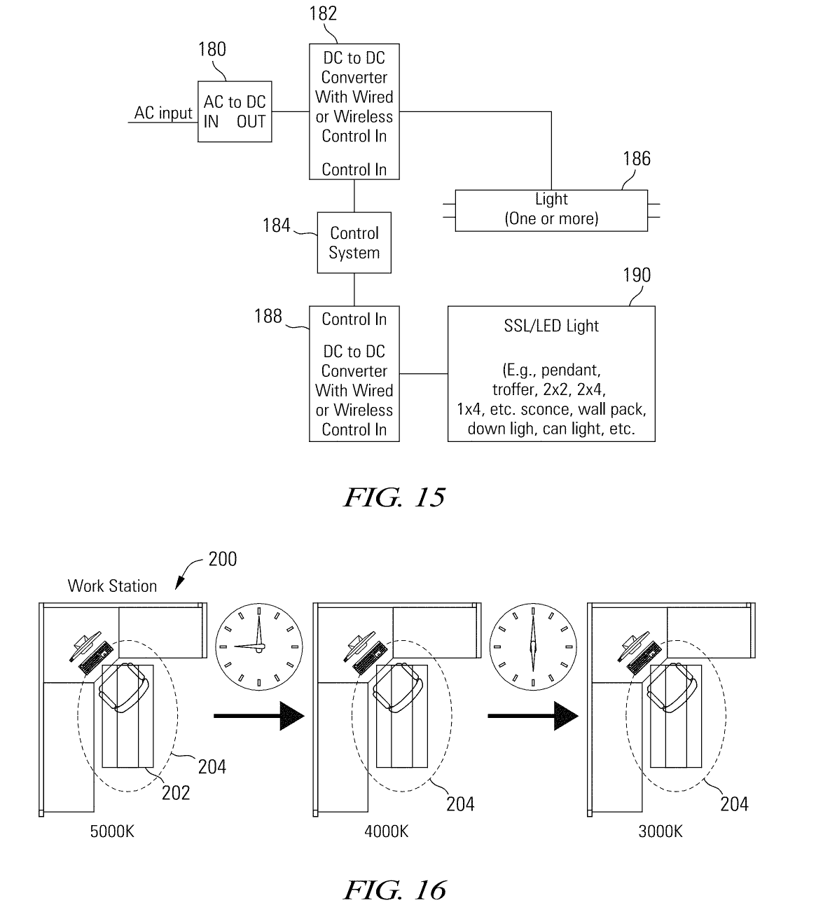

FIG. 15 depicts a block diagram of a solid state lighting system including multiple DC to DC converter modules and control system(s) for processing sensor inputs, communicating with controllers or between SSL/FLR devices, etc., in accordance with some embodiments of the invention. In this embodiment, additional DC to DC converters (e.g., 188) and other SSL/LED lights 190 or other systems are added to the system of FIG. 14, giving a simple, non-limiting example of the expandability of the system.

FIG. 16 depicts a cubicle or work space 200 with a solid state lighting system 202 that can be programmed to automatically adjust color temperature in the illuminated region 204 based on time of day or other triggers or events or conditions in accordance with some embodiments of the invention. For example, the system might be programmed to have a color temperature of 5000K before 9:00 AM, a color temperature of 4000K between 9:00 AM and 6:00 PM, and a color temperature of 3000K after 6:00 PM in order to benefit natural circadian rhythms, improve concentration and health, improve evening restfulness, etc. Of course, such changes can be pre-programmed, user-selectable, triggered by sensor input or other stimuli, etc. This and other features of the invention can be user-controlled, controlled by real-time control systems, edge-computing, machine-learning, AI systems, etc.

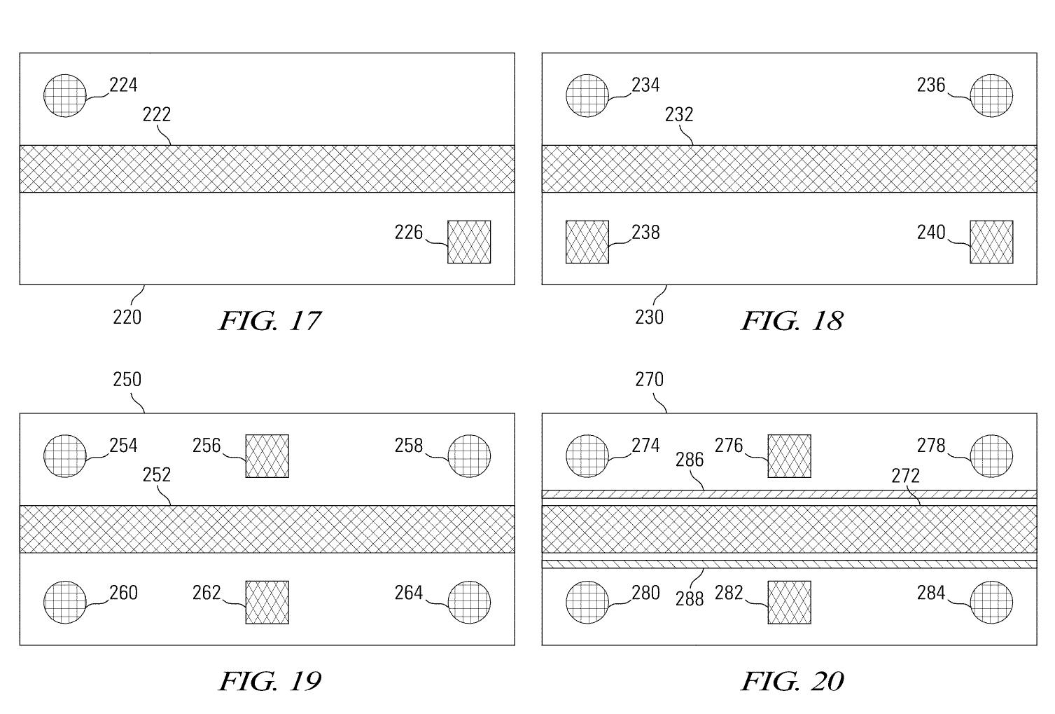

FIG. 17 depicts a fluorescent lamp troffer 220 with a solid state light source 222 and sensors/indicator lights/danger lights/cameras/microphones/buzzers/speakers/sirens, 224, 226 etc. in accordance with some embodiments of the invention. For example,

FIG. 18 depicts another fluorescent lamp troffer 230 with a solid state light source 232 and sensors/indicator lights/danger lights/cameras/microphones/buzzers/speakers/sirens 234, 236, 238, 240, etc. in accordance with some embodiments of the invention.

FIG. 19 depicts another fluorescent lamp troffer 250 with a solid state light source 252 and sensors/indicator lights/danger lights/cameras/microphones/buzzers/speakers/sirens 254, 256, 258, 260, 262, 264, etc. in accordance with some embodiments of the invention.

FIG. 20 depicts another fluorescent lamp troffer 270 with a solid state light source 272 and sensors/indicator lights/danger lights/cameras/microphones/buzzers/speakers/sirens 274, 276, 278, 280, 282, 284, etc. and with indicator danger lights 286, 288, etc., in accordance with some embodiments of the invention.

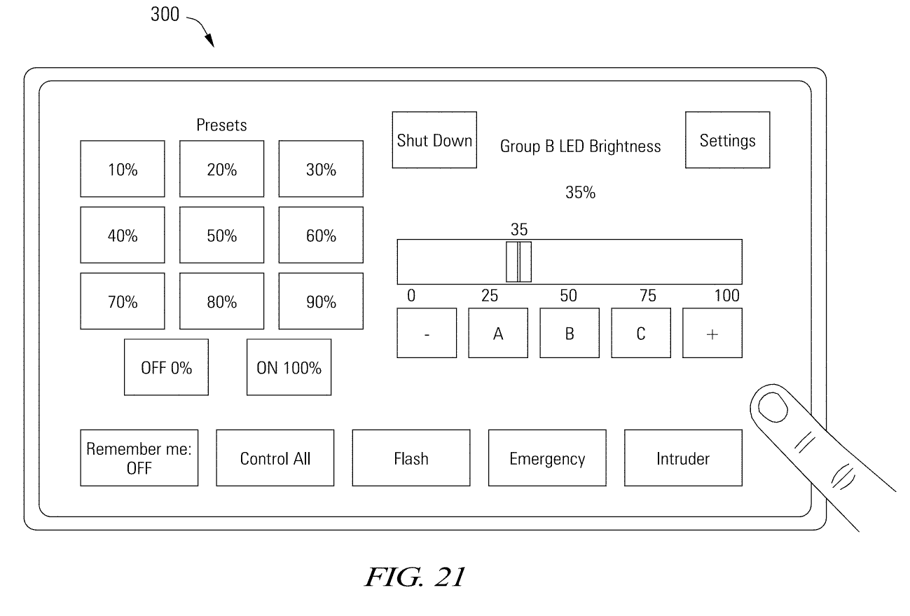

FIG. 21 depicts an example touchscreen of an App/API/GUI/etc. 300 for interfacing with/configuring/controlling a solid state lighting system, including but not limited to adjusting SSL/LED brightness or other lighting brightness in a group of LED lamps and for placing the system in a particular state such as an emergency or flashing state in accordance with some embodiments of the invention. This non-limiting example can, for example, but not limited to, be used in numerous settings and applications, environments, etc. including but not limited to as the main interface, as an interface in a hallway, classroom, gym, conference room, auditorium, cafeteria, multi-purpose room, break room, study room, entrance, exit, office, suite, waiting room, hospital room, hospital, nurses' station, spa, swimming pool, outdoors, indoors, etc., any of the places discussed herein. For example and not limited to, the touchscreen depicted in FIG. 21 can, for example, be used by a teacher in a classroom either mounted to a wall or sitting on a desk or both and wired or wirelessly connected or both to implementations of the present invention or even being portable and handheld and wirelessly connected to implementations of the present invention. The touch screen can also be gesture activated, voice activated, sound activated, etc. In terms of sending out safety, security, danger, etc. codes and information to, for example, but not limited to flash, strobe, change color or other things and ways mentioned herein, etc., biometrics could be required of one or more of the teacher, the students, the aides, the parents, the staff and administration, the principal, other employees, contractors, subcontractors, etc. As a non-limiting example in some to all situations, depending on the circumstances, for example but not limited to a finger or, for example but not limited to a thumb, could biometrically be required to manually activate a flash, strobe, alarm, buzzer, 17 KHz audio signal, color change on implementations of the present invention. In addition to such a non-limiting example of a touchscreen or similar touch pad, capacitor sense, other remote devices, cell phones, smart phones, tablets. Lap tops, desk top, computers in general, servers, etc. located locally and/or remotely could also be monitoring, viewing, seeing, responding, acting, determining, analyzing, mining, imaging, studying, etc., combinations of these including but not limited of one or more, as appropriate for a particular situation, of on-site security, police, law enforcement, employees, staff, teachers, faculty, employers, officers, administration, other personnel, etc. as well as remote and/or off site including but not limited of one or more, as appropriate for a particular situation, of on-site security, police, law enforcement, employees, staff, teachers, faculty, employers, officers, administration, other personnel, etc. Note that although only one page/menu/GUI/App/etc. of the touchscreen display is depicted in FIG. 10, there can be but is not limited to one or more or many additional subpages, menus, master pages, main page, other types of constructs and displayed information including graphical, video, images, overlays, maps, paths, ways, warnings, video from cell phones, smart phones, tablets, imagers, thermal imagers, heat maps, anything discussed herein, etc., cameras of any type, etc., Web, Edge, Cloud information, pages, sites, etc., partial or complete dashboard and/or dashboard information, safety, security, threat, risk, temperature maps and/or trends/history, humidity maps and/or trends/history/etc., information, data, trends, history, storage, etc. from any sensor, detector, microphone, speaker, etc. anything discussed herein, etc. combinations of these, etc. sliders, pointers, numerical entries, real and virtual knobs, real and virtual encoders, decoders, real and virtual buttons, real and virtual switches, settings, etc.

The non-limiting example of the touchscreen depicted in FIG. 10 can, for example, but not limited to work/interact/etc. in conjunction with, in tandem, in sequence, in series, in parallel, separately, manually, automatically, with assistance from others including other devices and humans, be part of, be monitored by, be controlled by, etc. others including systems at the location and/or remote from the location, by security, law enforcement, police, etc. on the premises, remote from the premises, on the way to the premises, mobile and either stationary or moving, other ways, methods, approaches, interactions both directly using humans or by/with artificial intelligence, those discussed within, etc., combinations of these, etc.

The present invention can be, for example but not limited to, controlled by one or more combinations of touchscreen, touch pad, computer, lap top, server, dedicated control, phone app, tablet app, dashboard, the cloud, the edge, etc., combinations of these, The present invention provides Security and Safety including but not limited to communications, directional applications, and situational awareness.

The present invention provides productivity and occupant/user comfort which results in improvements to productivity.

The present invention provides health benefits and enhancements and is suitable and can be optimized for individuals with autism, migraines, depression, etc. which have all been shown to have a correlation between light sensitivity and a physical response.

The present invention supports and can use analytics as well as dimmable lights, temperature tunable lights, color tunable lights, digital sensors, digital controls, communication between elements of system, dynamic tuning of intensity/brightness.

The lighting in living, working, and community spaces impacts how we function, feel, and interact with others.

Light sensitivity is a common phenomenon for many of the 3.5 million American's with autism spectrum disorder (ASD) and a substantial portion of the general population, especially those with Migraines and Depression.

Certain fluorescent and poorly designed LED lighting send out pulsing light signals including flicker, that are highly uncomfortable and can be distracting, adversely affecting well-being, productivity, employment and overall health.

Harm and pain points range from excessive eyestrain to headaches, myopia, or worse. Additionally, these types of light sensory disruptions can lead to social problems, attention difficulties, diminished educational and employment outcomes.

There is great value to the wellbeing, learning potential and improved productivity of autistic individuals by replacing improper, harmful lighting with cost-effective, efficient and human centric lighting for both those with ASD and those without ASD.

The present invention can be tuned to Daytime preferred spectra (blue rich) to support better productivity in the day and to Evening preferred spectra (Blue deprived) to support better Circadian Cycle in the evening and night.

The lighting of the present invention can be integrated with ambient temperature, humidity, ambient light, spectra, and sensors to provide a network to monitor energy efficiency, control environmental impact, while supporting demand and response in order to provide quality and positive experiences in every setting and every environment

Lighting should be a simple, helpful modality. Proper lighting can reduce the visual component of complex stress and provide an environment in which functionality and productivity can become optimal.

Lighting solutions that work well for people with ASD will also help with those with photosensitivity, suffer from migraines, as well as the general population.

Lighting can be integrated with ambient temperature, humidity, ambient light, spectra, sensors to provide a network to monitor and control environmental impact and provide quality and positive experiences in the manufacturing plant, and as light based solutions.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., red, blue, green, yellow, etc.), accent lighting, mood lighting, location indication, emergency information and direction, full spectrum lighting, etc. The same or similar embodiments of the present invention can be used in schools, offices, warehouses, assembly and manufacturing, colleges, universities, malls, stores, apartments, condos, hotels, motels, libraries, campuses, other places, types, structures, buildings including but not limited to those discussed herein, etc. for both indoors and outdoors, other places, etc. including but not limited to the man-made and natural disasters discussed herein for alerting, wayfinding, pathfinding, other methods, approaches, uses, purposes, applications, etc. for active shooter, bad actors, intruders, fire, earthquake, tornadoes, hurricanes, others discussed herein, etc.

Embodiments of the present invention can use, for example, but not limited to smoke detectors installed in the lamp, fixture, light, etc. or attached via wired or wireless to the lamp, fixture, light, etc. and in general powered by the lamp, fixture, light, etc. or battery or solar or hybrid or energy harvesting with or without a battery charger to detect the presence of smoke for example but not limited to smoke due to fire, smoke due to a gunshot, gun being fired, etc., combinations of these, etc. and also track the smoke, the path of the smoke, etc. and, for example, but not limited to, automatically issue alerts show the pattern, tracking, monitoring, etc. on any type of display including but not limited to touchscreen, computer monitors, TVs, smart phones, tablets, remote controls, displays of any type, the lights themselves including forming patterns, providing wayfinding to safe locations, identifying bad locations and bad paths, etc. strobing the lights to warn, distract, disorientate, etc. intruders, bad actors, active shooters, perpetrators, others, etc. and to also lead but not limited to and depending on situation, type and use of building, structure, etc., the students, parents, visitors, employees, staff, instructors, teachers, professors, employers, administration, etc. to safety as well as lead the first responders including police, security, fire, peace officers, etc. to the proper location to defuse, stop, neutralize, mitigate, end, address the threat, danger, emergency, situation, etc. The present invention can also be used to identify people trapped by for example but not limited to man-made or natural disasters including but not limited to fire, earthquake, collapse of part or all of a building, structures, etc., active shooters or other intruders, etc. In addition to simple to complicated to sophisticated automatic responses, call centers, 911, local monitoring, security monitoring, law enforcement monitoring, manual monitoring, decision making, flow chart decision making, autonomous decision making, algorithmic decision making, artificial intelligence decision making, etc., combinations of these decision making, response, actions, etc. can be performed including but not limited to more than one of these in combination, simultaneously, sequentially, flow charted, with or without automatic or manual overrides, etc. can, for example, but not limited to, be used. In some embodiments, authorized persons including but not limited to employees of any kind, contractors, subcontractors, employers, administration, employers, officers, etc. who may already have access to the facilities can be tracked and monitored if desired and the lighting can be set to turn on including but not limited to turning on (or turn up from a default setting with no activity detected) to an appropriate level and color temperature and related settings and then turn off after no activity is detected after, for example but not limited to, a certain amount of time. Such turn on could be used to also turn on other functions, facilities or related items such as HVAC, other environmental controls, power to areas, desks, wall plugs, etc.

The present invention can also be used as a security system with, for example but not limited to, the motions and other sensors, detectors, etc., combinations of these detecting the presence of intruders, etc. at times and hours when no one should be present in the structure, building, parking lot, parking structure, roof top, basement, airport, other types described herein, etc. and, for example, but not limited to provide alerts, e-mails, SMS, other messaging, etc., contacting law enforcement, police, security including but not limited to private, city, town, local, regional, state, national/federal, etc., combinations of these, etc. In such situations, the lights could turn on, strobe, stay/remain off depending on the desired response. As the situation changed, or other decisions were made, the lights could, for example but not limited to, automatically or manually change state—for example but not limited to turn from off to on, turn from on to off, strobe, stop strobing, change color temperature, change color, flash, etc., combinations of these, etc.

The present invention can work with all types of communications devices including portable communications devices worn by individuals, walkie-talkie types of devices, etc.

The present invention can for example but not limited to use/incorporate card readers of any type, fobs of any type, biometrics of any type and/or specific face recognition, cell phones, near field communications (NFC), RFID, etc., combination of these, to determine persons allowed to be in a certain, space, buildings, indoor and outdoor locations, structures, bathrooms, secured areas, etc. The lights and other parts of the present invention can respond to such proper and lack of identification as discussed herein.

The present device can use combinations of wireless and wired interfaces to control and monitor; for example for a linear or other fluorescent replacement for, for example, but not limited to, T4, T5, T8, T9, T10, T12, etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

Can also have a system where if an intruder/etc. is detected it will alert neighbors including apartment building neighbors, housing neighbors, etc. if there are a blend of both houses and apartments, etc. both can for example but not limited to be monitored, sensed and detected, etc.

A circuit can be used to provide, for example, but not limited to a 0 to 10 V sink control signal, such a circuit can accept a digital input, an analog input, a PWM, etc. and shall be referred to as a/the companion.

To power the companion circuit:

Use buck-boost, boost, etc. with companion circuit

Use battery with companion circuit

Use solar with companion circuit

Use other energy harvester with companion circuit

Use other 0 to 10V devices, loads, lights, lamps, fixtures, etc. with companion circuit

Use combinations of the above as well as others.

The above can also include sensors, IOT, etc. Sensors can be of any type or form, can be any color, color temperature, combinations of these, one or more colors, color temperatures, etc.

The present invention can provide light therapy in numerous ways for numerous benefits including wellness, health, disease prevention and curtailment, sleep health, sleep wellness, sleep disorder treatment, cancer, illnesses and injuries, dementia treatment and prevention, Alzheimer prevention and treatment, seasonal affective disorder (SAD), muscular dystrophy, Parkinson's Disease, eating disorders, other sleep disorders, etc.

The present invention can also work with other health aides, treatments, monitors, etc. including but not limited to sleep/REM monitors of any kind, blood pressure and heart rate monitors of any kind, make, design, form, etc., smart watches of any kind, make, design, form, etc. including but not limited to fitness watches of any kind, make, design, form, etc., health watches of any kind, make, design, form, etc., body mass index (BMI) equipment any kind, make, design, form, etc., supplements of any kind, make, design, form, etc. including but not limited to health supplements, vitamins, anti-aging products any kind, make, design, form, etc., one or more light sensors of any kind, make, design, form, etc. including but not limited to ambient light sensors, RGB light sensors, WRGB light sensors, ultraviolet (UV) light sensors including but not limited to UVA and/or UVB light sensors, more than 3 channel (i.e., RGB) light sensors such that more colors/wavelengths of the spectrum are covered including, 4, 5, 6, 7, 8, 9 10, 11, 12, 13, 14, . . . N where N>1 and less than infinity channels of sensing.

The present inventions described herein can use displays, one or more dashboards, can send out SMS messaging to/for/in response to events, actions, etc.

Embodiments of the present invention can work with other sources of health and wellness monitoring, testing, etc. Embodiments of the present invention can work with analytics, be part of a logging, monitoring, analytics system, transmit information via web, cloud, cellular, etc. methods, aggregate Big Data, analyze the Big Data, make corrective actions, implement different regiments and treatments including but not limited to the light treatment/therapy, have and use dashboards, etc.

The present invention can also be used in recurring cost models, monetizing the data—both in terms of collecting and analyzing the data, including but not limited to aimed at anti-aging in all aspects as well as the business model. Embodiments of the present invention can be personalized lighting, mid-level lighting, ceiling lighting, wall lighting, screw in bulbs such but not limited to E26 and E27 based bulbs, GU10, MR16, tube bulbs including but not limited to FLRs for T4, T5, T8, T9, T10, T12, etc., HIDs and any other type of indoor or outdoor lighting source.

Implementations of the present invention can use multiple N channel light sensors placed in multiple locations to receive input on the light including but not limited to the light background, the reflected light, the transmitted light, the ambient light in one or more different locations and log, store, analyze such information. In some implementations, the sensors can be portable, human worn, built into the lighting fixtures, built in to other fixtures and furniture, attached to windows, attached to walls, ceilings, floors, etc. Such data on the lighting including the lighting quality can be aggregated with other data including any and all personal health data, vitamin, medicine, supplement including but not limited to health, anti-aging, beauty, etc., supplements, vitamin, prescription medications, health history, environmental information, air quality, sun exposure, water and other environmental quality, considerations, etc. All such information including history, trending, new changes of any kind, form, etc. can be entered into implementations of the present system and collectively and personally processed for improvements in health, wellbeing, wellness, anti-aging, quality of life, preventive measures, treatment of ailments, diseases, illnesses, injuries, weight management, etc.

The present invention can be used to provide for example but not limited to trend, real-time, predictive, analysis, dashboard, etc. information, guidance, assistance, corrective actions, etc. Embodiments of the present invention can use artificial intelligence, virtual reality, augmented reality, etc.

Implementations of the present invention can use the light sensors including but not limited to the one or more N-channel light sensors and full spectrum sensors to provide information on the quality, performance, health, maintenance status, drift, flicker, lack of flicker. etc. of the artificial light sources, etc. as well as monitoring the ambient natural light and external artificial light and report the quality of light, the spectrum, the alignment with, for example but not limited to circadian rhythm alignment, melatonin levels including natural melatonin levels, etc.

Embodiments of the present invention can also be used with melatonin monitoring equipment as well as any health, beauty, anti-aging, cosmetic, etc. systems including manual, automatic, smart/intelligent systems, supplement and vitamins, exercise, doctor, medical, para-medical, vital sign monitoring, etc.

Implementations of the present invention can be designed and used to provide enhanced health and work with other sources, vendors, suppliers, entities to increase longevity, anti-aging, health, antitoxins, etc. promote health benefits, provide protection, monitoring, security, safety, have encryption and cybersecurity protection. Implementations of the present invention can be or be part of a smart and/or intelligent home/house/residence/business/etc. Embodiments of the present invention are applicable to millennials, Generation X, Y, Z, Baby boomers, seniors of any age group including babies (prenatal, less than 1 year old, etc.) toddler, children, adults to 100+ years old including but not limited to sick, well, ill, fit, overweight, chronic illnesses, diseases, cancer, physical ailments, mental, issues, etc.

The present invention can use light sources of any type, combinations, etc. including solid state lighting (SSL) such as LEDs and OLEDs and QDs as well as incandescent and florescent and HID light sources.

The present invention can be used for, for example but not limited to, assisted living, senior living, hospitals, hospices, clinics, schools, boarding houses, dormitories, libraries, airplanes, ships, busses, other forms of transportation, airports, hotels, motels, long term housing arrangements, apartments, condos, work, cubicle, workspace, open work spaces, restaurants, fast food, coffee shops, tea shops, etc. Embodiments of the present invention also allow for energy savings and installing a sensor network that can be used for other benefits, such as greater HVAC and equipment efficiency and alarm-system security and numerous other IOT applications including camera monitoring, voice communications and recognition, pattern recognition, gesture recognition, data transfer, energy management and monitoring, heat maps, etc. as well as demand response load shedding, etc. The present invention can be used to monitor, track, log, analyze both indoor and outdoor exposure, home and office, shopping and eating, etc. Embodiments of the present invention can analyze and be predictive and prognostic.

Implementations of the present invention involve reducing excessive use of electricity in consumer residential housing and commercial and industrial buildings in the United States including the negative effects the excessive and unnecessary energy has on the United States economy. A major source of this excessive and wasted electrical energy is both inefficient lighting such as incandescent bulbs and certain types of, for example, T8 and T12 fluorescent lights and energy wasted when lighting is left turned on and, literally, no one is home—whether ‘home’ is a residence or some other building including a commercial building—small or large.

The present invention involves a family of intelligent, connected, low-cost, highly efficient, high reliability SSL including but not limited to light emitting diodes (LEDs) and organic LEDs replacements for linear fluorescent lamp replacements (e.g., T8s, T12s, T5s., etc.) that have full range dimmability (i.e., less than 1%), no perceptible/‘zero’ flicker and provide at least two separate output channels to support white color tuning also referred to as color temperature tuning as well as higher channel count to support full spectrum including for health-related applications and horticulture/plant growth including for vertical farm conversions.

Implementations of the SSL FLRs that enable and support rapid and easy adoption of innovative lighting for residential, and especially commercial and industrial applications and markets as well as specialty, hospitality, senior care, classroom and related applications. This includes implementing the intelligent FLRs to be able to work with or without the fluorescent lamp ballast and being specifically optimized for two or more channel dimming including digital (as well as supporting analog—e.g., 0 to 10 V) dimming applications. We shall also make the connected parts and aspects of the tunable, dimmable, trimmable SSL FLRs open source and interoperable to increase the market acceptance, adoption and innovation of LED products and smart/intelligent/connected SSL products.

The intelligent SSL FLRs are able to power either or both LEDs and OLEDs as well as other SSLs and the smart/intelligent control and communications (e.g., Bluetooth, BLE, WiFi, IPv4, LoRa, 0 to 10 V, DMX, RS485, DALI, other wired and wireless protocols, interfaces, powerline, etc.) by a standard (non-dimmable) fluorescent lamp ballast or using universal AC input voltage range from 120 to 277 VAC+/−10% coupled with wireless and wired modules which can, for example, but not limited to be open-source inter-operable code to facilitate/support future-proof products and greater SSL adoption.

The present invention includes SSL solutions for fluorescent linear tube replacements coupled with low-cost systems, components, sensors, firmware and software approaches, such novel, imaginative and cost-effective SSL products that can be readily interfaced to sensors, control algorithms, and even applications for common digital platforms that provide control functionality to SSL products adding value to users with little additional cost and relatively quick return on investment (ROI). With the immense popularity and ease of programming interface capabilities (e.g., application ‘apps’) into, for example, digital smart phones and tablets, creative, useful energy savings applications can be implemented that provide access to the enormous and powerful distributed computational capabilities of present and future SSL systems, components and sensors and also reduce energy consumption with highly efficient and flexible SSL FLRs.

Current fluorescent lighting technology has limitations that leave many lighting customers' needs unmet. A reduced total-cost-of-ownership/return-on-investment that intelligent SSL fluorescent lamp replacements provide will permit customers who are concerned with energy, installation and maintenance costs of lighting to reap the benefits compared to other legacy and emerging light source technologies including increased energy savings, higher levels of sustainability, improved lighting quality, user-adjustable, friendly and other enhanced lighting options.

The present invention includes but is not limited to a family of commercial and industrial high quality and high reliability multi-channel (e.g., white tunable, color tunable and full spectrum) smart/intelligent/connected, feature-full SSL fluorescent lamp replacement (FLR) products coupled with control and monitoring products that further reduce energy usage while enhancing the user-experience. This family of smart/intelligent FLRs is able to support, for AC wall 120 to 277 VAC 50-60 Hz operation, Triac, forward/reverse phase cut dimming, etc. and, for both AC Wall and Ballast powered, one or more of 0 to 10 V, powerline (PLC), wireless (e.g., Bluetooth, Zigbee, WiFi, 6LoWPAN, sub-GHz etc.), digital wired (e.g., DMX and DALI) dimming including two to multi-channel output dimming and the integration of both LEDs and OLEDs in the same FLR including having the OLEDs and/or additional LEDs powered by the FLR but remote from the FLRs

The present invention includes ballast-compatible and AC line compatible as well as DC compatible SSL FLR that has at least two (channels of) different white color temperature LEDs.

Implementations of the present invention also include but are not limited to ballast-compatible SSL FLR with four, five or more individual and independent SSL channel lighting. The individual and independent SSL channels could, for example, consist of Red, Green, Royal Blue, Amber, Lime (RGBAL) LEDs.

Implementations of the present invention include dual mode operation on Universal AC Line Voltage/DC and Ballast Output. The dual mode operation also supports FLRs that can be powered directly by AC line voltage or powered by the output of common electronic or magnetic ballasts.

Implementations of the present invention include sensor control & monitoring for/of the Intelligent SSL FLRs.

Additional embodiments and implementations apply to other types of lighting and form factor including but not limited to A lamps, PAR lamps, R-lamps, pendant lamps, flat lamps including but not limited to edge lit, edge emitter, back lit, combinations of these, etc., any and all types of E26, E17, GU10, MR16, etc. lamps, floor lamps, desk lamps, task lamps, down lights, can lights, wall packs, corn lamps, etc., combinations of these including but not limited to those that are only powered by AC or DC voltages, etc. which is applicable to the entire discussion and text of this document.

Implementations of the present invention include control and monitoring system that includes photo/light sensors, motion sensors, dimmers which can also function and/or be set to on/off mode. The light and motion sensors can, for example, be powered by the FLRs and only send/transmit information/signals when there is change (i.e., the ambient light changes appreciably compared to a reference set-point, motion is detected or not detected, etc.).

The SSL FLRs and Sensors can be used as systems and platforms.

The dual-mode UL Type C 2-channel white tuning light sources can be used on system design, integration, & open-source source software for dual-mode (i.e., ballast and AC line) energy efficient, dimmable SSL FLRs that can be connected with sensors, controls and monitoring.

Implementations of the smart and intelligent SSL replacement solutions to fluorescent linear lamp tubes (FLRs) are fully compatible with sensors and control hardware and easily integrated, incorporated, and/or used in conjunction with existing office, home and building infrastructure. For example, the SSL FLRs to replace T8 linear lamps and even T12 linear lamps do not require the ballast to be replaced or rewired—literally a direct drop-in replacement—and yet can be fully dimmed and controlled and even monitored while being powered by virtually any existing ballast including magnetic and electronic ballasts that, by themselves (i.e., the existing installed ballasts), have no capabilities to dim or be controlled including responding to daylight harvesting and/or motion/proximity sensors and detectors.

These SSL FLR smart/intelligent solutions are fully controlled/dimmable and can be readily interfaced with modular existing or field-installable sensors and detectors that work with existing sensors and controls and are easy, simple and straightforward to install yet offer sophistication and energy-savings.

These smart/intelligent/connected FLRs can have, for example but not limited to, one or more of the following example interfaces as well as others discussed herein: 0 to 10 V, DMX, powerline (PLC), wired and wireless (e.g., BLE) dimming. In addition to versions that support white light trimming, dimming and white tuning, via low cost international scientific and medical (ISM) RF signals or BLE, and, optionally (via, for example Bluetooth, ZigBee or WiFi), smart phones, tablets, iPods, iPads, iPhones, Android devices, Kindles, computers, Alexa, Google Home, Apple Home, Echo, other devices from companies such as Amazon, Google, Apple, etc., RGB and higher color channel changing SSL FLRs can also be supported via the same interfaces and mobile/computer devices. In some cases, 8-bit to 12-bit (256 to 1024) or higher resolution dimming is used. The AC input circuitry for the dual mode FLRs can also accept AC input with wall/Triac dimming.

Embodiments of the present invention intelligent Fluorescent Lamp Replacements (iFLRs):
require no special installation—install directly to replace fluorescent tubes—no tools and no special skills required. No rewiring/retrofitting needed for remote control/dimming—just remove FL & replace with SSL iFLR
provide constant lumens out regardless and virtually independent of the ballast make and model used to power embodiments of the present invention.
have full protection for the circuit, the LEDs and living creatures who may come in contact with or install it.
have Smart/intelligent versions that save additional energy and last longer due to dimming and reduced LED current.
can work with daylighting, motion, proximity, occupancy, gesturing, light, sound, etc. sensors including, but not limited to, 3rd party.
can work with existing motion and daylight harvesting sensors and systems.
Provides an iFLR-as-a-platform infrastructure that includes futureproofing.

Implementations of the present invention can vary the color temperature which can be controlled/maintained SSL which, again, are based on the product family of constant current/lumen and intelligent single-channel SSL iFLRs.

In general, the power supplies and drivers for SSL FLRs need to be able to convert relatively high frequency (typically 40 to 100 kHz) AC input to DC output power, support various types of remote control/dimming, meet FCC EMI conducted and radiated limits, provide over-current (OCP), over-voltage (OVP), over-temperature (OTP) and short circuit protection (SCP).

In addition to the lights changing color or color temperature, additional lighting internal and/or external to the iFLRs and powered by the iFLRs can be used to, for example, but not limited to, provide such indications for directions, for first responders, for identifying where to go, etc. The present invention also applies to fixtures where the lights in the fixtures could also be used to provides such indications for, for example, but not limited to, directions for first responders, for identifying where to go, etc.

Smart/Intelligent SSL White Temperature Tunable FLRs.

Implementations of the present invention can, for example, but not limited to, include a two channel intelligent LED white temperature tunable FLR using two different sets of white color temperature LEDs with the first set being for example but not limited to, 2000, 2700K and 5000K and 6500K or higher, respectively, as the low and high color temperatures and the second set being 2700K and 5000K, respectively, as the low and high color temperatures.

Implementations of the two channel dimmable electronics for the two channel LED FLRs can include but are not limited to independent 0 to 10 V standard analog interfaces for/to each white color temperature.

Implementations can also include but are not limited to a single standard DMX (DMX512, etc.) interface that is able to take a digital input signal and digitally independently address each channel of the two or more channels.

Other implementations can include, but are not limited to, a wireless interface that provides both analog and digital (e.g., PWM or related) set level and control to the designs and implementations Bluetooth Low Energy (BLE) modules with built-in microcontrollers that provide the input/output I/O analog and digital pins to interface to the two-channel white tunable FLRs. Some implementations can have both wired and wireless including but not limited to one or more each of a wireless and wired interface and/or protocol. Some implementations of the present invention can have a wireless radio that can use one or more protocols including for example but not limited to Bluetooth, BLE, WiFi, ZigBee, ZWave, Thread, LoRa, 6LoWPAN, IPv4, IPV6, etc., other protocols, etc., discussed herein, combinations of these, etc.

Five Channel Smart/Intelligent SSL Tunable FLRs.

The five individual and independent SSL channels could, for example but is not limited to, be adapted from theatrical light color mixing consisting of Red, Green, Royal Blue, Amber, and either Lime or Mint LEDs.

5 types of LEDs which can be, for example but not limited to, an Amber LED, a Lime Green LED, a Red LED, a Green LED and a Royal Blue LED may be used in some embodiments. In some implementations a RGBAL package of LEDs will be chosen or even possibly a dual white-RGB package will be chosen. Efficacy will be carefully considered. In any event, the chosen 5 types of LEDs and their respective combined or individual packages will be arrayed in parallel and series to achieve the desired LED lumens and current and effective forward voltage (and, thus the DC power consumption) of each channel LED array for the 5 channel FLRs.

5 channel LED light boards consisting of 5 independent type LED arrays can be used in some embodiments of fully operational and functional five-channel tunable LED FLRs.

In some embodiments dual operation on universal AC line voltage and ballast output with, for example, but not limited to RGB or WRGB or WRGBA, etc. LED drivers for use and incorporation into energy efficient AC wall powered SSL FLRs with the sensors, controls and connectivity coupled with spectral control including feedback to control color variation due to aging and other factors as well as quantitative performance and control/feedback spectral performance

Some implementations of the present invention can have <0.1% dimming flexible SSL FLR.

Implementations of the present invention can include digital dimming for the SSL drivers and support AC line phase dimming (forward or reverse selectable). SSL FLRs with sensors, controls and connectivity specific optimized performance while incorporating appropriate performance standards into the architecture in both ballast and AC line mode operation for the dual mode (AC/ballast) powered two-channel SSL FLR

Implementations can Include but are not Limited to Sensor Control & Monitoring for the Intelligent SSL FLRs.

Embodiments of the present invention can include but are not limited to daylight harvesting (DLH) sensors including interfacing and being powered by the dual-mode FLRs. These sensors will provide, on a digital bus, ambient lux numbers & be used with/on the white tunable FLRs. Some embodiments of the present invention use full spectrum color sensors as well as, for example but not limited to, motion sensors including all hardware and software so that the motion sensors' on, off, dwell, occupancy, vacancy, etc. information can be programmed and motion detection responses can be transmitted/received on the same digital bus as the DLH sensors. In some embodiments the sensors can be integrated and power the motion and DLH sensors with the dual-mode, two-channel FLRs.

The SSL FLRs and Sensors can Also be, but are not Limited to, Simple Systems.

The intelligent two-channel, dual-mode FLRs and electrically tethered sensors can form systems and platforms. The data can be monitored, logged, stored and analyzed.

Intelligent Tunable/Dimmable SSL Replacements for Linear Fluorescent Lamps:

The intelligent dual mode two-channel white tuning/trimming with sensor-smart integration and controlled FLRs can be for example but not limited to be installed in one or more customer(s) locations.

Lighting is becoming important as an integral part of many types of operations. Digitally addressable control of the lighting fixtures and associated circuits, for example, can be used to dim and/or turn the lights on and off depending on what is required or desired. Control of lighting can be a critical operations factor. The present invention includes smart lighting that provides control and dimming of lighting fixtures and associated circuits down to individual light/circuit level.

The present invention includes smart modules that are be able to recognize the lighting package configuration and what type of light fixture it is controlling through embedded firmware/software; this would allow lights of different functions and power requirements to, for example, be daisy chained, significantly reducing cable runs and installation costs.

Implementations of the present invention including smart modules, therefore, allow for the capability that, as lights are added to the system, the lights would self-configure and appear on the operator control panel in the correct lighting group. The proposed smart module solution would also eliminate the need for multiple configurations, set-up issues and complex and tedious troubleshooting while providing a simplified configuration that allows easy field replacement when a light is short circuited or not able to be turned on/off, dimmed, or flashed from the operator control panel. As a result, failures of any light would not affect the operation of any other light.

The present invention can address, but is not limited to, lighting fixtures that range from a single LED fixture to fixtures containing multiple LED strings (1-6) with different voltage (˜ less than 3 to greater than 120 VDC) and current (less than 20 mA to greater than 100 A) requirements.

The present invention also addresses the needs for reducing system cable plant, minimize system interconnections, provide redundancy for fault tolerance, provide for on/off, flashing and dimming control of various lighting groups, configurations that can be incorporated into existing lighting fixtures or interconnection junction boxes while minimizing total system cost of ownership. The consolidated control of the total system can be of any form, type, approach, method, technology, protocol, interface(s), etc. including but not limited to those discussed herein, and, for example, over a mesh network including but not limited to a Bluetooth mesh or it can be over a local area network (LAN), WiFi, etc., combinations of these, etc.

Embodiments of the present invention can be isolated (galvanic) or non-isolated. Both the isolated and non-isolated embodiment of the present invention can be used for universal smart LED Light and Light Fixture Addressable Smart Control Module including but not limited to with respective embedded firmware/software capable of having universal applications.

The Lighting Addressable Smart Control Modules are able to digitally control SSL including LED, OLED, QD, combinations of these, etc. A simple yet sophisticated wiring cable can be used for the present invention.

Embodiments of the present invention can include but are not limited to modular isolated forward or flyback converter and driver architecture and design including, for example, but not limited to, a buck (down) converter.

Embodiments of the present invention can provide extensive driver/power supply protection, safeguards and fault detection/redundancy/override detection/protection/response. For example, but not limited to, the power supplies and drivers for lighting (e.g., OLED, LED, CFL, CCFL) can be fully protected including protected against arcs, shorts, over voltage and over current, over power, etc. and can be either (or both) digital or analog controlled.

Embodiments of the present invention can provide for sophisticated, advanced, low-cost wired or powerline (or optionally wireless) control and monitoring and data and status/fault logging of each and every individual driver/power supply/module and LED lighting source including but not limited to extensive remote monitoring and control including auto/self-identification, configuring and commissioning and can also be used to monitor all key parameters including, but not limited to, input current, input voltage, inrush current, voltage spikes, power factor, true input power, Volt-Amp (VA) input power, output current, output voltage, output power, output voltage overshoot, output current overshoot, temperature at multiple locations, humidity (if desired), etc. Most of these parameters and especially the input parameters can be transmitted either as waveforms (e.g., amplitude vs. time) or as instantaneous or average data points.

Embodiments of the monitoring, interface and control can perform and permit self-configuration where the smart module will configure itself to the type of fixture and recognize how it fits into the configuration of one or more of a group or groups, mesh or meshes, system or systems, organization, room, home, building, office, suite, warehouse, etc., other types of buildings, housing, living space, hospitals, schools, etc., including but not limited to those discussed herein, combinations of these, etc. including for visible and infrared and other SSL including but not limited to LED lighting as well as, for example, essentially any indoor or outdoor application or use and also, for example, attempt to prevent SSL LED junction overheating SSL lighting while delivering maximum possible lifetime including under all conditions such as full on, flashing, maximum (deep) dimming. The ‘self-configuring’ is an important aspect and feature for some embodiments of the present invention as well as thermal monitoring, control and management including both full and partial thermal interface and control systems that either completely turn off the LED at a prescribed temperature or gently reduce the power supplied to the LED once a specific temperature is reached with the power continually reduced to the LED until a maximum safe operation area (SOA) upper limit temperature is reached at which point the LED is fully turned off, respectively; of course all of these modes allow for ‘emergency’ overrides and in general, provide optimal protection while balancing all related trade-offs including providing maximum permissible light output for the SSL/LED lighting without fatally damaging or seriously degrading the SSL/LED source and being able to activate emergency override capability in case a situation, due to some unforeseen event or failure, occurs.

Embodiments of the present invention may use different materials, devices, thermal, mechanical and electrical parts, components, subsystems, etc. that may be incorporated into the digitally addressable and controlled power supplies and constant current and constant voltage drivers. Silicon carbide (SiC) or gallium nitride (GaN)-based semiconductor power devices including diodes and transistors may be used with the present invention to increase efficiency, switching frequencies and reliability while reducing size and mass and waste heat.

Some implementations of the present invention may use redundant circuits within a module or modules or redundancy in the modules so that if one circuit or module, respectively, fails, overheats, degrades, etc., the system can automatically switch over to the other circuit or module, respectively and can provide status and diagnostics including manual override of any automatic operation and remote reprogramming if deemed necessary. Implementation of the Lighting Addressable Smart Control Modules can include wired, wireless and powerline control and monitoring.

The present invention can use ‘self-configuration’, where the smart module will automatically self-configure itself to the type of fixture and be able to recognize how it fits into the configuration of the lighting in a room, in a building, in a ship, in an airplane, in a hotel, in a home, in a hospital, in a school, etc., any other type of building, facility, etc., in an outdoor setting, including but not limited to concerts, events, camping, mobile living, temporary living, field hospitals, military mobile units, others discussed herein, combinations of these, etc.

In the case of a power failure, there may be a short interruption, therefor implementations of the present invention can be designed to anticipate the possibility of a short interruption and not be negatively impacted, affected or impaired by such an interruption and could have, for example but not limited to, non-volatile memory to backup and maintain pertinent information including setup and self-configuration/identifying/addressing information, etc.

Any form, type, protocol, interface, etc. may be used for communications including, for example, but not limited to, RS485. Implementations of the present invention may use wiring redundancy and data redundancy.

Embodiments of the present invention can self-configure without user interaction. Some embodiments of the present invention may use an electronic identifier for each module or a physical connection to its neighbors to set, determine, ascertain, etc. such information as part of the automatic self-configuration. Dimming can be from approximately 0% to 100% using, for example, but not limited to, pulse width modulation (PWM).

Implementations of the present invention include but are not limited to constant current source with adjustable current setting and adjustable compliance (i.e., maximum) voltage settings that support analog and digital dimming coupled with, for example, being dynamically adjustable and programmable. For example, a buck converter can be used to provide a constant output current to convert the input AC voltage down to a lower DC voltage at the desired constant current which can also be PWM digitally dimmed or optionally analog dimmed. In general the AC to DC buck converter works equally well as a DC to DC buck converter. In other embodiments the buck converter can be replaced with other types of non-isolated converters such as boost, buck-boost, boost-buck, Cuk, etc. or an AC to AC or AC to DC isolation converter which, for example but is not limited to, can consist of one or more individual or power combined forward converters of any type but most likely a low noise, low EMI, current fed forward converter(s) or flyback converter(s).

The SSL/LED lighting and associated electronics including drivers, power supplies, controls, etc. can be in any number of standard form factors including but not limited to T8, T12, T4, PL 2 pin and 4 pin, A lamp (E26 base), PAR 30, PAR 38, BR30, BR 40, R20, R30, R40, 2×2 ft panels, 2×4 ft panels, etc. in any white color temperature or color temperatures, etc. with or without other colors as discussed herein as well as custom form factors.

A module can include, for example but not limited to, an AC to DC rectification and EMI filter stage that feeds a DC to DC buck converter which can output a constant current to the SSL/LED or SSL/LED array. The controller for the module can contain a number of functional features and elements including but not limited to one or more digital to analog converters (DACs) with, for example but not limited to, at least one of the DACs providing a reference voltage for the buck converter to use to set the output current to the SSL/LED light or SSL/LED array light. Note that such a DAC current reference/set point can also be used to provide, for example, flashing or PWM digital dimming. Analog to digital converters (ADCs) can be used to read a typically reduced (i.e., voltage divider) replica of LED forward voltage of the SSL/LED light which can be corrected for any wire/cable losses from the current output of the module. In general it is expected that such wire/cable losses will be relatively small or completely negligible. One or more additional ADCs can be used to read the differential voltage across a typically very low resistance value precision resistor to determine the voltage and current, respectively, as well as the power (which is the product of the voltage times the current) to the SSL/LED or SSL/LED array lamp—again under the assumption that the length of cables between the output of the module and the SSL/LED light element or array are low enough resistance to not seriously affect the measured LED forward voltage results and also cause inefficiencies. In addition, one or more optional photosensors (e.g., phototransistors) can be placed at an appropriate point(s) so as to not interfere with the SSL/LED lights and can effectively calibrated and used with the module to determine the real time efficacy (i.e., lumens/watt) of the SSL/LED light(s) and also flag any apparent degradation in the SSL/LED lighting.

As an example, two types of bidirectional communications between the module and central or distributed control include but are not limited to powerline communications (PLC) to the AC lines (or optionally can be from a daisy-chained AC to AC or AC to DC and a serial connection using low voltage and low current twisted pair wiring supporting one or more interfaces/protocols including but not limited to RS485, controller area network (CAN) bus, UARTs, SPI, I2C, etc. RS485 is a simple, medium speed communication bus that can, in newer implementations, support hundreds or more connection nodes. Typical RS485 drivers can automatically return to high impedance tri-state within a few microseconds after data has been sent thus eliminating, for example, the need to have delays between the data packets on the RS485 bus. The CAN bus began as a an automotive bus standard designed to allow microcontrollers, microprocessors, etc. and other types of devices to directly communicate with each other as well as an optional host server or computer. The ‘IDer’ is used to provide an ID type for the SSL/LED or SSL/LED array lamp. Such an ID can range from a simple analog identification such as a certain resistance value which corresponds to a particular LED lamp current and associated voltage to a simple integrated circuit (IC) or application specific IC (ASIC) that sends out an ID data byte or bytes when commanded to do so or a sophisticated code using discrete ICs and components or and ASIC. In other embodiments a low voltage, low current wire or wires can be used measure a resistor that is uniquely associated with a particular current and voltage LED light. In some embodiment of the present invention, a small IC or ASIC that contains an ID, calibration data, and can also measure and digitally transfer/transmit the current, voltage and power usage requirements of the SSL/LED or SSL/LED array light. RS485 is currently used to communicate with the Operator Control Panel. Although the discussion above was focused on RS485, in general, other serial interfaces and UARTs as well as SPI, I2C, CAN Bus, Ethernet, etc. can be used. RS485 is used as the electrical layer for many well-known interface standards, including Profibus and Modbus. In some embodiments of the present invention, secure communications including cybersecure communications and related technologies, techniques, methods, methodologies, etc. can be used

Implementations of the present invention can also use only the power (DC current) lines to the SSL/LED elements or arrays and superimpose small AC signals that identify the particular light source. As the data rate requirement is typically quite low and limited (in some cases just a SSL/LED lamp element or array ID and model number), as an example, an approach similar to, for example, X10 (X-Ten) communications protocol can be used for identification purposes including to set the maximum current (and associated appropriate LED forward voltage for the dumb LED light. Such a superposition technique using for example modulated sine waves and filters including but not limited to notch, narrow band, etc. on either AC and DC bus rails to transfer control and monitoring data using, for example, low cost narrow band filters tuned to the carrier to transmit and receive. Such a superimposed/superposition technique can be very effective in communicating control, monitor, logging and informatics, analytics information. An example carrier frequency can in the 100 kHz range or lower or higher. Other embodiments can use a unique/different type of connector for each type/model of LED light element or array.

This innovative I-V approach can also be adapted and used to determine/detect the health and well-being of the SSL/LED light, many of the fault and failure modes, and significantly assist in self and group recognition and reconfiguring in the event of an abnormal, faulty or failed lamp condition as well as support dimming, flashing and on/off features and functions.

Embodiments of the present invention reduce wire/cabling and associated costs, complications, and logistics and provide extensive driver/power supply protection, safeguards and fault detection/redundancy/override detection/protection/response can include but are not limited to a robust maximum power measurement, management and monitoring for the module and related systems including for the LED drivers, power supplies, and related electronics.

Implementations of the present invention can include N+1 redundancy and possibly N+2 redundancy where N=1 for, for example, the buck) or other) converter of the module and N may be greater than 1 for other critical components used in the module including monitoring and logging pertinent data and parameters including input current, input voltage, inrush current, voltage spikes, power factor, true input power, Volt-Amp (VA) input power, output current, output voltage, output power, output voltage overshoot, output current overshoot, optional temperature at multiple locations, humidity (if desired), etc. Most of these parameters and especially the input parameters can be transmitted via the candidate communications interface as either waveforms (e.g., amplitude vs. time) or as instantaneous or average data points.

The control and monitoring interface and control strategies performs and permits ‘self-configuration’ where the smart module will configure itself to the type of fixture and recognize how it fits into the overall, local, and/or global, etc. configuration of, for example, but not limited to, the SSL/LED lighting as well as, for example, attempt to prevent SSL LED junction overheating of the SSL/LED lighting while delivering maximum possible lifetime including under all conditions such as full on, flashing, maximum (deep) dimming, short detection, short circuit protection, etc.

Implementations of the present invention can us various ‘IDer’ and address sing/self-configuration approaches including but not limited to those discussed herein. Some embodiments can employ RS485 or RS485 derivatives including Profibus and Modbus as well as other serial protocols/interfaces. Implementations of the present invention can have redundant circuits within a modules or redundancy in the modules so that if one circuit or module, respectively, fails, overheats, degrades, etc., the system can automatically switch over to the other circuit or module, respectively and can provide status and diagnostics including manual override of any automatic operation and remote reprogramming if deemed necessary. The redundant modules can be built in or be stackable and hot swappable.

Smart control of lighting can be used to dim and/or turn the lights on. A smart lighting solution can provide control and dimming of lighting fixtures and associated circuits down to individual light/circuit level. This can be through a standardized smart module that can recognize the lighting package configuration and what type of light fixture it is controlling through embedded firmware/software. This allows lights of different functions and power requirements to be, for example, but not limited to, ‘daisy chained’, significantly reducing cable runs and installation costs.

Dimming can be from 0% to 100% brightness using, for example, but not limited to, pulse width modulation (PWM) and can cover orders of magnitude. Flashing can be 90 flashes per minute (fpm) at 50% duty cycle for some fixtures. The consolidated control of the total system can be over Local Area Network (LAN).

Automatic self-configuration and installation including no single points of failure is part of the present invention.

The present invention can drive any of the fixtures and associated LED strings and automatically recognize, identify and self-configure to the fixtures while providing extensive input and output protection and bi-directional control, monitoring and status communications.

Numerous topologies can be used with the present invention. Three of these topologies are buck converter, boost converter and buck-boost converter. For a buck, the input voltage must be higher than the output voltage. For a boost converter, the output voltage cannot be lower than the input voltage. For the buck-boost converter, the restrictions on the input and output voltages are removed and the output voltage can range from lower to higher than the input voltage. In some applications, the buck converter circuit approach would yield the highest efficiency and put the lowest stress on the components.

For example, a prime power (100 VAC to 300 VAC 50/60 Hz) can provide power to local isolated AC-DC converters which, in turn, would directly power a set of DC-DC converters each of which provides a constant current to one LED array/string of a fixture.

An isolated low voltage DC buss (powered by the 100 to 300 VAC 50/60 Hz prime power) that would provide a daisy-chained power to local LED drivers which, in turn, would provide constant current output to each LED array/string in a fixture.

Variants of these which include separate and combined versions AC-DC and the DC-DC converters including the original initially proposed approach for an AC voltage input to a DC current output.

All circuits, drivers, power supplies, modules, etc. disclosed herein can have Over-current Protection: (OCP); Over-voltage Protection: (OVP); Over-temperature Protection (OTP); Short Circuit Protection (SCP); Arc Detection/Protection (ADP); Transient Surge Protection (TSP); Circuit Breaker Protection (CBP); Electronic Circuit Breaker Protection (ECBP) Fuse Protection (FP); Relays; Other forms of redundant/multiple forms of protection; Alerts; Potential additional ‘Protection Buses’ with low power wiring; Additional modes of protection can include Alarms; Status modes, override modes, Designed for no single points of failure; Redundant bidirectional communications between the modules and the Gateway can be implemented including failure to detect/communicate with one or more modules as well as the Gateway.

Further advantages of a single universal module include incorporating onto the same printed circuit board as the main module ‘motherboard’ common elements of the DC to DC converters as well as the microcontroller and related intra-module and inter-module communications. Note that there can be more than one redundant microcontroller (and/or microprocessor, digital signal processor, etc.) or other ‘brains’ as well as redundant follower bi-directional wired communications. Advances in electronics for LED drivers and power supplies have resulted in ultra-compact relatively high power density electronics for LEDs. In addition, by active heat-sinking and parametric monitoring of thermal and electronic loads and performance, the firmware on the proposed modules can make appropriate autonomous decisions of appropriate thermal loads and dissipation.

The present invention includes DC-DC drivers and the novel auto-detect-and-set approach to accurately identifying which of the LED arrays/strings was attached to the DC-DC converter. This novel identification method uses the current-voltage curve of the LED array/string to identify and set the electrical properties of the DC-DC converter for that LED array/string based on updateable firmware.

A DC-DC constant current converter can include an on-board buck converter that can take the 30 V DC input and efficiently converter it to a 5 V DC to power the microcontrollers, other digital and analog circuits and electronics (e.g. op amps, comparators, analog to digital converters, digital to analog converters, etc.) as well as the wired USB, SPI, UART (which were tested but not used to gather data in Phase 1) as well as the wireless Bluetooth interface that bi-directionally communicated with one or more smart phones and/or Android or Apple iOS tablets.

A feature of the present invention universal DC-DC constant current converter is that it is able to automatically auto-detect which LED array/string it is electrically connected to and powering and provide appropriate maximum current/power and associated parameters such as but not limited to OVP, OCP, to that particular LED (emulation) array/string.

In terms of the wired communications, some embodiments have a multi-drop configuration that is tolerant of shorts and opens on the drops for the communication between the Gateway (GW) and the modules. The communications can be bi-directional in a leader-follower configuration for purposes of verification, confirmation, status, fault/no-fault and general health monitoring, etc.

The electronics can have protection including but not limited to fuse including both one-time and resettable fuses, thermal and/or thermal-magnetic, circuit breaker, transient voltage suppressors (TVS) such as varistors and metal oxide varistors (MOVs), surge protectors. Such protection will also be monitored for signs and indications of near end of life/failure to protect. Such protection will also provide disconnect protection in the event of a short or other excessive current draw from a module. In addition, the isolated AC to DC converter and each DC to DC Buck converter that constitute the power train for the module will have extensive protection including redundant protection including Over current Protection: (OCP); Over voltage Protection: (OVP); Over temperature Protection (OTP); Short Circuit Protection (SCP); Arc Detection/Protection (ADP); Transient Surge Protection (TSP); Circuit Breaker Protection (CBP); Electronic Circuit Breaker Protection (ECBP); Fuse Protection (FP); Relays and/or Transistor Switches. In addition, extensive current, voltage and temperature monitoring can be implemented. In addition protections to implement, which protections to have override capabilities, which protections to be programmable, software or firmware enabled, etc. can be included in embodiments of the present invention.

In addition, the novel auto-detect and set identification approach to safely and automatically self-configure the modules to the respective LED arrays/strings in the light fixtures is, in general, intended to be only turned on (this feature is programmable, remote enabled, by a command or locally and can be configured in most anyway.

The bidirectional communications can be designed with redundancy and potentially tri-state (i.e., low, high, high impedance) digital connectivity.

In addition, the modules can be designed to be able to operate without dropping out and compromising the DC output to the LED arrays and fixtures should prime power dropout for, for example, up to 150 milliseconds; this dropout immunity can be accomplished via, for example, but not limited to, sufficient capacitance or battery backup, super capacitors, etc., combinations of these, etc.

Commands can be sent to, for example but not limited to, set the mode (i.e, on/off, 0 to 100% digital PWM dimming in 0 to 2000 steps [i.e., greater than 3 orders of magnitude], flashing at 90 fpm) of the output of the DC-DC converter to the different LED array/strings. Wireless communications and/or wired communications or PLC can be used with the present invention. Configuration, redundancy, method and approach for bi-directional redundant communications can include all forms of common wired and wireless communications protocols and interfaces including, but not limited to, serial interfaces such as RS232, RS485, CAN, USB, Profibus, Modbus, Ethernet, LAN, DMX, DALI, I2C, SPC, SPI, powerline communications, etc. and wireless protocols including, but not limited to, WiFi, ZigBee, Bluetooth Classic, Bluetooth Low Energy, ISM band, ZWave, 6LowPAN, LoRa, etc. or wired interface(s) to assure no single point(s) of failure, redundant communications to and from the universal modules.

An auto-detect-and-set approach to accurately identifying which of the LEDs can be incorporated into the DC-DC converter. This identification method can use the current-voltage curve of the LEDs to identify and set the electrical properties of the DC-DC converter for that LEDs.

This auto-detect-and-set feature can be enabled and turned on or off automatically, remotely or locally and is typically used for safe, automatic, self-configuration and identification when pairing/mating the universal modules to the respective LEDs in a lighting fixture.

These constitute some features of a field installable/replaceable module. Such protection can include fuses, resettable fuses, short circuit current protection, ultrafast acting DC electronic circuit breakers as well as OTP, OVP, OCP, etc.

An intelligent controller can contain a number of functional features and elements including but not limited to one or more digital to analog converters (DACs) with, for example but not limited to, at least one of the DACs providing a reference voltage for the buck converter to use to set the output current to the SSL/LED light or SSL/LED array light. Note that such a DAC current reference/set point can also be used to provide, for example, flashing or PWM digital dimming. Analog to digital converters (ADCs) can be used to read a typically reduced (i.e., voltage divider) replica of LED forward voltage of the SSL/LED light which could be corrected for any wire/cable losses from the current output of the module. In general it is expected that such wire/cable losses will be relatively small or completely negligible. One or more additional ADCs can be used to read the differential voltage across a typically very low resistance value precision resistor to determine the voltage and current, respectively, as well as the power (which is the product of the voltage times the current) to the SSL/LED or SSL/LED array lamp—again under the assumption that the length of cables between the output of the module and the SSL/LED light element or array are low enough resistance to not seriously affect the measured LED forward voltage results and also cause inefficiencies. In addition, one or more optional photosensors (e.g., phototransistors) can be placed at an appropriate point(s) so as to not interfere with the SSL/LED lights and can effectively calibrated and used with the module to determine the real time efficacy (i.e., lumens/watt) of the SSL/LED light(s) and also flag any apparent degradation in the SSL/LED lighting.

As an example, two types of bidirectional communications between the module and central or distributed control include but are not limited to powerline communications (PLC) to the AC lines (or optionally could be from a daisy-chained AC to AC or AC to DC and a serial connection using low voltage and low current twisted pair wiring supporting one or more interfaces/protocols including but not limited to RS485, controller area network (CAN) bus, UARTs, SPI, I2C, etc. RS485 is a simple, medium speed communication bus that can, in newer implementations, support hundreds or more connection nodes. Typical RS485 drivers can automatically return to high impedance tri-state within a few microseconds after data has been sent thus eliminating, for example, the need to have delays between the data packets on the RS485 bus. The CAN bus began as a an automotive bus standard designed to allow microcontrollers, microprocessors, etc. and other types of devices to directly communicate with each other as well as an optional host server or computer. The ID circuit is used to provide an ID type for the SSL/LED or SSL/LED array lamp. Such an ID can range from a simple analog identification such as a certain resistance value which corresponds to a particular LED lamp current and associated voltage to a simple integrated circuit (IC) or application specific IC (ASIC) that sends out an ID data byte or bytes when commanded to do so or a sophisticated code using discrete ICs and components or and ASIC. In other embodiments a low voltage, low current wire or wires can be used measure a resistor that is uniquely associated with a particular current and voltage LED light. In some embodiment of the present invention, a small IC or ASIC that contains an ID, calibration data, and could also measure and digitally transfer/transmit the current, voltage and power usage requirements of the SSL/LED or SSL/LED array light. RS485 is currently used to communicate with the Operator Control Panel. Although the discussion above was focused on RS485, in general, other Serial interfaces and UARTs as well as SPI, I2C, CAN Bus, Ethernet, etc. can be used. RS485 is used as the electrical layer for many well-known interface standards, including Profibus and Modbus. In some embodiments of the present invention, secure communications including cybersecure communications and related technologies, techniques, methods, methodologies, etc. can be used

Implementations of the present invention can also use only the power (DC current) lines to the SSL/LED elements or arrays and superimpose small AC signals that identify the particular light source. As the data rate requirement is typically quite low and limited (in some cases just a SSL/LED lamp element or array ID and model number), as an example, an approach similar to, for example but not limited to, X10 (X-Ten) and other powerline communications protocol can be used for identification purposes including to set the maximum current (and associated appropriate LED forward voltage for the dumb LED light. Such a superposition technique using for example modulated sine waves and filters including but not limited to notch, narrow band, etc. on either AC and DC bus rails to transfer control and monitoring data using, for example, low cost narrow band filters tuned to the carrier to transmit and receive. Such a superimposed/superposition technique can be very effective in communicating control, monitor, logging and informatics, analytics information. An example carrier frequency could in the 100 kHz range or lower or higher. Other embodiments could use a unique/different type of connector for each type/model of LED light element or array.

In some embodiments of the present invention, an innovative and highly flexible/adaptable approach to implementing universal output modules “one type/module does it all” is to essentially have the module take a current vs. voltage (I-V) curve of the SSL/LED lamp and, for example but not limited to, compare the acquired I-V curve to stored I-V curves in the modules non-volatile memory to determine the type, make and model of the LED light and automatically self-configure and put out the correct maximum current or any lower current that the module is commanded to do in dimming mode, etc. Such an I-V curve may not be not acquired using the conventional way of sourcing a voltage (independent variable) and measuring a current (the dependent variable) due to the high possibility of damaging the SSL/LED light by applying a severe over voltage; instead, the current is sourced (dependent variable) by, for example, but not limited to using the digital to analog (DAC) block to set the current for, for example, but not limited to, the power supply so as to be able to acquire discrete I-V data points or perform entire I-V curve sweep. For example data can be acquired by having the module set and sweep the reference DAC that sets the reference current voltage to the power supply, which, in turn, outputs a constant current to the SSL/LED lamp.

Note the design allows for autoranging and selecting the decade sequence spacing of data points (e.g., 1, 2, 5 or 1, 2, 3, 4, 5, 6, 7, 8, 9, etc.) with the LED forward voltage read using ADC channel. Such an I-V curve could easily be acquired by the module as the module will include one or more, for example but not limited to, low cost microcontrollers each of which will be fully loaded up with ADC to measure, for example, a voltage-divided version of the LED forward voltage as a function of, for example, but not limited to, Buck Converter output current. As an example, any of the I-V curves of one or more LED arrays can be acquired, analyzed and compared to existing library/look up tables of I-V curves stored in the module's non-volatile memory and accurately uniquely identified in less than a second. Such multi-point I-V curves can be easily and routinely performed using the digitally driven design and approach for the present invention. Such an approach requires no additional low voltage wires or infrastructure and exploits the readily available technology directly associated with the addressable smart control modules which can also determine and assign addresses and self-configure and re-configure as new lights are added or subtracted. This innovative I-V approach can also be adapted and used to determine/detect the health and well-being of the SSL/LED light, many of the fault and failure modes, and significantly assist in self and group recognition and reconfiguring in the event of an abnormal, faulty or failed lamp condition as well as support dimming, flashing and on/off features and functions.

While illustrative embodiments have been described in detail herein, it is to be understood that the concepts disclosed herein may be otherwise variously embodied and employed, and that the appended claims are intended to be construed to include such variations, except as limited by the prior art.

What is claimed is:

1. A solid state lighting system comprising:
a plurality of solid state lamps;
a plurality of sensor modules, each associated with at least one of the plurality of solid state lamps, wherein the sensor modules are configured to communicate with each other and to coordinate location-based color settings in the plurality of solid state lamps.
